(19) United States
(12) Patent Application Publication
(10) Pub. No.: US 2024/0381863 A1
(43) Pub. Date: Nov. 21, 2024

(54) Sensing Alarm Unit for Rotating Spool or Reel Equipped Fishing Apparatus

(71) Applicant: Vulture Systems, LLC, Stoughton, WI (US)

(72) Inventors: Gregg J. Haensgen, Menomonee Falls, WI (US); James R. Milota, Stoughton, WI (US); Richard Lucas, Zimmerman, MN (US); Bradley Brunker, Mazomanie, WI (US); Cooper Haensgen, Menomonee Falls, WI (US)

(21) Appl. No.: 18/771,320

(22) Filed: Jul. 12, 2024

Related U.S. Application Data
(63) Continuation-in-part of application No. 17/980,550, filed on Nov. 4, 2022.
(60) Provisional application No. 63/275,038, filed on Nov. 3, 2021.

(51) Int. Cl. A01K 97/12; A01K 97/01

(52) U.S. Cl. CPC A01K 97/125; A01K 97/01

(57) ABSTRACT

A fishing apparatus sensing alarm unit having a processor and at least one sensor, the unit mounted to a fishing apparatus and configured to sense apparatus operation and provide an alarm sensing an apparatus operation event. Sensor can be a motion sensor and the unit mounted to a movable component of the apparatus, sensing movement thereof, and alarming upon sensing movement. Apparatus can be an ice fishing tip up to which the unit is mounted to a movable component, such as a flagpole or shaft, thereof. Sensor can be a magnetic sensor and the unit configured for sensing movement of a magnet of the apparatus and alarming upon sensing magnet movement. Magnet is carried by a base, shaft, or cross bar of the tip up or a spool of a fishing reel with the unit configured to sense magnet movement and output a fish strike alarm upon sensing magnet movement.

### CROSS-REFERENCE

This application is a continuation-in-part of U.S. patent application Ser. No. 17/980,550, filed Nov. 4, 2021, and which claims priority in and the benefit of U.S. Provisional Patent Application No. 63/275,038 filed Nov. 3, 2021, the entire disclosures of each of which are hereby expressly incorporated herein by reference.

### FIELD OF THE INVENTION

The present invention is directed to a fishing equipment alarm system and more particularly to a sensing alarm unit well suited for outdoor use with a fishing apparatus that preferably is an ice fishing tip up and other types of fishing apparatuses, such as fishing reels, which is equipped with at least one onboard magnetic field sensor configured to detect a fish strike by way of detecting rotation of one or more components of the fishing apparatus when a fish strikes.

### BACKGROUND OF THE INVENTION

In the past, there have been many attempts at making sensing units for sensing a fish strike of a fishing apparatus, such as an ice fishing tip up, a rod and reel, or another type of fishing apparatus. One problem is that it can be very difficult to detect accurately when a fish strikes the bait attached to fishing line extending from a spool of a rotary reel of a fishing apparatus such that while many attempts have been made, nearly all have been fraught with difficulties and/or drawbacks. In particular, it can be challenging to accurately detect an amount or rate of rotation and/or number of rotations of such a spool or reel of a fishing apparatus that is indicative of not only a fish strike occurring, but which also avoids false positives, particularly occurrences which appear to be a fish strike that would ordinarily trigger a fish strike alarm but which is not a fish strike.

What is needed is a sensing unit configured for sensing movement of one or more components of a fishing apparatus during fishing operation indicative of a fish strike that is accurate, and which can discriminate against false positives where movement indicative of a fish strike occurs but which is not a fish strike.

### SUMMARY OF THE INVENTION

The present invention is directed to a sensing alarm unit for use with a fishing apparatus, such as preferably an ice fishing tip up or a rod and reel, where the unit is configured for monitoring one or more parameters pertaining to operation of the fishing apparatus and providing feedback to a user upon occurrence of one or more events, such as a fish strike, a fish running with bait, a fish slowing upon tiring after running with bait, a fish disengaging from the bait or breaking fishing line attached to the bait, and/or another type of predetermined known fishing apparatus operational event which can occur during fishing with the apparatus. The sensing unit can have and preferably includes one or more onboard components and/or an arrangement for outputting a human perceptible, such as an audible, visible, tactile, vibratory, etc., feedback, such as in the form of an alarm, can have or include one or more other components, and/or can have or also include an arrangement for wirelessly communicating with one or more other units and/or a transportable portable hand-held controller and/or user alarm unit of an alarm system of the present invention.

A preferred sensing alarm unit configured for monitoring one or more parameters of operation of a fishing apparatus, has one or more sensors each configured to sense a value, magnitude, threshold, and/or range of or pertaining to one or more of the operational parameters during apparatus operation, and has a processor in communication with each sensor which is configured for providing user feedback in the form of one or more alarms upon the one or more sensors sensing a predetermined value, a predetermined magnitude, a predetermined threshold and/or a predetermined range of or pertaining to one or more of the monitored operational parameters, such as movement or operation of one or more components of the apparatus during fishing, indicative of one of the fishing-related events occurring, and providing a corresponding alarm to the user notifying the user of the occurrence of the corresponding event.

In a preferred embodiment, the at least one sensor is a magnetic sensor disposed onboard the unit which can be a Hall sensor, but which preferably is a magnetoresistance (MR) sensor that preferably is a tunneling magnetoresistance (TMR) sensor. The unit can be equipped with a plurality of magnetic sensors, preferably spaced apart from each other, if desired. In another preferred embodiment, the at least one sensor is a motion sensor, such as at least one of a tilt sensor, inclinometer, accelerometer, a gyro, an angular rate sensor, a magnetometer, an Inertial Measurement Unit (IMU) sensor, or a Heading Reference Unit (HRU) sensor. The unit can be equipped with a plurality of motion sensors, preferably spaced apart from each other, if desired. In at least one embodiment, the unit is equipped with at least one magnetic sensor and at least one motion sensor. In at least one other embodiment, the unit is equipped with a plurality of spaced apart magnetic sensors and a plurality of spaced apart motion sensors disposed onboard the unit.

In one embodiment, the fishing apparatus is equipped with a pole, a rotary shaft, and a reel assembly with a spool having fishing line spooled thereon, and the unit is configured to monitor fishing apparatus operation using at least one sensor configured to detect movement of at least one movable component of the apparatus, such as a rod or pole of the apparatus, a rotary shaft, e.g., rotary drive shaft, of the apparatus, and/or a reel assembly, such as preferably a fishing line carrying spool of the reel assembly, of the apparatus which is indicative of a fishing-related event occurring, such as (a) movement of the pole or rod upon occurrence of a fish strike, (b) rotation of the rotary shaft upon occurrence of (i) a fish strike, (ii) a fish running with bait after a fish strike, (iii) a fish tiring and slowing down, and/or (iv) a fish disengaging from the bait, e.g. detaching from a hook or the like carrying the bait such as by throwing the hook, or breaking the fishing line to which the bait is attached, e.g., by a hook or the like, and/or (c) rotation of the spool upon occurrence of (i) a fish striking bait attached to fishing line from the spool of the reel assembly, (ii) a fish running with the bait after striking the bait, (iii) a fish becoming tired after running with the bait, and/or (iv) a fish disengaging from the bait, e.g., detaching from the hook, or breaking the line extending from the spool. Such a fishing apparatus equipped with a reel assembly can be and preferably is an ice fishing apparatus, such as preferably an ice fishing tip up. Such a fishing apparatus equipped with a reel assembly preferably also includes a rod and reel, such as a spinning rod and/or reel, a casting rod, a baitcasting rod and/or reel, a spin-casting rod or reel, a fly rod and/or reel, a trolling rod and/or reel, a surf rod and/or reel, an offshore rod and/or reel or another type of fishing rod and/or reel.

In one such preferred embodiment, the fishing apparatus is an ice fishing apparatus, preferably a tip up, which has a reel assembly equipped with (a) a rotary spool carrying fishing line to which hook-containing or hook-carrying bait is attached, e.g., via a hook, which is initially unspooled from the spool into the water during casting of the bait into the water to seek to entice a fish to take the bait with the spool monitored by the unit by sensing with at least one sensor when the spool: (i) rotates, e.g., begins rotating, after casting when additional line is abruptly unspooled from the spool when a fish strikes upon taking the bait attached to the line, (ii) rotates faster and/or substantially continuously over an extended period of time of at least a plurality, preferably at least a plurality of pairs of, i.e., at least three, seconds when the fish fights and/or runs with the bait unspooling more line from the from the spool (preferably after a fish strike has been detected), (iii) rotates slower and/or substantially continuously over an extended period of time of at least a plurality, preferably at least a plurality of pairs of, i.e., at least three, seconds when the fish tires or slows down (preferably after a fish strike has been detected and/or after it has been detected that the fish has run with the bait), and/or (iv) stops rotating for at least a plurality, preferably at least a plurality of pairs of, i.e., at least three, plurality of seconds when the fish disengages from the bait and/or breaks the fishing line (preferably after a fish strike has been detected); and (b) a rotary drive shaft in operable cooperation with the spool, preferably coupled to the spool, which rotates with the spool as fishing line is unspooled from the spool which is monitored by the unit by sensing with at least one sensor when the shaft: (i) rotates or begins rotating when a fish has taken bait attached to the line causing more line to be unspooled after the spool after initial casting thereby indicating that a fish strike has occurred, (ii) rotates continuously and/or faster for at least a plurality, preferably at least a plurality of pairs, of seconds when the fish fights and/or runs with the bait as more line is unspooled from the from the spool (after a fish strike has been detected), (iii) rotates slower and continuously for at least a plurality, preferably at least a plurality of pairs, of seconds as the rate of line spooling from the spool decreases as the fish tires or slows down (after a fish strike has been detected and/or after it has been detected that the fish has run with the bait), and/or (iv) stops rotating, such as for at least for a plurality of seconds, when the fish disengages from the bait and/or breaks the fishing line (preferably after a fish strike has been detected).

In a preferred tip up embodiment, the rotary drive shaft is connected to the spool in a manner such that rotation of the spool rotates the shaft preferably in unison therewith. In one such preferred embodiment, the unit is equipped with at least one sensor that is a magnetic sensor, preferably a TMR sensor, configured to sense a magnetic field or magnetic flux of at least one source of a magnetic field or magnetic flux, each of which preferably is a permanent magnet, operatively connected to or operatively coupled with either or both the spool and/or the rotary drive shaft for movement of the magnetic field or magnetic flux source substantially in unison therewith. In a preferred embodiment, at least one magnet is carried by the shaft and/or the spool for rotation in unison therewith during fishing with the tip up. In one such preferred embodiment, at least a plurality of magnets is spaced apart from each other and carried by the shaft and/or the spool for rotation in unison therewith during the tip up operation.

The unit is configured to be mounted to the tip up in a manner that positions the at least one magnetic sensor in close enough proximity, i.e., sensing proximity, to the at least one source of magnetic field or magnetic flux, preferably magnet, carried by the shaft or spool in order to sense a magnetic field or magnetic flux of the magnet, preferably a change in a magnetic field of the magnet, and/or preferably a change in a magnetic flux of the magnet indicative of movement, preferably rotation, e.g., change in angle, preferably rotational angle, of the shaft or spool. The at least one magnetic sensor and/or the processor of the unit is or are configured, such as and/or including in software and/or firmware, to detect the occurrence of a fish strike by monitoring for the occurrence of movement, e.g., start of movement, such as preferably in the form of rotation, e.g., start of rotation, of the shaft or spool by the at least one magnetic sensor sensing the magnetic field, preferably a change in the magnetic field, or the magnetic flux, preferably a change in the magnetic flux, of the magnet that occurs when a magnet carried by the shaft or spool begins to move or rotate in response to the shaft or spool beginning to move, preferably beginning to rotate, such as after casting of the bait has taken place.

The processor and/or the at least one magnetic sensor of the unit is or are also configured, such as and/or including in software and/or firmware, to detect if a fish that has taken the bait is running with the bait, e.g., fighting, by monitoring for movement, preferably rotation, of the shaft or spool occurring after a fish strike has been detected by the at least one magnetic sensor sensing the magnetic field, preferably a change in the magnetic field, or the magnetic flux, preferably a change in the magnetic flux, of the magnet indicative of movement, preferably additional movement, more preferably rotation, even more preferably additional rotation, of the shaft or spool occurring that is indicative of the fish running with the bait. In a preferred embodiment and implementation of a method of operation, the processor and/or the at least one magnetic sensor of the unit is or are preferably configured to detect if a fish is running with the bait by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor due to movement of the shaft or spool of the apparatus from which an angle, a change in angle, a rotational angle, a change in rotational angle, an increase in rotation, an increase in the rate of rotation, an increase in an angular velocity, an increase in angular acceleration, a jerk factor, an increase in the rate or speed of rotation, an increase in rotations per unit time, e.g., increase in revolutions per minute (RPMs), of the shaft or spool is determined or obtained that is indicative of a fish running with the bait. The processor and/or the at least one magnetic sensor preferably is or are configured to begin monitoring for the occurrence of a fish running with the bait only after a fish strike has first been detected.

The processor and/or the at least one magnetic sensor of the unit preferably is or are further configured, such as and/or including in software and/or firmware, to detect if a fish is slowing down how fast it is running with the bait, e.g., tiring, by monitoring for movement, preferably rotation, of the shaft or spool occurring by the at least one magnetic sensor sensing the magnetic field, preferably a change in the magnetic field, or the magnetic flux, preferably a change in the magnetic flux, of the magnet indicative of movement, preferably reduced movement or a reduction in movement, more preferably rotation, even more preferably reduced rotation or a reduction of rotation, of the shaft or spool occurring during fishing apparatus operation. In a preferred embodiment and method implementation, the processor and/or the at least one magnetic sensor of the unit is or are also configured to detect if a fish is slowing how fast it is running with the bait by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor caused by movement of the shaft or spool from which an angle, a change in angle, a rotational angle, a change in rotational angle, a decrease in rotation, a decrease in the rate of rotation, a decrease in an angular velocity, a decrease in angular acceleration, a jerk factor, a decrease in the rate or speed of rotation, a decrease in rotations per unit time, e.g., decrease in revolutions per minute (RPMs), of the shaft or spool is determined or obtained that is indicative of a fish slowing in how fast it is running with the bait. The processor and/or the at least one magnetic sensor preferably is or are configured to begin monitoring for the occurrence of a fish slowing in how fast it is running with the bait after a fish strike has been detected and/or after a fish running with the bait has been detected. In a preferred embodiment, the processor and/or the at least one magnetic sensor preferably is or are configured to begin monitoring for the occurrence of a fish slowing in how fast it is running with the bait only after a fish strike has first been detected and only after a fish running with the bait has also been detected.

The processor and/or the at least one magnetic sensor of the unit preferably is or are further configured, such as and/or including in software and/or firmware, to detect if a fish has disengaged or detached from the fishing line attached to the spool, e.g., thrown the hook, detached from the bait or broken the line, by monitoring for movement, preferably rotation, of the shaft or spool occurring by the at least one magnetic sensor sensing the magnetic field, preferably a change in the magnetic field, or the magnetic flux, preferably a change in the magnetic flux, of the magnet indicative of movement, preferably of significantly reduced movement such as preferably a stoppage or cessation of movement, more preferably of rotation, even more preferably of significantly reduced rotation, such as preferably a stoppage or cessation of rotation, of the shaft or spool occurring during fishing apparatus operation. In a preferred embodiment and method implementation, the processor and/or the at least one magnetic sensor of the unit is or are also configured to detect if a fish has disengaged or detached from the line by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor corresponding to movement of the shaft or spool during fishing apparatus operation from which an angle, e.g., change in angle, such as where there is no change in angle, a rotational angle, a change in rotational angle, such as where there is no change in rotational angle, a significant decrease in rotation, such as a cessation or stopping of rotation, a decrease, preferably significant decrease, in the rate of rotation, such as the rate of rotation rapidly dropping to a level close to zero, about zero, or becoming zero, a significant decrease in an angular velocity, such as the angular velocity dropping to a level close to zero or zero, a decrease in angular acceleration, such as the angular acceleration dropping to close to zero, about zero, or becoming zero, a jerk factor, such as the jerk factor dropping to zero, a decrease in the rate or speed of rotation, such as dropping to about zero or becoming zero, a decrease in rotations per unit time, e.g., decrease in revolutions per minute (RPMs), such as dropping to about zero or zero rotations per unit time, e.g., decreasing in RPMs to about zero or zero, of the shaft or spool, such as for a predetermined period of time, e.g., for at least one-half second, one second or even a plurality of seconds, is determined or obtained that is indicative of a fish having disengaged or detached from the line.

In a preferred embodiment and method implementation, a fish disengaging or detaching from the line is detected upon occurrence of where there is no change in angle of the shaft or spool for at least one half second, at least one second, at least a plurality of seconds, or even at least a plurality of pairs of, i.e., at least three, seconds, where there is no change in rotational angle for at least one-half second, at least one second, at least a plurality of seconds, or at least a plurality of pairs of, i.e., at least three, seconds, where there is a cessation or stopping of rotation for at least one-half second, at least one second, a plurality of seconds, or even a plurality of pairs of, i.e., at least three, seconds, where the rate of rotation drops to about zero or zero for at least one-half second, at least one second, at least a plurality of seconds, or even at least a plurality of pairs of, i.e., at least three, seconds, where the angular velocity drops to a level of about zero or zero for at least one-half second, at least one second, at least a plurality of seconds, or even at least a plurality of pairs of, i.e., at least three, seconds, where the angular acceleration drops to about zero or zero for at least one-half second, at least one second, at least a plurality of seconds, or even at least a plurality of pairs of, i.e., at least three, seconds, where the jerk factor drops to zero for at least one-half, at least one second, at least a plurality of seconds, or at least a plurality of pairs of, i.e., at least three, seconds, a decrease in the rate or speed of rotation, such as dropping to about zero or zero for at least one-half, at least one second, at least a plurality of seconds, or at least a plurality of pairs of, i.e., at least three, seconds, a decrease in rotations per unit time, e.g., decrease in RPMs, such as dropping to about zero or zero rotations per unit time, e.g., decreasing in RPMs to about zero or zero, for at least one-half second, at least one second, at least a plurality of pairs of seconds, or even at least a plurality of pairs of seconds. The processor and/or the at least one magnetic sensor preferably is or are configured to begin monitoring for the occurrence of a fish disengaging or detaching from the line after casting and after a fish strike has been detected. If desired, the processor and/or the at least one magnetic sensor can be configured to begin monitoring for the occurrence of a fish disengaging or detaching from the line after casting, after a fish strike has first been detected, after a fish running with the bait has also been detected and/or after a fish has slowed in running with the bait.

In a preferred embodiment, the spool and/or the shaft of the fishing apparatus, preferably tip up, carries at least a plurality and preferably carries at least a plurality of pairs of, i.e., at least three, magnets which are preferably are equidistantly and/or equiangularly spaced apart from each other and/or from or relative to an axis of rotation of the spool and/or the shaft. In one preferred embodiment, there are at least a plurality of magnets and can be a plurality of pairs of magnets mounted to or carried by the shaft for rotation in unison with the shaft during rotation of the spool operatively coupled or operatively connected to the shaft. In one such embodiment, there is a magnet carried by each segment of a crossbar mounted to the shaft that is configured to releasably retain a pole of a fish strike indicator flag in a ready to trigger position that moves, preferably pivots, toward and to a fish strike indicating position when the shaft rotates enough to disengage the crossbar during occurrence of a fish strike.

In one embodiment, a single magnet can be attached to or otherwise carried by the crossbar for movement, preferably rotation, substantially in unison with the crossbar during fishing apparatus, preferably tip up, operation, the magnet having one magnetic pole disposed on or extending along one segment of the crossbar and an opposite pole disposed on or extending along the other segment of the crossbar. In another embodiment, there are a plurality of magnets attached to or carried by the crossbar for rotation substantially in unison therewith with one magnet attached to, extending along, and/or otherwise carried by at least a portion of one segment of the crossbar and another magnet attached to, extending along, and/or carried by the other crossbar segment.

In a further embodiment, a plurality, preferably a plurality of pairs of magnets are attached to the shaft and arranged so they are equidistantly and/or equiangularly spaced apart from each other about the shaft and equidistantly radially spaced from the shaft with the magnets oriented so as to extend radially outwardly from or relative to the shaft having one of their magnetic poles facing toward the shaft and the other one of their poles facing away from the shaft. In such an embodiment, the magnets can be mounted in or to a circular disk that is fixed to the shaft an axial distance from the crossbar such that the disk and magnets rotate in unison with the shaft with each magnet extending in a radial direction outwardly from the shaft such that one of the poles of each magnet faces radially outwardly away from the shaft.

It also is contemplated that a magnet holder, such as a magnet-holding cartridge, carrying at least one magnet and preferably a plurality of spaced apart magnets can be used that is releasably attached to or otherwise carried by the crossbar and/or shaft so that holder and its magnets rotate substantially in unison therewith. In a preferred embodiment, the magnet holder is composed of a non-magnetic material, such as preferably plastic, and configured for snap-fit attachment to one or both bar segments and/or an adjacent part of the shaft in a manner that positions one magnet adjacent or along a portion of one of the crossbar segments and positions the other magnet adjacent or along a portion of the other one of the segments.

In a further preferred embodiment, a spool of a reel assembly of a fishing apparatus, which can be a rod and reel or a tip up, is configured to carry at least a plurality, preferably at least a plurality of pairs of, i.e., at least three, magnets which are equiangularly and equidistantly spaced apart from each other and equidistantly spaced from a centrally located axis of rotation of the spool, and with each magnet oriented with one of its magnetic poles facing radially outwardly away from the rotational axis of the spool. The radially outermost disposed pole of each magnet is disposed adjacent and radially underlies a cylindrical fishing line carrying outer surface of the spool defining a magnet track composed of the plurality, preferably plurality of pairs of spaced apart magnets that is non-straight, preferably annular, more preferably generally cylindrical, and even more preferably defines a wheel that rotates during casting, during occurrence of a fish strike where a fish has taken bait attached to fishing line spooled therearound, when a fish runs with the bait after striking the bait unspooling line from the spool, and/or when a fish tires after striking the bait and/or running with the bait also unspooling line from the spool.

In one such spool embodiment, each magnet is received in a pocket formed in the spool that orients the magnet so the magnet extends radially outwardly from or relative to the rotational axis of the spool towards or to the outer fish-line carrying surface of the spool with one of the poles of the magnet directly underling the outer surface of the spool. The spool can have a corresponding spoke or rib that extends radially outwardly from a centrally located hub through which the rotational axis is disposed towards and preferably to each one of the magnet-holding pockets. The spool can be formed of a pair of halves, which are preferably symmetrical and/or a mirror image of one another, which are assembled together with a magnet received in each pocket to produce the spool. In a preferred embodiment, the spool has three equiangularly and/or equidistantly spaced apart magnets received in a corresponding one of the magnet-holding pockets of the spool.

The unit is configured for mounting, such as with a mounting arrangement, such as described in more detail below, and removably mounted to the fishing apparatus, such as a fishing apparatus equipped with a reel assembly, like a rod and reel or tip up, in a location on the apparatus that positions a magnetic sensor of the unit in close enough proximity to a magnet of the apparatus so as to dispose the magnetic sensor in magnetic field and/or magnetic flux sensing proximity to the magnet during movement, preferably rotation, of the shaft or spool carrying the magnet, such as in a manner the same as or like that described above, during fishing with the apparatus. Where there is more than one magnet carried by and/or in operable cooperation with the shaft or spool, the unit preferably is mounted, such as by its mounting arrangement, where its magnet sensor is positioned close enough to the magnets carried by and/or in operable cooperation with the shaft or spool for each one of the magnets to pass by, preferably sequentially, in sensing proximity to the sensor during movement, preferably once during each rotation, of the shaft or spool during apparatus operation.

As the spool or shaft rotates, at least one and preferably each magnet passes by a magnet sensor of the unit, preferably in sensing proximity thereto, during fishing apparatus, preferably tip up, operation enabling (1) sensing of at least one of the magnetic field, increase in magnetic field strength, decrease in magnet field strength, magnetic flux, increase in magnetic flux and/or decrease in magnetic flux of the magnet passing by, and (2) detection or determination, such as preferably by the processor of the unit, whether any of (a) (i)-(iv) and/or (b) (i)-(iv) is occurring. Depending on which one of (a) (i)-(iv) and/or (b) (i)-(iv) is detected or determined as occurring, the unit will provide, preferably output, either in human perceptible form, e.g., visually, audibly, vibrationally, etc., and/or wirelessly, e.g., via radio frequency communication, notification, e.g., an alarm, that an event corresponding to one of (a) (i), a (ii), a (iii) and/or a (iv), and/or (b) (i), b (ii), b (iii) and/or b (iv) that indicates the corresponding one of (a) (i), a (ii), a (iii) and/or a (iv), and/or (b) (i), b (ii), b (iii) and/or b (iv) is occurring.

In another preferred embodiment, the present invention is directed to a fishing apparatus sensing alarm unit configured for sensing one or more parameters of operation of a fishing apparatus, such as a tip up or a rod and reel, the unit having at least one sensor that is or includes at least one motion sensor configured for sensing at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor, where the unit is configured to be mounted or attached to the fishing apparatus, and wherein the unit is configured, such as and/or including in software and/or firmware, to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus. The at least one motion sensor preferably is an accelerometer, such as at least a 3-axis accelerometer, a gyro, such as at least a 3-axis gyro, a magnetometer, such as at least a 3-axis magnetometer, an IMU, an HRU, a GPS sensor, an inclinometer, an angle sensor, or a tilt sensor disposed onboard the unit. If desired the unit can be equipped with a plurality of motion sensors and can have none, one, or more than one magnetic sensor.

During operation, the at least one motion sensor senses at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus. The processor can be configured, such as and/or including in software and/or firmware, to determine at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus from data and/or signals received by the processor from the at least one motion sensor during fishing operation of the apparatus.

The unit, preferably the processor and/or the at least one motion sensor, is configured, such as and/or including in software and/or firmware, to (a) monitor operation of the apparatus in the above manner, (b) detect one or more fishing events that include one or more of (1) a fish strike, (2) a fish running with bait after a fish strike, (3) a fish tiring and slowing down, and/or (4) a fish disengaging from the bait, e.g. detaching from a hook or the like carrying the bait, or breaking the fishing line to which the bait is attached, e.g., by a hook or the like, based on whether one or more of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus meets or exceeds a predetermined value, magnitude, or threshold, meets or falls below a predetermined value, magnitude, or threshold, and/or falls within or lies outside of a predetermined range, and (c) provide feedback to a user of the apparatus, such as preferably in the form of an audible, visually perceptible, tactile, vibrational, etc. alarm, corresponding to the event detected during fishing with the apparatus depending on the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed by the at least one motion sensor during fishing apparatus operation. The unit, preferably processor and/or the at least one motion sensor, is configured to monitor operation of the fishing apparatus to determine whether the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed during fishing with the apparatus meets or exceeds the predetermined value, magnitude, or threshold, meets or falls below the predetermined value, magnitude, or threshold, and/or falls within or lies outside of the predetermined range that indicates (b)(1), (b)(2), (b)(3) or (b)(4) is occurring and provides feedback to the user of the apparatus, such as preferably in the form of an audible, visually perceptible, tactile, vibrational, etc. alarm, corresponding to the specific one of event (b)(1), (b)(2), (b)(3) or (b)(4) detected during fishing with the apparatus.

In one preferred embodiment, the unit is configured to be releasably mounted or attached by a mounting arrangement to the fishing apparatus, the processor and/or the at least one motion sensor is or are configured, such as and/or including in software and/or firmware, to sense and/or determine at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of a component, such as a shaft, preferably a rotary drive shaft, and/or spool, such as of a reel assembly of the apparatus, or a pole, e.g., tip up fish strike indicator flagpole, or rod, e.g., rod of a rod and reel, of the apparatus that is movable relative to one or more other components of the apparatus during fishing with the apparatus. The unit is mounted in operable communication with and preferably is operatively connected to the movable component of the apparatus in a manner enabling the at least one motion sensor to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the movable component during apparatus operation. The unit preferably is configured to be mounted by the mounting arrangement to the movable component, such as by being releasably clamped to the shaft, e.g., drive shaft, pole, e.g., tip up flagpole, or rod, e.g., fishing pole or rod of a rod and reel, of the apparatus for movement substantially in unison with the movable component during fishing operation of the apparatus. The unit, preferably its mounting arrangement, can be configured for releasable mounting with the at least one motion sensor disposed in operable cooperation with the spool and/or operatively connected to the spool in a manner that enables at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the spool to be sensed during apparatus operation using the at least one motion sensor and/or determined using the processor.

In another preferred embodiment, the fishing apparatus has a rod or pole and unit can be and preferably is configured for releasable mounting to the rod or pole with the at least one motion sensor and/or processor of the unit configured to sense one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, an angular velocity, an angular acceleration, and an angular jerk or an angular jerk factor indicative of a change in the position of the pole or rod during fishing with the apparatus to determine whether the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed by the at least one motion sensor and/or determined by the processor are indicative of one of a fish strike, a fish running with the bait, a fishing tiring, or a fish disengaging from the bait or breaking the fishing line.

In one such preferred embodiment, the fishing apparatus is an ice fishing apparatus, preferably a tip up, equipped with a rod or pole, such as preferably a fish strike indicator flagpole, in releasable engagement with part, e.g., a crossbar, of a rotary drive shaft coupled to a spool of a reel assembly of the apparatus where the pole or rod is configured to be movable between a generally horizontal ready to trigger position, where it is engaged with the part of the shaft and ready to trigger upon occurrence of a fish strike, and a generally upright or vertical fish strike indicating position disposed from the ready to trigger position when rotation of the shaft disengages the rod or pole therefrom when a fish strike occurs. The unit can be and preferably is configured for releasable mounting to the rod or pole for movement substantially in unison with the at least one motion sensor and/or processor of the unit configured to sense one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, an angular velocity, an angular acceleration, and an angular jerk or an angular jerk factor of the rod or pole indicative of a change in the position of the pole or rod moving from the horizontal ready to trigger position towards the vertical fish strike indicating position. The unit, preferably its processor and/or the at least one motion sensor, is configured to monitor the position of the rod or pole, sense when the rod or pole moves or begins moving from the ready to trigger position toward or to the fish strike indicating position and provides feedback to the user, such as preferably in the form of an audible, visually perceptible, tactile, vibratory, etc. alarm telling the user that a fish strike has occurred.

In a further preferred embodiment, unit is configured for being operably coupled, preferably operatively connected, and preferably is operably coupled, preferably operatively connected, to a rotary drive shaft of a fishing line carrying spool of a reel assembly of a fishing apparatus in a manner that enables the at least one motion sensor of the unit to sense at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft is the shaft is rotated by the spool being rotated due to fishing line unspooling from the spool by a fish during fishing apparatus operation. The processor and/or at least one motion sensor are configured to determine whether the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed during fishing apparatus operation are indicative of one of a fish strike, a fish running with the bait, a fishing tiring, or a fish disengaging from the bait or breaking the fishing line. The processor and/or at least one motion sensor are further configured to determine whether the sensed position, change in position, angle, change in angle, orientation, change in orientation, movement, change in movement, velocity, acceleration, jerk or jerk factor, rotation, change in rotation, rotational angle, change in rotational angle, number of rotations, number of rotations per unit time, number of rotations per minute, angular velocity, angular acceleration, and angular jerk or angular jerk factor meets or exceeds a predetermined value, magnitude, or threshold, meets or falls below the predetermined value, magnitude, or threshold, and/or falls within or lies outside of a predetermined range that indicates a casting event is occurring, a fish strike event is occurring, a fish running with the bait event is occurring, a fish tiring event is occurring, or a fish disengaged from the bait or broken line event is occurring during fishing with the apparatus and provides feedback to the user of the apparatus, such as preferably in the form of an audible, visually perceptible, tactile, vibrational, etc. alarm, corresponding to the specific one of these events that has occurred or is occurring.

In one such preferred embodiment, the fishing apparatus is an ice fishing apparatus that preferably is an ice fishing tip up and the unit is configured to be releasably mounted by a mounting arrangement that preferably is a clamp that clamps the unit to a rotary drive shaft of the tip up that is operatively coupled, preferably operatively connected, to a fishing-line carrying spool of a reel assembly of the tip up to enable rotation of the shaft caused by rotation of the spool due to a fish striking the bait unspooling line from the spool, a fish running with the bait unspooling line from the spool at a relatively fast rate, or a fish tiring unspooling line from the spool at a slower rate than a fish running with the bait to be sensed by the at least one motion sensor of the unit. During fishing operation, the unit clamped to the shaft rotates substantially in unison with the shaft with the at least one motion sensor sensing at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft and the processor determining from the sensed data and/or signals from the at least one motion sensor whether a fish strike has occurred after casting of the bait, a fish is running with bait after a fish strike has occurred, a fish is tiring such as after a fish strike has occurred, or a fish has detached from the bait and/or broken the line.

The processor can be configured to monitor the apparatus to determine whether a casting event has occurred where fishing line carrying a bait, such as attached to the line by a hook or the like, has taken place where line has been unspooled from the spool to position the bait in the water in a manner where a fish can strike the bait. The processor can be configured to do so by accepting a manual input, such as through a control, e.g., a button or the like, or other input, e.g., such as via or using an app on a processor-equipped device like a smartphone, tablet, or computer, that indicates a casting event has occurred. The processor can also be configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a casting event occurring or having occurred.

The processor is configured to monitor apparatus operation to determine whether a fish strike event has occurred where fishing line carrying a bait is further rapidly unspooled from the spool after casting when a fish bites the bait thereby striking the bait. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish strike event occurring or having occurred.

The processor also is configured to monitor apparatus operation to determine whether a fish running with the bait event has occurred where fishing line carrying a bait is rapidly unspooled from the spool after occurrence of a fish strike event thereby indicating the fish is fighting. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish running with the bait event occurring or having occurred. In a preferred embodiment and method implementation, the processor can be further configured to communicate with a drag assembly of the fishing apparatus to increase drag on the fishing line in response to detection of a fish running with the bait event.

The processor is further configured to monitor apparatus operation to determine whether a fish tiring event has occurred where fishing line carrying a bait is less rapidly unspooled from the spool compared to an earlier rate of unspooling of the line and after a fish strike event has occurred. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish tiring event occurring or having occurred. In a preferred embodiment and method implementation, the processor can be further configured to communicate with a drag assembly of the fishing apparatus to decrease drag on the fishing line in response to detection of a fish tiring event.

The processor is still further configured to monitor apparatus operation to determine whether a fish detaching from bait or line breaking event has occurred where fishing line abruptly ceases being unspooled from the spool and after a fish strike event has occurred. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish disengaging from bait or breaking the line event occurring or having occurred.

The processor and/or at least one motion sensor are configured to determine whether the sensed position, change in position, angle, change in angle, orientation, change in orientation, movement, change in movement, velocity, acceleration, jerk or jerk factor, rotation, change in rotation, rotational angle, change in rotational angle, number of rotations, number of rotations per unit time, number of rotations per minute, angular velocity, angular acceleration, and angular jerk or angular jerk factor meets or exceeds a predetermined value, magnitude, or threshold, meets or falls below the predetermined value, magnitude, or threshold, and/or falls within or lies outside of a predetermined range that indicates a casting event is occurring, a fish strike event is occurring, a fish running with the bait event is occurring, a fish tiring event is occurring, or a fish disengaged from the bait or broken line event is occurring during fishing with the apparatus and provides feedback to the user of the apparatus, such as preferably in the form of an audible, visually perceptible, tactile, vibrational, etc. alarm, corresponding to the specific one of these events that has occurred or is occurring.

The present invention also is directed to an inventive alarm system for a fishing apparatus having a sensing alarm unit configured for sensing movement of a component of the fishing apparatus, such as a fish strike indicator, which moves during a fish strike and outputting an alarm indicating a fish strike has occurred in response to movement of the component of the fishing apparatus. One preferred fishing apparatus is an ice fishing tip up that includes a base having an opening therein, an upright having a top and bottom extending through the opening in the base, a crossbar or spindle bar extending from the upright adjacent to the top of the upright, a spool located adjacent to the bottom of the upright, and a fish strike indicator, such as a flagpole, in releasable engagement with the crossbar or spindle bar which disengages therefrom and moves toward a fish strike indicating position during a fish strike. The unit is equipped with a housing having at least one mounting mechanism used for mounting the unit to the fishing apparatus. The unit contains a power source, at least one sensor, and a processor. The unit can also contain a wireless transmitter or wireless transceiver.

The unit is movable between a first mounting configuration configured and used to mount the unit to one part of the fishing apparatus and a second mounting configuration configured and used to mount the unit to another part of the fishing apparatus. In the first configuration, the mounting mechanism uses a releasable clamp which secures the unit to the fish strike indicator, such as to the flag pole, of the fishing apparatus. In the second configuration, mounting mechanism includes a mount with a dovetail joint or twist lock joint is configured to secure the unit to the base of the fishing apparatus. Regardless of the configuration, an alarm is distributed from the unit housing when a fish strikes, such as one which causes rotation of the spool of the fishing apparatus occurs. In the second configuration, at least one magnet is associated with one or more of the upright and the crossbar or spindle bar of the fishing apparatus.

The at least one sensor contained within the housing of the sensing alarm unit detects rotation of the crossbar or spindle bar based on magnetic signals from the at least one magnet. The at least one sensor can detect the number of rotations, as well as the speed or rotations of the crossbar or spindle bar. The unit housing can also include at least one LED light, where the at least one LED light flashes different light sequences based on the number of rotations and speed of rotations, allowing a user to understand the number and speed of rotations from afar. Also, the unit can be equipped with a wireless transmitter that can transmit a signal wirelessly to a master controller also located afar from the sensing alarm unit.

Additionally, a magnet can be associated with the base of the fishing apparatus. In the first mounting configuration, the at least one sensor of the unit can detect the presence of the magnet when the flagpole of the fishing apparatus is located in an armed position where the flag pole is partially or substantially parallel with the base. In the armed position, the unit housing can still be vertically displaced from the magnet, preventing the unit from potentially freezing to the magnet. When the flagpole is released by the crossbar or spindle bar of the fishing apparatus, the flag pole moves upwardly to a disarmed position, and the at least one sensor of the unit detects the lack of the magnet. The sensing alarm unit then notifies a user that the flagpole is in the disarmed position. Alternatively, the at least one sensor can include an accelerometer that detects movement of the unit, such as when the flagpole is moved from the armed position to the disarmed position and the unit is attached to the flag pole.

Additionally, the mounting mechanism includes a plurality of flexible clamp jaw fingers of a clamp configured to mount the unit to a pole or rod, a thumbscrew, and at least one fastener opening. In the first mounting configuration, the thumbscrew is twisted to tighten or loosen the fingers relative to one another to accommodate different sized flag poles. In the second mounting configuration, at least one fastener can be inserted into the base of the fishing apparatus through the at least one fastener opening in the mounting mechanism.

The present invention is directed to an inventive alarm system according to at least one preferred embodiment of the present invention. The alarm system includes at least one base unit that is a sensing alarm unit configured with an onboard processor and at least one onboard sensor which is configured for use as a fish strike monitor that is used to monitor a device or apparatus that preferably is a fishing apparatus that more preferably is an ice fishing tip up used outdoors to catch fish. Once the onboard sensor detects that a fish has engaged with the fishing apparatus, the unit issues an alarm via flashing lights, differently colored lights, sounds, vibrations, and combinations or sequences thereof, wireless RF and/or Bluetooth digital communications, including with at least one transportable handheld portable alarm unit, e.g., handheld controller, as well as with one or more smartphones, tables, laptops, computers and the like notifying a user, e.g., fisherman, of the occurrence of a fish strike. Additionally, the alarm system can include multiple sensing alarm units that can be used on fishing apparatuses, such as ice fishing tip ups, at multiple different fishing locations, with each of the units communicating with a controller. The unit housing can be oriented relative to the fishing apparatus to which it is mounted in a variety of ways as will further be described below.

One preferred fishing apparatus is an ice fishing tip up that includes a generally planar base with an opening formed therein between a pair of frame rails in which a tip-up spindle shaft is pivotably mounted to the rails. The tip-up spindle shaft includes a coaxial drive shaft attached to rotary spool having a fishing line (not shown) at least partially wrapped around the spool and a hook (not shown) or the like connected to an end of the fishing line that is configured for releasable attachment of bait, such as in the form of a fishing lure, fishing jig, a fly, nightcrawler(s), minnow(s) or another type of fish attracting bait. The tip up has spindle bar or crossbar located above the spindle shaft that is connected to the drive shaft for rotation in unison therewith when fishing line unspools from the spool when a fish strikes by taking the bait. The tip up includes a flag with a bendable flagpole that is armed by being releasably retained in a generally horizontal fish strike indicator trigger ready position by part of the flagpole releasably engaging with the spindle bar or the crossbar. The flagpole is anchored to the tip up base and resiliently biased by a coil spring biasing element to spring uprightly into a generally vertical fish strike indicating position when a fish strikes the bait unspooling line from the spool rotating the spool, drive shaft and spindle bar or crossbar disengaging the flagpole therefrom.

The sensing alarm unit has a housing that includes a front sidewall, a back sidewall, and an elongate U-shaped housing holder clip configured to hold the front sidewall and back sidewall together in registry with each other thereby enclosing internal components that include a processor, a wireless receiver, preferably wireless RF transceiver, a power supply, e.g., a single AA or AAA alkaline or lithium battery, one or more lights, e.g., LEDs, an audio transducer, at least one sensor configured for sensing a fish strike, a proximity sensor, a motion sensor, and/or at least one or more of an inclinometer, angle sensor, angular rate sensor, accelerometer, gyroscope, and/or inertial measurement unit (IMU) and circuit board to which the aforementioned components are mounted to. The unit preferably is equipped with multiple LED lights, such as one or more of Red Green Blue LED lights which are configured to display a plurality of different light intensities, flashing patterns and/or color sequences. The unit may have different magnetic sensors, including one or more magnetoresistance sensor (MR) magnetic sensors that preferably are or include at least one onboard tunneling magnetoresistance sensor (TMR) magnetic sensor and preferably a plurality of onboard TMR sensors. The sensing alarm unit housing may include different magnetic sensors, such as a reed switch or but preferably has a TMR sensor, preferably two TMR sensors, and may have one or more other sensors, preferably motion sensor(s), configured to monitor the position, angle, orientation, and/or movement of the unit, including for instance a position sensor, a motion sensor, an acceleration sensor, a velocity sensor, an angle sensor, a tilt sensor, as well as one or more other sensors. The unit may have one or more user, e.g., fisherman, manipulable controls, e.g., button, configured to change one or more settings, parameters or the like of the unit, such as to be manipulated to pair the sensing alarm unit to at least one transportable portable handheld alarm unit that can be configured with one or more manipulable controls, including at least one control or control setting configured to power on the unit, change a color scheme of the LED lights used to issue a visual or visible alarm, and resetting or rearming the fish strike detecting sensor after detecting a fish strike and tripping the alarm. If desired, the unit has an magnetically attractive magnetic anchor disposed adjacent and preferably inline with an onboard fish strike sensing sensor that preferably is a magnetic sensor.

The sensing alarm unit is mounted by a multiple position or multiple orientation mount to the fishing apparatus, preferably tip up, that releasably attaches to the unit by a twist-lock dovetail joint formed between the unit housing and the mount. The mount can be directly attached to the base of the tip up via an adhesive or using a plurality of fasteners that extend through a bottom wall of the mount. The mount also includes at least one clamp configured for releasable clamping onto the flagpole of the tip up fish strike indicator flag to releasably mount the unit by clamping the clamp onto the flagpole. It is contemplated as being within the scope of the present invention to use a pair of the mounts with one mount attached via a dovetail joint to one end of the unit and releasably clamped to one part of the flagpole and the other mount via a dovetail joint to one end of the unit and releasably clamped to another part of the flagpole.

In a first operating position or orientation, the mount is fixed to the base of the tip up, such as adhesively or using a plurality of fasteners, with the unit releasably attached to the mount via the twist-lock dovetail joint positioning the onboard sensor close enough to the rotatable spindle bar to sensor rotation of the spindle bar from a fish strike. The sensor can preferably be one or more TMR sensors configured to detect a magnetic pole of a fish strike indicator trigger magnet attached to opposite ends of the spindle bar when the spindle bar is rotated by a fish unspooling line from the spool during and after a fish strike. As such, in the event that the rotatable spindle bar and the drive shaft begin to rotate due to pulling of the line from the spool by a fish, each TMR sensor onboard the unit detect(s) any rotations based on movement of the magnets carried by the rotary spindle bar relative to rotation of the rotary spindle bar and/or the drive shaft. For instance, the TMR sensors may detect when a partial spool rotation occurs, when a single spool rotation occurs, when two or more spool rotations occur, when five or ten spool rotations occur, or when the spindle bar, drive shaft and spool continuously rotate. Such an embodiment is advantageous in that it allows a user to detect when only a single or partial rotation occurs, which could occur when the line and/or hook are only briefly moved by a fish or other object, such as when a fish nibbles at a piece of bait but does not engage the hook. This helps to prevent false positive fish strike alarms from being issued, in which case a user would receive an indication from the unit and approach the unit only to find that the fish did not get hooked by the hook. The unit may be configured to only alert a user when a predetermined number of spool rotations have occurred to avoid wasted time based on false positives where not even a single spool rotation had occurred. Additionally, the TMR sensors can be configured to detect the rotational speed of the spool including at rotational or time intervals, which can provide helpful insight to a user. Where faster speeds of rotation are detected by the sensor that output visual and/or audible alarms enabling speed of spool rotation to estimated remotely by the user, e.g., fisherman, may be useful to help the user to know that he or she needs to quickly proceed to the tip up to check if a fish strike occurred and/or attend to the tip up.

In a second preferred operating position and/or orientation, the sensing alarm unit is releasably clamped or clipped by the mount to the flag pole using a releasable clamp onboard the mount to releasably but securely clamp onto the pole. More specifically, the unit is clipped to the flag pole, after which a thumbscrew of the clamp is twisted or rotated to tighten the clamp jaws against the flagpole positively securing the unit to the flag pole. Once the unit is mounted to the flag pole, the flag pole is urged downwardly against the spring bias of the coil spring until the flag pole is releasably held in place by the rotatable spindle bar, arming the fish strike indicator flag in a generally horizontal trigger ready position. In the event that the rotatable spindle bar and drive shaft begin to rotate due to pulling of the line from the spool by a fish striking and taking bait attached to the line, the rotatable spindle bar disengages from the flagpole. Because of the force of the coil spring, the flagpole is urged upwardly by the coil spring biasing force. When this occurs, a user can see that the flag and flagpole have been elevated into a generally vertical or upright fish strike indicator position. In addition to the visual representation of the elevated flag, the unit also displays various LED light signals, brightness's, on off sequences, etc. providing the user with notice of the occurrence of a fish strike. Because the flagpole moves upwardly, the unit also is in a raised configuration to improve visibility of the LED lights onboard the unit that are also energized to provide light fish strike alarm. In addition to the visual signals, a radio, Bluetooth, or other signal may be transmitted to a portable alarm unit on the person of a user who is remotely located a further distance away, or visually blocked from being able to see the light of the unit, such as when the user is indoors. A magnet mounted on the base of the tip up causes the TMR magnetic sensor to trigger upon movement of the magnetic sensor and senor alarm unit away to magnet when elevated with flagpole when disengaged from the spindle bar. When the flagpole is moved from the lowered generally horizontal armed position to the raised fish strike indicating position, the sensor separates from the magnet triggering the sensor to cause one or a visible or audible fish strike indicator and/or spool rotation alarm to be outputted by the unit.

In yet another sensing alarm unit operating position and/or orientation, the unit may be mounted to the rotatable spindle bar and/or the drive shaft of the tip up. In such an embodiment, the unit would be configured to detect movement of the rotatable spindle bar and/or the drive shaft for instance using a motion sensor, such as an accelerometer, a position sensor, a velocity sensor, an angle sensor, a tilt sensor, or another type of motion sensor. Thus, in the event that the rotatable spindle bar and the drive shaft begin to rotate due to pulling of the line from the spool by a fish, at least one of the above-identified sensors onboard the unit can detect this movement and alert a user. Much like the first orientation described above, the settings of the unit can be adjusted such that an alert is only sent when a threshold amount of rotation occurs so as to avoid false positives. Similarly, additional information such as the number of rotations, speed of rotations, etc. could be monitored, and the user can be notified accordingly.

Regardless of the orientation, when a user is alerted of a fish strike, he or she can check the tip up for fish upon issuance of one of a fish strike alarm and/or spool rotation alarm and rearm the sensing alarm unit if needed.

The present invention thereby also is directed to a fishing equipment alarm system and more particularly to a sensing alarm unit thereof that is well suited for outdoor use with an ice fishing tip up and other types of fishing apparatuses, such as other types of fishing reels, and which is equipped with an onboard magnetic field sensor, e.g., magnetic sensor, configured for more sensitive and/or selective magnetic field or flux sensing that preferably is an MR sensor, which more preferably is a TMR sensor, positioned and/or orientated relative to one or more sensor triggering magnets in one or more sensor trigger magnet arrangements where each magnet can be spaced from the magnetic sensor(s) of the unit a distance whereby there is an air gap between the onboard magnetic sensor(s) and adjacent triggering magnet passing by the sensor(s) during rotation of one or more components of a fishing apparatus indicative of a fish strike, and whose magnets can be positioned at varying magnetic pole angles and magnetic pole orientations relative to the sensor(s), preferably TMR sensors, as well as be located different directions in front of, behind, above, below and on either side of the magnetic sensor(s), preferably TMR sensor(s), during operation of the unit during fishing apparatus operation.

The sensing alarm unit preferably is configured to be releasably clamped to one of a flagpole of an ice fishing tip up, a fishing reel and drive assembly drive shaft of the tip up, and a spindle bar or crossbar of the tip up that fixed to the drive shaft of the tip up. The unit can have one or more of an accelerometer, gyro, tilt sensor, inclination sensor or another type of sensor configured for detecting unit when a tip up flagpole is released by or during a fish strike and/or configured for detecting unit and drive shaft rotation, spindle bar rotation and/or crossbar rotation when releasably mounted to the tip up drive shaft, spindle bar or cross bar of the tip up.

These and other objects, features and advantages of this invention will become apparent from the following detailed description of the invention and accompanying drawings.

### DRAWING DESCRIPTION

One or more preferred exemplary embodiments of the invention are illustrated in the accompanying drawings in which like reference numerals represent like parts throughout and in which:

FIG. 1 is a top front perspective view of an alarm system of the invention that includes a sensor carrying alarm unit releasably clamped to a flagpole of an ice fishing tip up fishing apparatus with the tip up and alarm unit armed with a tip up fish strike indicator flag and alarm unit in a generally horizontal fish strike indicator trigger ready position;

FIG. 2 is a fragmentary rear perspective view of the tip up and sensor carrying sensing alarm unit of FIG. 1 illustrating a removable mount of a mounting arrangement removably attached to one end of a housing of the alarm unit and having a resilient clamp with a pair of jaws clamped around the generally cylindrical or tubular flagpole of the fish strike indicator flag of the tip up;

FIG. 3 is a side elevation view of the tip up and sensing alarm unit shown in FIGS. 1 & 2;

FIG. 4 is an enlarged fragmentary side view of the portion of the tip up and the sensing alarm unit showing a sensing field, which includes an air gap, between a sensor triggering magnet mounted to the base of the tip up and a magnetic sensor onboard the unit that senses a magnetic field, change in magnetic field, magnetic flux and/or change in magnetic flux to detect occurrence of a fish strike during tip up fishing use;

FIG. 5 is an enlarged top front perspective view of part of the tip up showing the construction of the sensing alarm unit, its housing and the clamp of the mount in more detail;

FIG. 6A is a first top rear perspective view of the tip up and the sensing alarm unit fixed by the mount to a ground of the tip up by being fixed to the base of the tip with the unit oriented uprightly relative to the base with its magnetic sensor positioned to detect a magnetic field, magnetic flux and/or changes therein of a first embodiment of a magnetic sensor trigger magnet arrangement composed of pair of spaced apart sensor trigger magnets arranged with their common poles facing or extending radially oppositely outwardly and mounted at opposite ends of a spindle bar or cross bar of the tip up that releasably retains the fish strike indicator flag in the generally horizontal armed position whereby the magnets rotate in unison with the spindle bar or cross bar when a fish strike occurs;

FIG. 6B is a second top rear perspective view of the tip up and the sensing alarm unit of FIG. 6A with a second embodiment of a magnetic sensor trigger magnet arrangement composed of pair of spaced apart sensor trigger magnets arranged with opposite poles facing or extending radially oppositely outwardly and mounted at opposite ends of a spindle bar or cross bar of the tip up;

FIG. 6C is a third top rear perspective view of the tip up and the sensing alarm unit of FIG. 6A with a third embodiment of a magnetic sensor trigger magnet arrangement composed of single sensor trigger magnet arranged axially parallel to and alongside the spindle bar or cross bar;

FIG. 6D is a fourth top rear perspective view of the tip up and the sensing alarm unit of FIG. 6A with a fourth embodiment of a magnetic sensor trigger magnet arrangement that has a housing configured for carrying at least one sensor trigger magnet and for releasable attachment to one of the spindle bar, crossbar and/or tip up rotary fishing reel drive shaft;

FIG. 7 is a fragmentary front elevation view of the sensing alarm unit and part of the tip up with a pair of magnets attached to opposite ends of the spindle bar with the magnetic poles facing or extending transversely relative to the spindle bar and the magnetic sensor onboard the unit;

FIG. 8 is a bottom perspective view of the mount releasably attached to the sensing alarm unit illustrating (a) a circular pedestal or base of the mount having a pair of mounting fastener through holes and a pair of generally half-moon shape through openings on either side of an elongate mounting panel of the pedestal or base, and (b) each one of the resiliently flexible jaws of the tip up flagpole mounting clamp along with an opening extending transversely therethrough for accommodating a clamp jaw tightener or clamp jaw clamping force adjuster;

FIG. 9 is a fragmentary enlarged perspective view depicting (a) the twist lock dovetail joint in more detail and the thumbscrew of the clamp jaw tightener or force adjuster being received in the aligned through bores extending through each clamp jaw; and (b) the substantially symmetrical pair of spaced apart and outwardly flared male dovetail cars that respectively extend outwardly from a bottom or end wall of each one of the boxlike housing panels that form the sensing alarm unit housing;

FIG. 10 is a top perspective view of the body of the mount including the pedestal or base of the mount showing in more detail in elongate generally rectangular dovetail twist lock receiving recess with elongate sidewalls having a generally arcuately outwardly extending section forming an enlarged generally circular dovetail insertion receptacle which receive the cars of the male dovetail of the sensing alarm unit housing before twisting of the unit housing relative to the mount pedestal or base is performed to releasably and substantially immovably lock the mount to the unit housing;

FIG. 11 is a rear perspective view of the body of the mount that shows the twist lock dovetail receiving receptacle formed, preferably integrally formed, more preferably formed by molding into the top surface of the body of the mount;

FIG. 12 is a top plan view of the body of the mount showing in more detail the twist lock dovetail receiving receptacle formed therein

FIG. 13 is a bottom plan view of the body of the mount;

FIG. 14 is a front bottom perspective view of the body of the mount with the clamp jaws facing forwardly showing both clamp jaws of the flagpole clamp in more detail;

FIG. 15 is a front elevation view of the body of the mount;

FIG. 16 is a rear elevation view of the body of the mount;

FIG. 17 is a right side elevation view of the of the body of the mount with the left side elevation view of the body of the mount being substantially identical thereto;

FIG. 18 is a first exploded perspective view of the sensing alarm unit;

FIG. 19 is a second exploded perspective view of the sensing alarm unit;

FIG. 20 is a front left hand side perspective view of another embodiment of the sensing alarm unit mounted by a mounting bracket to a rotary spool that is part of a reel assembly of a fishing apparatus with a magnetic sensor of the unit in sensing proximity to sense at least one of a plurality of magnets onboard the spool;

FIG. 21 is an exploded view of the mounting bracket and spool illustrating a pair of spaced apart halves of the spool each equipped with a corresponding portion of a plurality of magnet-holding pockets which each receive, retain and position a corresponding magnet of the spool therein when the two halves of the spool are assembled together;

FIG. 22 is a perspective view of the assembled spool;

FIG. 23 is a top plan view of a spool half;

FIG. 24 is a bottom plan view of the spool half;

FIG. 25 is a left side elevation view of the spool half with the right side elevation view being a mirror image thereof;

FIG. 26 is a top left perspective plan view of the spool half;

FIG. 27 is a bottom right perspective view of the spool half;

FIG. 28 is a front elevation view of an ice fishing tip and a sensing alarm unit mounted to a rotary drive shaft connected to a fishing-line carrying spool of a reel assembly of the tip up; and

FIG. 29 is an enlarged fragmentary top perspective view of the sensing alarm unit to the rotary drive shaft of the tip up.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

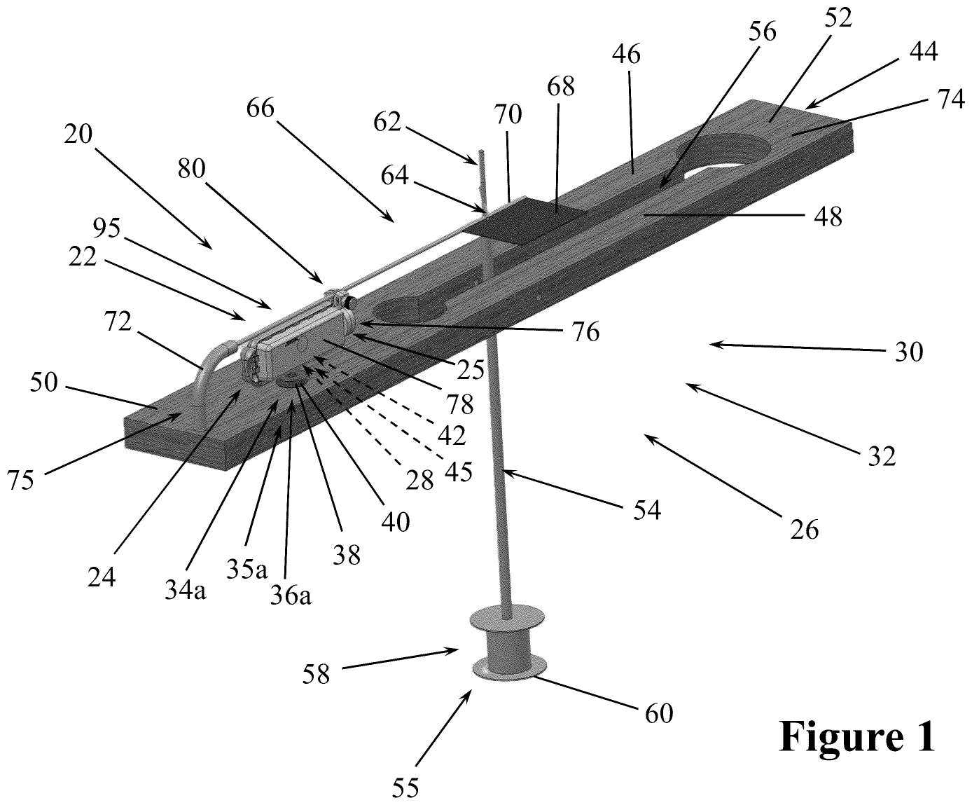

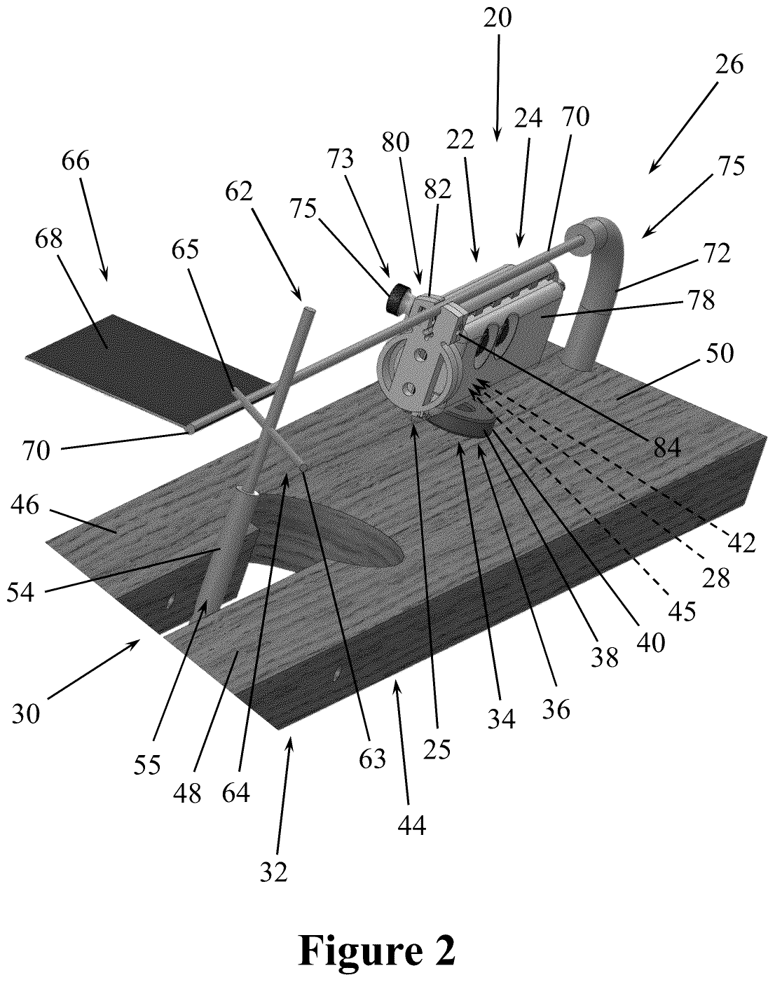

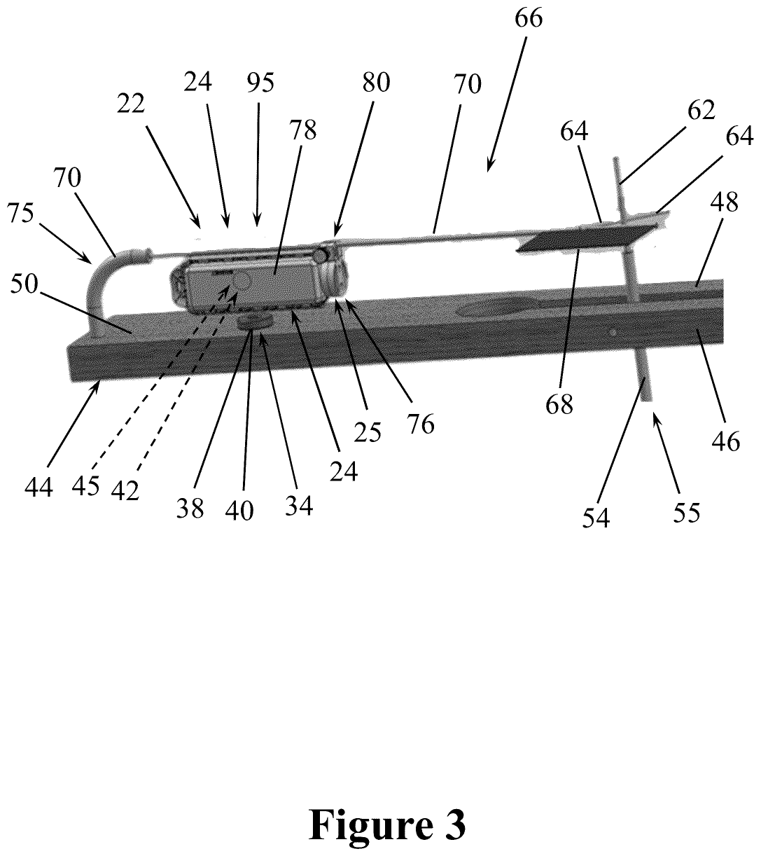

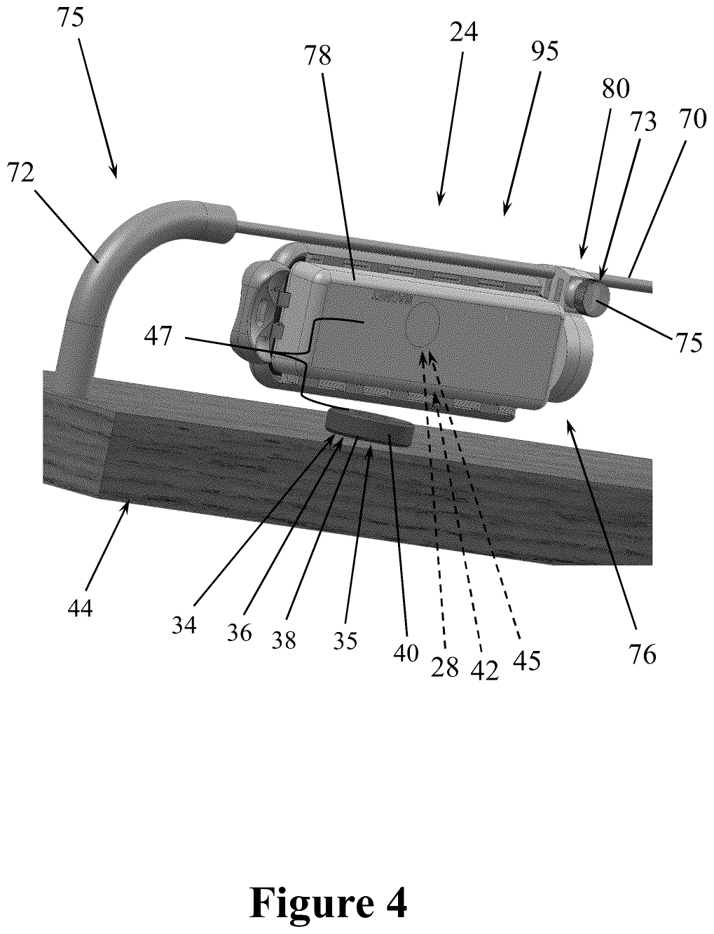

FIGS. 1-5 illustrates an inventive alarm system 20 according to a preferred embodiment of the present invention. The alarm system 20 includes a base unit 22 that is a sensing alarm unit 24 configured to sense operation of an apparatus 26, preferably in the form of a type of outdoor equipment, located in close proximity, carried thereby and/or attached thereto and output an alarm upon the sensing of the occurrence of a predetermined condition, parameter, or event of the apparatus 26 that is related to operation or performance of the apparatus 26. The unit 24 has at least one sensor 28 and/or 28′ onboard the unit 24 used to detect at least one predetermined condition or parameter of the apparatus 26 that is related to apparatus operation and issue an alarm when a sensing alarm event occurs where the sensed predetermined condition or parameter exceeds or falls below a predetermined threshold, e.g., threshold value, falls outside a predetermined threshold range, e.g., falls outside a predetermined minimum value or maximum value, or falls within a predetermined threshold range, e.g., falls within a predetermined minimum value or maximum value. Although the sensor 28 and/or 28′ is not directly shown in FIGS. 1-5, the sensor 28 preferably is mounted to a circuit board 33 enclosed within a housing 78 of the unit 24. The sensor 28 and/or 28′ preferably is positioned in close enough proximity relative to a movable component of the apparatus 26 to sense movement, e.g., displacement, translation, orientation, rotation, angle, rotational angle, change in displacement, change in translation, change in orientation, change in rotation, change in angle, and/or change in rotational angle of the movable component during operation of the apparatus 26. As discussed in more detail below, where unit 24 is equipped with sensor 28, the sensor 28 preferably is a magnet sensor or magnetic sensor 42, and where unit 24 is equipped with sensor 28′, the sensor 28′ preferably is a motion sensor 136. The unit 24 is configured to provide at least one type of human perceptible alarm, e.g., output a visual or audible alarm, and can be configured to sequentially and/or substantially simultaneously output a plurality of types of human perceptible alarms, e.g., output both a visual and audible alarm, visually and/or audibly detectable by a user of the apparatus 26 upon the occurrence of a sensing alarm event.

In a preferred system 20 employing at least one base unit 22 that is a sensing alarm unit 24, the unit 24 is configured to wirelessly communicate a sensing alarm event message to a handheld portable user-transportable alarm unit (not shown), which can be configured as a controller (not shown) of each unit 24 of the system 20, and which is configured to output at least one and preferably at least a plurality of an audible alarm, e.g., audibly detectable alarm, a visual alarm, e.g., a visually detectable alarm, and/or a haptically detectable alarm, e.g., vibratory alarm, upon receiving the wireless sensing alarm event message. Each unit 24 and portable alarm unit and/or controller of such a system 20 have an onboard digital wireless communications system respectively configured to enable wireless digital messages, including sensing alarm event messages, to be transmitted from unit 24 and received by the portable alarm unit and/or controller, which is configured to receive wireless communications from at least a plurality of different units 24 of the system 20. Where the portable alarm unit also is a controller configured to remotely control one or more aspects of sensing alarm unit operation, each unit 24 and portable alarm unit and/or controller of system 20 are configured to wirelessly bidirectionally exchange digital wireless messages, including status messages from each unit 24 to the controller, status request messages from the controller to one or more units 24, sensing event and sensing alarm event messages from each unit 24 to the controller, and control messages from the controller to one or more units 24 enabling control of one more aspects of operation thereof. Such a system 20 is composed of at least one base unit 22 that is a sensing alarm unit 24 and which can include at least one portable alarm unit and/or controller capable of bidirectional digital wireless communication with a plurality of units 24 of system 20 can be constructed and arranged and configured to operate in accordance with the corresponding system, sensing base units, and portable transportable controller disclosed in commonly owned U.S. Pat. No. 10,827,735, the entirety of which is hereby expressly incorporated by reference herein.

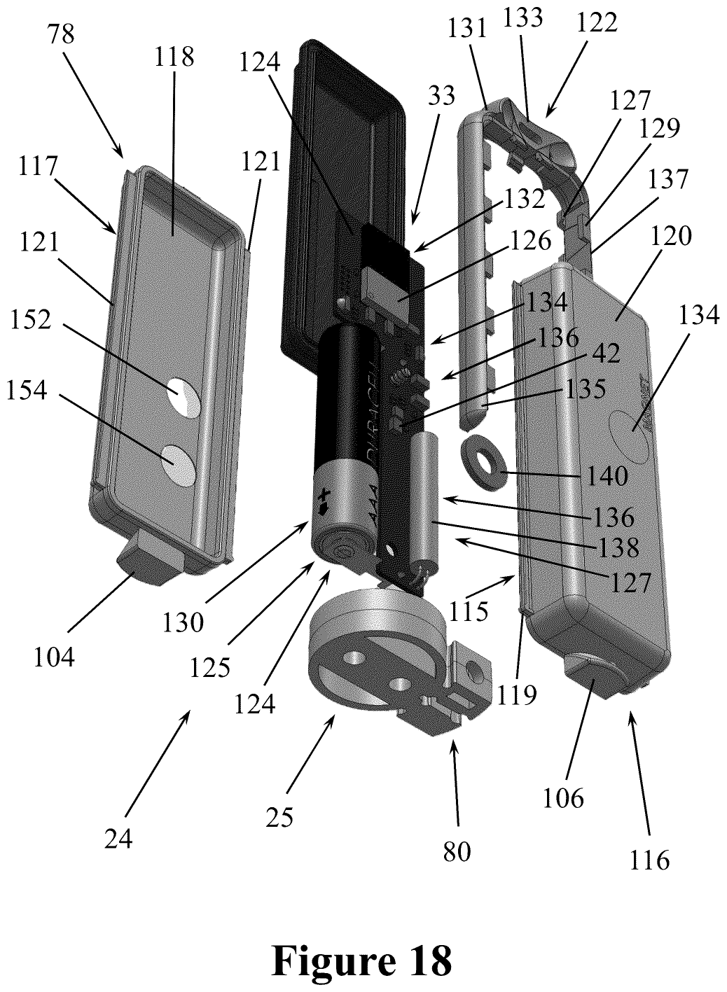

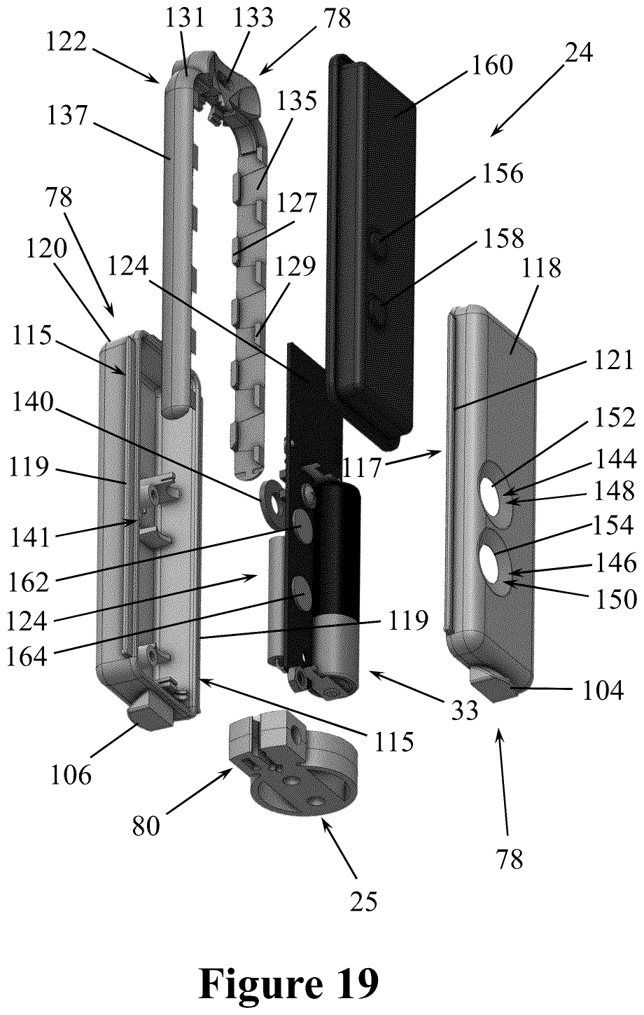

With specific reference to FIGS. 1-3, the unit 24 is releasably mounted by a mounting arrangement 25 to an apparatus 26 that is a fishing apparatus 30, such as preferably an ice fishing tip up 32, and which is disposed with an onboard sensor 28 located in close enough proximity to a component of the apparatus 26, preferably fishing apparatus 30, more preferably tip up 32, preferably a movable component thereof, such that relative movement the component of the apparatus 26 and the sensor 28 and/or unit 24 during operation of the apparatus 26, preferably fishing apparatus 30, more preferably tip up 32, triggers the sensor 28 resulting in issuance of a sensing alarm event signal, e.g., interrupt, therefrom which in turn causes a processor 126 (not shown in FIGS. 1-5) onboard the unit 24 to output an alarm from the unit 24 notifying a user located in the vicinity of the unit 24 of the occurrence of a sensing alarm event, such as an event indicative of a fish strike. With reference to FIGS. 18 and 19, processor 126 preferably is mounted to a circuit board 33 onboard unit 24 that is enclosed within its housing 78. Where the system 20 includes a portable alarm unit and/or controller carried on the person of a user of the system 20 who is remotely located away from the unit 24, a wireless sensing alarm event message is communicated to the portable alarm unit and/or controller causing a processor (not shown) onboard the portable alarm unit and/or controller to also output an alarm notifying the user of the occurrence of the sensing alarm event, e.g., fish strike, at the unit 24. Processor 126 can be a microprocessor, e.g., CPU, a microcontroller, a graphics processing unit, an accelerated processing unit, a field programmable gate array, a digital signal processor, a system on chip processor or another type of processor.

In use and operation, the sensor 28 of the unit 24 is disposed in close proximity relative to a sensor trigger arrangement 34 mounted to or carried by a component, preferably a movable component, of the apparatus 26, preferably fishing apparatus 30, more preferably tip up 32, and which is configured to trigger the sensor 28 upon the occurrence of relative movement therebetween. Upon relative movement therebetween causing either the trigger arrangement 34 to move away from the sensor 28 and unit 24 or the sensor 28 and unit 24 to move away from the arrangement 34 due to movement of the apparatus component during apparatus operation, the sensor 28 outputs an electrical signal, e.g., interrupt, to the onboard processor 126 of the unit 24 thereby causing the alarm to be emitted by the unit 24.

The sensor trigger arrangement 34 includes a sensor trigger 36 configured to operatively couple with the sensor 28 of the unit 24, even when spaced apart a sensor set or sensor trigger distance by a space or gap therebetween, and trigger the sensor 28 upon the occurrence of a change in the distance between the sensor trigger 36 and sensor 28 by the space or gap between them either widening or narrowing compared to the original sensor set or sensor trigger distance as a result of apparatus movement during operation of apparatus 26. In a preferred embodiment and method of operation, the unit 24, including its onboard sensor 28 and/or onboard processor 126, is or are configured, such as and/or including in software and/or firmware, to cause the sensor 28 to trigger thereby causing the unit 24 to alarm upon a sensed change in the distance between the sensor 28 and the sensor trigger 36 from an original preset or predetermined set or trigger distance due to apparatus component movement during operation of apparatus 26. In this manner, a unit 24 of the present invention is configured or can be configured to sense movement of a component of the apparatus 26, preferably relative to the sensor 28 of the unit 24, indicative of the occurrence of an event, condition, phase, orientation, position or the like of the apparatus 26 that can arise or which typically does occur during operation of the apparatus 26 that a user of the apparatus 26 desires to monitor so that an alarm can be provided notifying, including remotely from unit 24, the user of the apparatus 26 of the occurrence of the event, condition, phase, orientation, position, or the like of the apparatus 26.

In at least one embodiment and method of operation, the unit 24, including its onboard sensor 28 and/or processor 126, is or are configured, such as and/or including in software and/or firmware, to enable an initial predetermined or preset distance between the sensor 28 and sensor trigger 36 to be set as a predetermined or preset set or trigger distance with the sensor 28 and/or processor 126 onboard the unit 24 preferably further configured, such as and/or including in software and/or firmware, to sense a change in the distance between the sensor 28 and sensor trigger 36 deviating from the initial set or trigger distance due to the occurrence of relative movement therebetween caused by apparatus operation and trigger the unit 24 to alarm. In a preferred embodiment and method of operation, the unit 24, including its sensor 28 and/or processor 126, is or are configured, such as and/or including in software and/or firmware: (a) to allow a user to selectively record or set an initial predetermined or preset distance between the sensor 28 and sensor trigger 36 as the predetermined or preset sensor set or trigger distance, (b) to sense or detect movement of a component, preferably a movable component, of the apparatus 26 caused during operation of the apparatus 26 by sensing or detecting a change, preferably an increase, in the distance between the sensor 28 and sensor trigger 36, and (c) trigger the unit 24 into outputting an alarm to the user of the occurrence of movement of the component of the apparatus 26. As such, a unit 24 of the invention also can be configured or is configured to sense movement of at least one part or component of the apparatus 26, preferably relative to the sensor 28 and unit 24, indicative of the occurrence of an event, condition, phase, orientation, position or the like of the apparatus 26 that can arise during operation of the apparatus 26 that a user of the apparatus 26 desires to monitor and provide an alarm notifying the user that the event, condition, phase, orientation, position, or the like of the apparatus 26 being monitored by the unit 24 has occurred.

In the preferred embodiment depicted in FIGS. 1-5, the sensor trigger 36 of the sensor trigger arrangement 34 preferably is or includes at least one trigger magnet 38, each of which is a source of a magnetic field, flux and/or flux density emitted therefrom, each of which can be a steady-state magnetic field, flux and/or flux density source, and each of which preferably is a permanent magnet 40, such as a rare earth magnet. Such a trigger arrangement 34 is a magnetic sensor trigger arrangement 35 that includes or consists of a magnetic sensor trigger 36 that is or consists of at least one trigger magnet 38. As previously noted, sensor 28 is a magnetic sensor 42, which is carried by unit 24 and which is preferably disposed onboard unit 24.

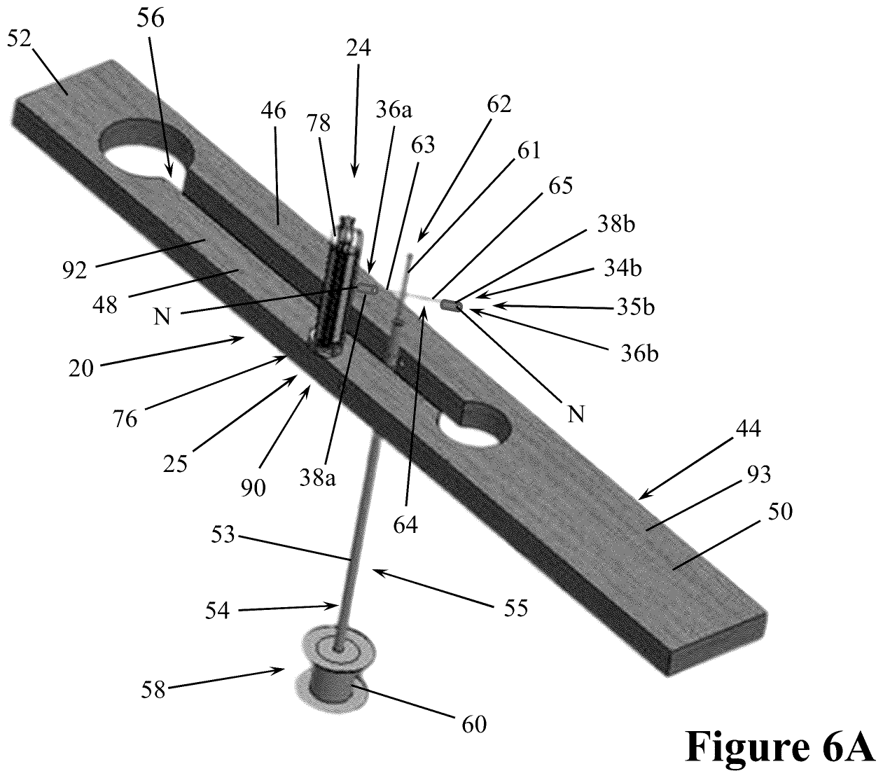

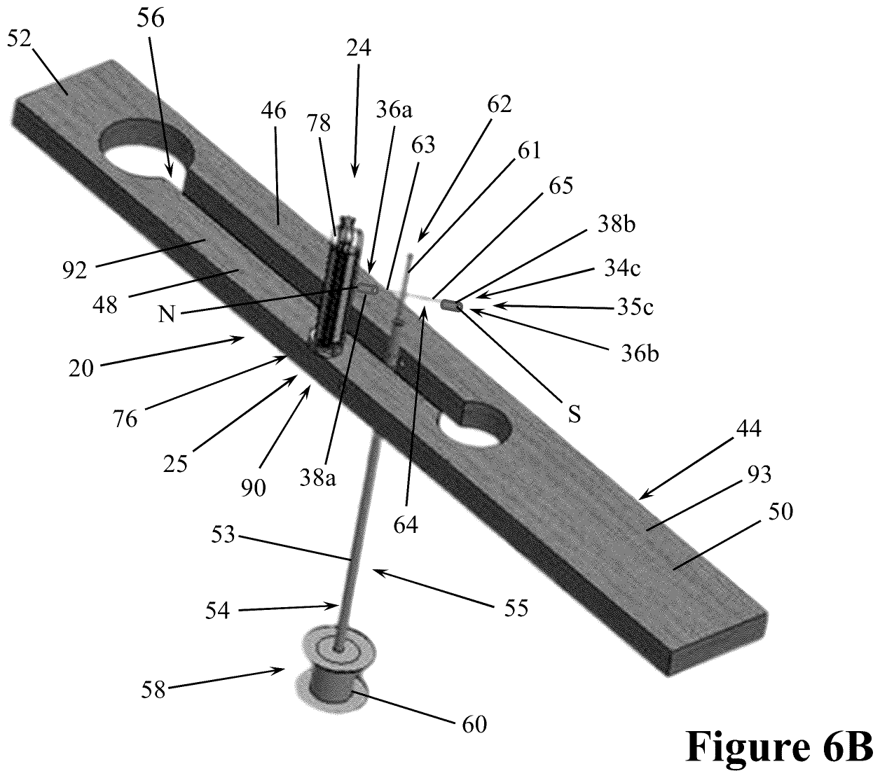

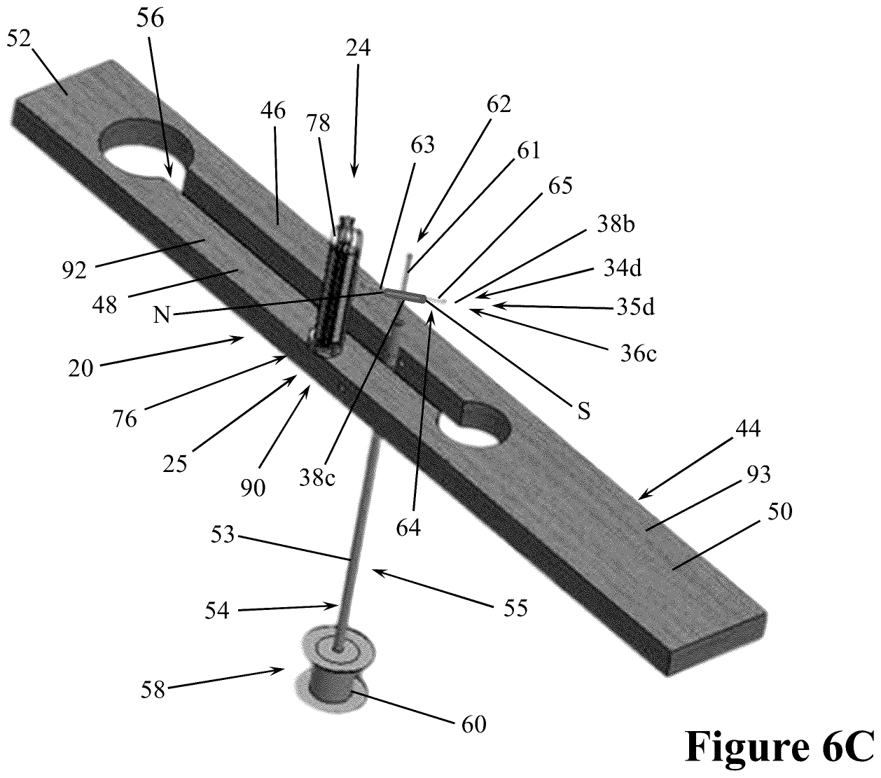

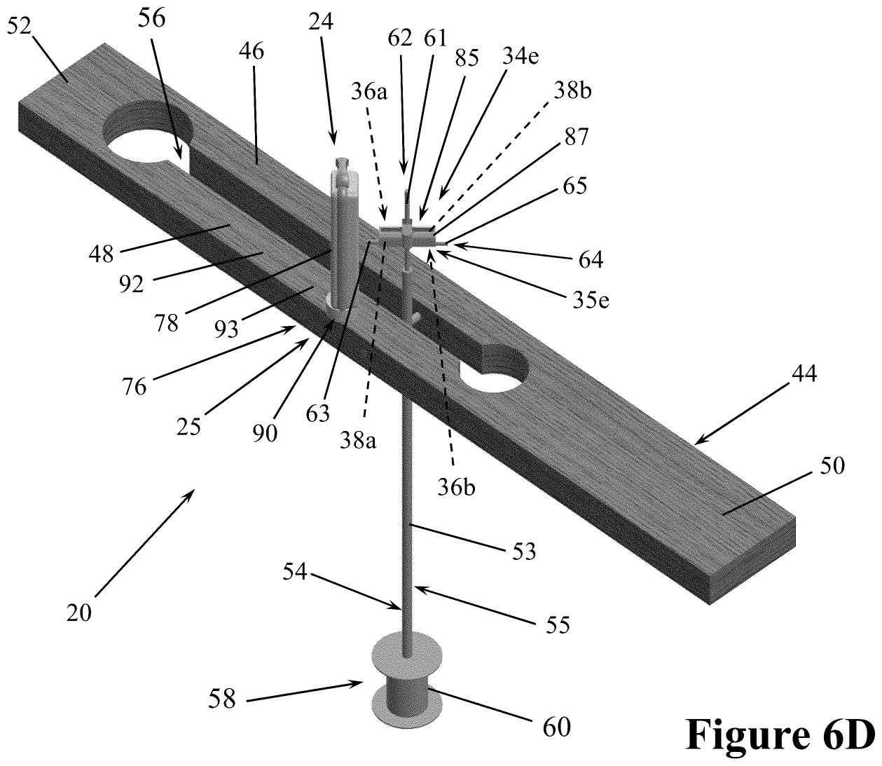

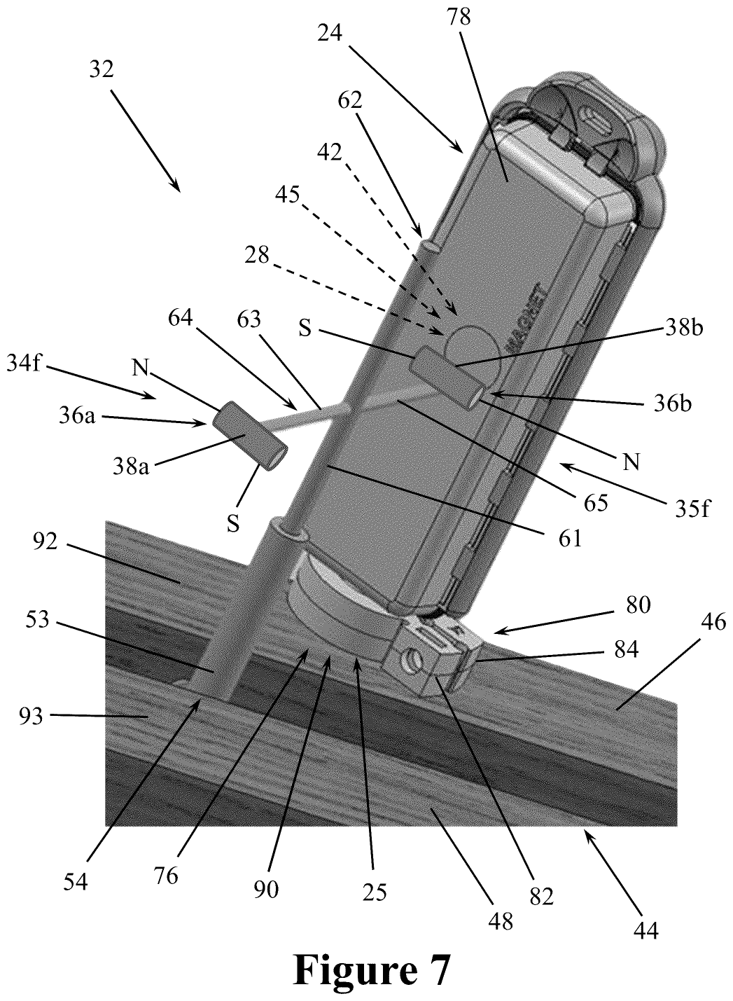

While the sensor trigger arrangement 34a shown in FIGS. 1-5 is a magnetic sensor trigger arrangement 35a that consists only of a single trigger magnet 38 in the form of a single annular, round, circular, or disc-shaped permanent magnet 40 immovably fixed to part of the apparatus 26, a sensor trigger arrangement 34b, 34c, 34d, 34c, preferably a magnetic sensor trigger arrangement 35b, 35c, 35d, 35e, as depicted in FIGS. 6A-6D, and/or a sensor trigger arrangement 34f, preferably magnetic sensor trigger arrangement 35f of FIG. 7 can be used that are respectively carried by or mounted to a spindle bar 64 or crossbar 64 fixed to an elongate shaft or rod 61 of a rotary drive shaft 62 of a rotary reel and drive assembly 55 of the tip up 32 where the shaft or rod 61 is coaxially telescopically received in an elongate cylindrical tube 54, that preferably is a driveshaft rotation guide or bearing sleeve 53. The shaft or rod 61 of the drive shaft 62 has one end operatively connected, such as by being fixed, to a rotary reel 58 and configured to rotate in unison with the reel 58 when a fish takes bait attached to fishing line extending from a spool 60 of the reel 58. The spool 60 can be an integral part of the reel 58 or a removable component carried by the reel 58 and which rotates the reel 58 in unison therewith when a fish strikes bait attached to fishing line extending from and wrapped around the spool 60. A crossbar 64 is oriented perpendicularly relative to the drive shaft 62 and fixed to the shaft or rod 61 of the drive shaft 62 such that the crossbar 64 rotates in unison therewith when a fish strikes bait and unspools line from the spool rotating the spool 60 thereby rotating the reel 58 in turn causing the drive shaft 64 to rotate. The crossbar 64 has a pair of oppositely extending crossbar bar segments 63, 65 that extend generally perpendicularly outwardly from the shaft or rod 61 of the drive shaft 62 in opposite directions. As depicted in the drawing figures showing a tip up 32, one of the bar segments 63 or 65 of the crossbar 64 operatively engages with a flagpole 70 of the tip up 32 to retain the flagpole 70 in a set position and disengages from the flagpole 70 when a fish strike causes the reel 58 to rotate the driveshaft 62 which in turn causes the crossbar 64 to rotate.

In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly.

Each one of the magnets 38a, 38b has a north (N) pole and a south(S) pole and configured so a respective one of the magnets 38a, 38b is oriented on or relative to the corresponding crossbar segment 63, 65 carrying the magnet so that one of the north and south poles of each magnet 38a, 38b faces outwardly away from the shaft or rod 61 of the drive shaft 62 of the tip up 32 so as to be detectable by a sensor 28 that is a magnetic sensor 42, preferably TMR sensor 45, during rotation of the crossbar 64 during a fish strike. In a preferred embodiment, each one of the magnets 38a, 38b is oriented with the same magnetic pole facing outwardly such that each one of the magnets 38a, 38b is oriented either with its north pole facing outwardly or its south pole facing outwardly. In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly.

Preferred embodiments of a magnetic sensor trigger arrangement 35b, 35c, and/or 35c depicted in FIGS. 6A, 6B and 6D, discussed in more detail below, include at least a plurality of the trigger magnets 38a and 38b, with (a) one of the magnets 38a carried by one bar segment 63 of the crossbar 64 and configured for movement, preferably rotation, in unison with the bar segment 63 during a fish strike, and (b) another one of the magnets 38b carried by the other bar segment 65 of the crossbar 64 and configured for movement, preferably rotation, in unison with the bar segment 65 during a fish strike. In a preferred embodiment, each one of the trigger magnets 38a are fixed to a corresponding one of the bar segments 63, 65 for rotation in unison with the bar segments 63, 65 during rotation of the crossbar 64 by the shaft or rod 61 of the driveshaft 62 when a fish strikes bait and unspools line from the spool 60 rotating the reel 58. In the additional embodiment of a magnetic sensor trigger arrangement 35d shown in FIG. 6C and also discussed in more detail below, there is a single sensor trigger that preferably is a single sensor trigger magnet 38c mounted to the spindle bar or crossbar 64 of the tip up 32 for rotation in unison with the crossbar during a fish strike.

As is shown in FIGS. 6A-6D & 7, the crossbar 64 is elongate and generally straight with the one crossbar segment 63 thereof generally coaxial and axially inline with the other crossbar segment 65. As is also shown in FIGS. 6A-6D & 7, the one magnet 38a is a generally cylindrical magnet 38a that is fixed to or caps the free end of the one bar segment 63 of the spindle bar 64 and the other magnet 38b also is a generally cylindrical magnet 38b that is fixed to or caps the free end of the other bar segment 65 of the spindle bar 64. As is shown in FIG. 7, each one of the trigger magnets 38a, 38b is oriented generally transversely, e.g., tangential, to the corresponding bar or segment 63, 65 of the spindle bar 64 to which the respective magnet 38a, 38b is attached orienting the magnetic poles of each magnet such that magnetic field or magnetic flux extends generally transversely relative to the magnetic sensor 42, preferably TMR sensor 45, when each magnet 38a, 38b passes by the sensor 42 during rotation of the spool 60, drive shaft 62 and spindle bar 64 during tip up fishing apparatus operation. If desired, each one of the magnets 38a, 38b can be mounted to the respective bar or segment 63, 65 of the spindle bar 64 with the poles of each magnet 38a, 38b facing parallel to the bars or segments 63, 65 of the spindle bar 64 as depicted in FIG. 6A.

In a preferred embodiment, the unit 24 has at least a pair of the TMR sensors 45 arranged on oppositely facing sensing directions with one of the TMR sensors 45 facing in one direction and the other one of the TMR sensors 45 facing in the other direction (oppositely facing oppositely sensing pair of TMR sensors). In another preferred embodiment, the unit 24 has four onboard TMR sensors 45 arranged in a magnetic sensor array with a first pair of oppositely facing oppositely facing TMR sensors 45 and a second pair of oppositely facing oppositely facing TMR sensors 45 orthogonally oriented relative to the first pair of oppositely facing oppositely facing TMR sensors 45. Such a unit 24 with at least one pair of oppositely facing oppositely facing TMR sensors 45 and preferably an array of the two pairs of oppositely facing oppositely facing TMR sensors 45 enables the unit 24 to sense trigger magnets 38a, 38b located above, below, in front of, behind, to the right side of, or to the left side of the unit 24 preferably substantially simultaneously. In addition, such a unit 24 with at least one pair of oppositely facing oppositely facing TMR sensors 45 and preferably an array of the two pairs of oppositely facing oppositely facing TMR sensors 45 enables the unit 24 to sense trigger magnets 38a, 38b arranged at all different angles, including diagonally, above, below, in front of, behind, to the right side of, or to the left side of the unit 24 including offset to one side or the other side of the TMR sensors 45 and even offset a distance to one side or the other side of the sensing alarm unit housing 78 such that is an air gap of at least one inch and preferably as much as two inches, i.e., sensing range of between 1-2 inches, and being able to be sensed by one or more of the TMR sensors 45.

With reference to FIGS. 6A-6D, there is at least one sensor trigger 36a, 36b, and/or 36c, each of which preferably is a sensor trigger magnetic source, such as a steady state source of a magnetic field or flux, which more preferably is a permanent magnet sensor trigger magnet, such as one or more of the pair of sensor trigger magnets 38a, 38b depicted in FIGS. 6A-6B and 7, the single sensor trigger magnet 38c depicted in FIG. 6C, and/or the sensor trigger magnet(s) 38a, 38b of the sensor trigger magnet arrangement 85 of FIG. 6D. It should also be noted that the sensor trigger magnet arrangement 85 of FIG. 6D can contain a pair of sensor trigger magnets 38a, 38b, such as depicted in FIG. 6D, a single sensor trigger magnet 38c, like the single magnet 38c depicted in the trigger magnet arrangement 35c of FIG. 6C, or even a plurality of pairs of, i.e., at least three, of the sensor trigger magnets, such as both the magnets 38a, 38b of FIGS. 6A, 6B & 6D and also one or more additional spaced apart magnets like magnets 38a, 38b &/or 38c. Each one of the magnets 38a, 38b, 38c has a north (N) pole and a south(S) pole and configured so at least a respective one of the magnets 38a, 38b and/or 38c is oriented on or relative to the corresponding crossbar segment 63, 65 carrying the magnet so that one of the north and south poles of each magnet 38a, 38b or 38c faces outwardly away from the shaft or rod 61 of the drive shaft 62 of the tip up 32 so as to be detectable by a magnet sensor 42, preferably TMR sensor 45, during rotation of the crossbar 64 during a fish strike. Where the unit 24 has a plurality of spaced apart magnet sensors 42, preferably at least a pair of TMR sensors 45, each one of the magnets 38a, 38b or 38c is sequentially detectable and preferably sequentially detected by at least a plurality of the magnet sensors 42, preferably TMR sensors 45, during a partial rotation, i.e., less than 360 degrees, of the crossbar 64 that occurs during a fish strike and also during each complete 360 degree rotation of the crossbar 360 that occurs during a fish strike. In a preferred embodiment where at least a plurality of spaced apart TMR sensors 45 is used, the resultant sensing arrangement is configured to be able to sense in quarter turn or 90 degree increments of rotation of the crossbar 64 during fish strike operation up to one complete rotation of the crossbar 64 as well as able to sense at least a plurality of rotations of the crossbar 64 during a fish strike.

With specific reference to FIG. 6A, in a first preferred embodiment of a sensor trigger arrangement 34b that preferably is a sensor trigger magnet arrangement 35b constructed and arranged in accordance with the present invention, each one of the magnets 38a, 38b is oriented with the same magnetic pole facing outwardly such that each one of the magnets 38a, 38b is oriented either with its north pole facing outwardly or its south pole facing outwardly. In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly. With continued reference to FIG. 6A, the present invention also contemplates a trigger magnet arrangement configured in accordance with that discussed above in this paragraph where the crossbar 64, and/or each one of its bar segments 63, 65, are the sensor trigger magnets and are magnetic or even magnetized so that one of the magnets 38a is formed of or integral with one of the bar segments 63 and the other one of the magnets 38b is formed of or integral with one of the bar segments 65.

With specific reference to FIG. 6B, in a second preferred embodiment of a sensor trigger arrangement 34c that preferably is a sensor trigger magnet arrangement 35c constructed and arranged in accordance with the present invention, the magnets 38a, 38b are oriented with opposite magnetic poles facing outwardly such that one of the magnets 38a, 38b is oriented with its north pole facing outwardly pole facing outwardly and the other one of the magnets 38a, 38b is oriented with its south pole facing outwardly. With continued reference to FIG. 6B, the present invention further contemplates a trigger magnet arrangement configured in accordance with that discussed in this paragraph where the crossbar 64, and/or each one of its bar segments 63, 65, are the sensor trigger magnets and are magnetic or even magnetized so that one of the magnets 38a is formed of or integral with one of the bar segments 63 and the other one of the magnets 38b is formed of or integral with one of the bar segments 65.

With specific reference to FIG. 6C, in yet a third preferred embodiment of a trigger magnet arrangement 35d, the pair of magnets 38a, 38b of the trigger magnet arrangements of FIGS. 6A & 6B are replaced with a single sensor trigger 36c that is a single elongate trigger magnet 38c that has one pole, e.g., its north (N) pole, carried by and/or disposed alongside one bar segment 63 of the crossbar 64 and its other pole, e.g., its south(S) pole, carried by and/or disposed alongside the other bar segment 65 of the crossbar 64. If desired, the length of such a single magnet 38c trigger magnet arrangement can be configured so that one end of the magnet 38c and its corresponding magnetic pole, e.g., north pole, extends outwardly beyond the free end of one of the bar segments 63 of the crossbar 64 and the opposite end of the magnet 38c and its corresponding opposite magnetic pole, e.g., south pole, extends outwardly beyond the free end of the other one of the bar segments 65 of the crossbar 64. With continued reference to FIG. 6C, the present invention further contemplates a trigger magnet arrangement configured in accordance with that discussed in this paragraph where at least one of the crossbar bar segments 63 and/or 65 and preferably the entire crossbar 64 is a single trigger magnet and is magnetic or magnetized so that it has a single north pole and a single south pole. In such a preferred crossbar trigger magnet arrangement embodiment, the entire crossbar 64 is a trigger magnet and is magnetic or magnetized with the north pole being formed of or in one of the bar segments 63 or 65 of the crossbar 64 and the south pole being formed of or in the other one of the bar segments 65 or 63 of the crossbar 64.

With specific reference to FIG. 6D, FIG. 6D illustrates a fifth preferred embodiment of a sensor trigger arrangement 34e that preferably is a fifth preferred embodiment of a sensor magnet trigger arrangement 35e that more preferably is a releasable sensor trigger magnet arrangement 85 configured for releasable engagement with at least part of the crossbar 64 of a tip up 32 whose construction, configuration, use, and operation are discussed in more detail below. The releasable sensor trigger magnet arrangement 85 includes a housing 87, such as made, e.g., molded, of plastic which contains at least one sensor trigger 36a, preferably a plurality of sensor triggers 36a, 36b axially spaced apart along the crossbar 64, more preferably at least one sensor trigger magnet 38a (or 38c), and even more preferably at least a plurality of sensor trigger magnets 38a, 38b axially spaced apart along the axial extent and/or length of the crossbar 64. As is shown in phantom in FIG. 6D, the releasable sensor trigger magnet arrangement 85 has a pair of spaced apart sensor trigger magnets 38a, 38b with one of the magnets 38a disposed at one end of the housing 87 on, along or adjacent one of the bar segments 63 of the crossbar 64 and the other one of the magnets 38b disposed at the other end of the housing 87 on, along or adjacent the other one of the bar segments 65 of the crossbar 64. If desired, the sensor trigger magnets 38a, 38b can be oriented with the same magnetic pole facing oppositely outwardly like the magnets 38a, 38b of the sensor magnet trigger arrangement 35b shown in FIG. 6A, with opposite poles of the magnets 38a, 38b facing oppositely outwardly like the magnets 38a, 38b of the sensor magnet trigger arrangement 35c shown in FIG. 6B, or a single elongate magnet like the single sensor trigger magnet 38c of the sensor magnet trigger arrangement 35d shown in FIG. 6C.

Each magnet 38, 38a, 38b, and/or 38c preferably has a magnetic flux density of at least 10 gauss and preferably at least 30 gauss. Magnet sensor 42, preferably is an MR sensor that is at least a 9 gauss MR sensor and which preferably is at least a 30 gauss MR sensor. The sensor 42 more preferably is a TMR sensor 45, which is at least a 9 gauss TMR sensor 45 and which preferably is at least a 30 gauss TMR sensor 45.

The releasable sensor trigger magnet arrangement 85 is configured for releasable mounting to at least part of the crossbar 64, such as by preferably being releasably mounted or releasably mountable to at least one of the bar segments 63 or 65 of the crossbar 64 and preferably to both of the bar segments 63 and 65 of the crossbar 64. In a preferred embodiment, the housing 87 of the releasable sensor trigger magnet arrangement 85 is configured for snap-fit engagement with part of the crossbar 64 with the housing 87 of such a preferred releasable sensor trigger magnet arrangement 85 configured for releasable snap-fit engagement with at least one and preferably both bar segments 63, 65 of the crossmember 64 such that the releasable sensor trigger magnet arrangement 85 rotates substantially in unison with the crossmember 64 during a fish strike. The housing 87 preferably is configured, e.g., molded, with at least one first channel configured with a snap fit into which at least part of the crossbar 64, such as one or both bar segments 63, 65 are received and releasably frictionally and/or snap-fittingly retained via a snap-fit or snap-fit construction. Where the housing 87 also engages part of the rod or shaft 61 of the drive shaft 62, the housing 87 is configured, e.g., molded, with at least an additional channel, preferably a second channel, configured with a snap fit into which at least part of the shaft or rod 61 of the drive shaft 62 is received and releasably frictionally and/or snap-fittingly retained via a snap-fit or snap-fit construction. In at least one preferred embodiment, the housing 87 of the releasable sensor trigger magnet arrangement 85 is configured not only to engage, preferably snap-fittingly engage, with one or both bar segments 63, 65 of the crossbar 64, but also is configured to engage with at least part of the shaft or rod 61 of the drive shaft 62 to further more securely yet releasably mount the releasable sensor trigger magnet arrangement 85 to the crossmember 64 and/or drive shaft 62 for rotation in unison therewith during a fish strike.

FIG. 7 illustrates a multi-sensor trigger arrangement 34f that preferably is a multi-magnet magnetic sensor trigger arrangement 35f employing a pair of spaced apart trigger magnets 38a, 38b arranged with their north and south magnetic poles and magnetic flux emanating therefrom and therebetween in a direction tangential to the respective bar segments 63, 65 carrying the corresponding magnets 38a, 38b. In other words, each magnet 38a, 38b mounted with its north and south poles facing tangent or orthogonal to the respective crossbar bar segment 63, 65 to which the magnet 38a, 38b is mounted. While only a pair of tangentially mounted or tangentially oriented magnets 38a, 38b are used in the embodiment of FIG. 7, such a tangentially oriented multi-magnet sensor trigger arrangement 35f can be composed of or consist of at least a plurality of pairs of, at least three, the trigger magnets with a first one of the trigger magnets 38a fixed or capping the end of a first bar or segment 63 of the spindle bar 64 extending outwardly from the drive shaft 62 in a first direction, a second one of the trigger magnets 38b fixed or capping the end of a second bar or segment 65 of the spindle bar 64 extending outwardly from the drive shaft 62 in a second direction that is opposite the direction of the first bar or segment 63, a third one of the trigger magnets (not shown) fixed or capping one end of a third bar or segment (not shown) of the spindle bar 64 extending outwardly from the drive shaft 62 in a third direction generally transverse to the first and second directions, and a fourth one of the trigger magnets (not shown) fixed or capping one end of a fourth bar or segment (not shown) of the spindle bar 64 extending outwardly from the drive shaft 62 in a fourth direction generally transverse to the first and second directions and in a direction opposite to that of the third bar or segment of the spindle bar 64.

As also discussed in more detail below, the sensor 28 onboard the unit 24 preferably is a magnet sensor 42 constructed and arranged to detect at least one of (i) a magnetic field, flux, or flux density, (ii) a magnitude or strength of the magnetic field, flux or flux density, (iii) a change in magnetic field, flux, or flux density, and/or (iv) a change in the magnitude or strength of the magnetic field, flux, or flux density of a sensor trigger magnet 38 in magnetic communication therewith by being within sensing proximity thereof. Movement of a component of the apparatus 26 carrying one of a trigger magnet 38 and the unit 24 and its magnet sensor 42 causes movement relative to the other one of the trigger magnet 38 and the unit 24 and its magnet sensor 42 which in turn causes a change in one or more of (i), (ii), (iii) and/or (iv) sensed by the magnet sensor 42 causing a user-perceptible audible and/or visual alarm to be outputted from the unit 24. Such a change that can be sensed by the sensor 42 is when one or more of (i), (ii), (iii) and/or (iv) falls below a predetermined threshold or threshold value, rises above a predetermined threshold or threshold value, falls outside a predetermined threshold range and/or outside of predetermined maximum and minimum threshold range values, or falls within a predetermined threshold range and/or in between predetermined maximum or minimum threshold range values indicating the occurrence of relative movement between the sensor 42 and trigger magnet 38 being sensed by the sensor 42 sufficient for the sensor 42 to signal the onboard processor 126 occurrence of a sensing alarm event. Of course, where the unit 24 is wirelessly paired with a handheld portable transportable remote alarm unit (not shown), such relative movement that triggers the sensor 42 to signal the sensing alarm unit processor 126 of occurrence of a sensing alarm event also causes a wireless sensing alarm event message to be sent to the remotely-located portable alarm unit (not shown) causing one or more of a user-perceptible audible, visual, and/or haptic, e.g., vibratory, alarm to be generated.

As discussed in more detail below, where the apparatus 26 is a fishing apparatus 30, preferably ice fishing tip up 32, the sensor 28 of the unit 24 is disposed in close proximity relative to the sensor trigger arrangement 34 mounted to or carried by a component of the apparatus 30, preferably tip up 32, and which is configured to trigger the sensor 28 upon occurrence of relative movement therebetween. With reference once again to FIGS. 1-5, the fishing apparatus 30 is an ice fishing tip up 32 of a classic or standard rail design having a generally planar or flat wooden or plastic base 44 composed of a pair of spaced apart elongate and parallel frame rails 46, 48 adjoined at opposite ends by a crossmember 50, 52 and having an elongate cylindrical tube 54, preferably drive shaft guide sleeve 53, of an elongate tip up rotary reel and drive assembly 55 pivotally attached to both rails 46, 48 enabling pivoting of the tube 54 and assembly 55 between (a) a storage position where the tip up reel and drive assembly 55 is folded until it is received in an elongate longitudinally extending reel and cylinder storage channel 56 disposed between the rails 46, 48, and (b) a T-shaped fishing operating position like that depicted in FIG. 1 where a rotary reel 58 at the end of the rod and reel assembly 55 extends downwardly through a hole in the ice of a lake or pond into the water during ice fishing operation. As is shown in FIG. 1, the storage channel 56 formed between the frame rails 46, 48 of the tip base 44 is three-dimensionally contoured to accept not only the elongate cylindrical tube 54 and drive shaft 62 but has enlarged portions disposed at opposite ends of the channel 56 to respectively accommodate the reel 58 and spindle bar 64. The reel 58 has a rotary spool 60 carrying fishing line disposed at one end of the tube 54 that is rotatively coupled by a drive shaft 62 coaxially cylindrically housed within the tube 54 to a portion of the shaft 62 extending outwardly from the tube 54 to which an elongate generally transversely extending notched spindle bar 64 is fixed for rotation in unison with the spool 60 during ice fishing tip up operation.

The tip up 32 has a fish strike indicator flag 66 that includes a flag panel or banner 68 attached to an elongate flagpole 70 anchored to the base 44 by a coil spring 72 that is a biasing element 75 that biases the flag 66 toward a generally upright fish strike indicating position but allows the flagpole 70 to be bent about the spring 70 toward a generally horizontal fish strike trigger ready position. The flag 70 is shown in FIG. 1 disposed in a generally horizontal trigger ready position by part of the flagpole 70 being releasably retained in the generally horizontal trigger ready position by the notched spindle bar 64 by being disposed underneath the bar 64 and retained in a notch in the bar 64. When a fish strikes bait attached to fishing line and runs with the bait, it unspools fishing line from the spool 60 rotating the drive shaft 62 which turns the spindle bar 64 until the bar 64 disengages from the flagpole 70 thereby releasing the flagpole 70. Once the flagpole 70 is released, the flagpole biasing spring 72 quickly urges the flagpole 70 uprightly rotating the flagpole 70 upwardly about the tip up base 44 from the generally horizontal trigger ready position shown in FIGS. 1-4 (where the flagpole 70 is generally parallel to the tip up base 44) to a fish strike indicator position where the flagpole 70 is generally vertical (where the flagpole 70 is generally perpendicular or orthogonal to the tip up base 44). When disposed in the generally upright fish strike indicator position, the banner 68 of the flag 66 is readily visible for a user of the tip up 32, i.e., fisherman, to see signaling the fisherman to come check the tip up 32 and reel in the fish that has taken the bait.

A first sensing alarm unit embodiment is shown in FIGS. 1-4 where the unit 24 is adapted for use with an ice fishing tip up 32, the unit 24 is configured for releasable but secure mounting to the flagpole 70 adjacent the flagpole anchor spring 72 and the sensor trigger arrangement 34 that is a single permanent magnet 40 immovably fixed to an upper or outer surface 74 of the tip up base 44 adjacent the spring 72. The unit 24 preferably is removably attached to the flagpole 70 by a mount 76, which is removably attached to one end of the housing 78 of the unit 24 with a clamp 80 composed of a pair of clamp jaws 82, 84 that releasably clamps around the flagpole 70 enabling the unit 24 to be slidably selectively positioned anywhere along the flagpole 70. A fastener 73, preferably a thumbscrew 75, is disposed in operable cooperation with the jaws 82, 84 of the clamp 80 of the mount 76 and configured for manual rotation of the fastener 73, preferably thumbscrew 75, (a) in one direction, e.g., clockwise, to decrease the space between the jaws 82, 84, clamp the jaws 82, 84 together around the flagpole 70, and/or increase the clamping force exerted by the jaws 82, 84 against the flagpole 70 to releasably mount the alarm unit 24 to the flagpole 70, and (b) in an opposite direction, e.g., counterclockwise, to decrease the clamping force exerted by the jaws 82, 84 against the flagpole 70, increase the space between the jaws 82, 84, and/or move one or both jaws 82, 84 away from the flagpole 70, disengage, release and/or unclamp the jaws 82, 84 from the flagpole 70 thereby unclamping the clamp 80 from the flagpole 70 enabling the alarm unit 24 to be detached from the flagpole 70 and removed from the tip-up 32.

The unit 24 preferably is equipped with at least one sensor 28′ that is a motion sensor 136, and which can be equipped with a plurality of sensors 28′, each of which is a motion sensor 136 in communication with processor 126 configured, such as and/or including in software and/or firmware, to detect motion of the unit 24 relative to fishing apparatus 30, preferably tip up 32, such as preferably to detect movement, including linear motion, angular motion and/or rotation, acceleration and/or jerk of the unit 24 relative to the fishing apparatus 30, preferably tip up 32, such as preferably during movement of the tip up flagpole 70 from its generally horizontal armed position to the generally vertical fish strike indicating position that occurs during a fish strike during tip up fishing operation. In a preferred embodiment, whether unit 24 is equipped with a single motion sensor 126 or a plurality of motion sensors 126, suitable motion sensors include an accelerometer, preferably at least a 3-axis accelerometer, a gyro, preferably at least at a 3-axis gyro, an angular rate sensor, magnetometer, preferably a 3-axis magnetometer, an Inertial Measurement Unit (IMU) sensor, a Heading Reference Unit (HRU) sensor, a tilt sensor, an inclinometer, and/or a combination of two or more of these sensors disposed in communication with processor 126 and configured, such as and/or including in software and/or firmware, to detect motion of the unit 24 relative to fishing apparatus 30, preferably tip up 32, such as preferably to detect movement, including linear, angular motion and/or rotation, acceleration and/or jerk of the unit 24 relative to the fishing apparatus 30, preferably tip up 32, such as preferably during movement of the tip up flagpole 70 from its generally horizontal armed position to the generally vertical fish strike indicating position that occurs during a fish strike during tip up fishing operation.

The unit 24 is removably mounted by the mount 76 to a portion of the flagpole 70 adjacent the spring 72 with the magnet sensor 42 of the alarm unit 24 positioned in relatively close proximity to the magnet 40, preferably generally overlying the magnet 40, when the flagpole 70 is disposed in the generally horizontal fish strike trigger ready position with the flagpole 70 releasably engaged with the spindle bar 64. When the alarm unit 24 is releasably mounted to the flagpole 70 the mount 76, including its clamp 80, is disposed at an end of the alarm unit 24 and housing 78 that is positioned distal to the tip up flagpole spring 72 as depicted in FIGS. 1-4. The unit 24 is releasably mounted to the flagpole 70 above and adjacent to the spring 72 to minimize angular acceleration imparted to the unit 24 when the generally horizontally oriented flagpole 70 disengages from the spindle bar 64 and whips vertically upon occurrence of a fish strike.

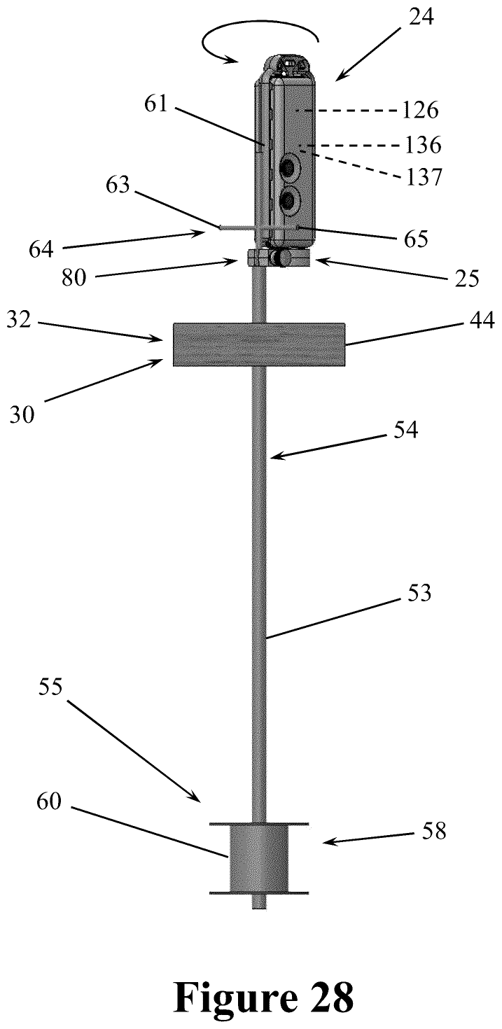

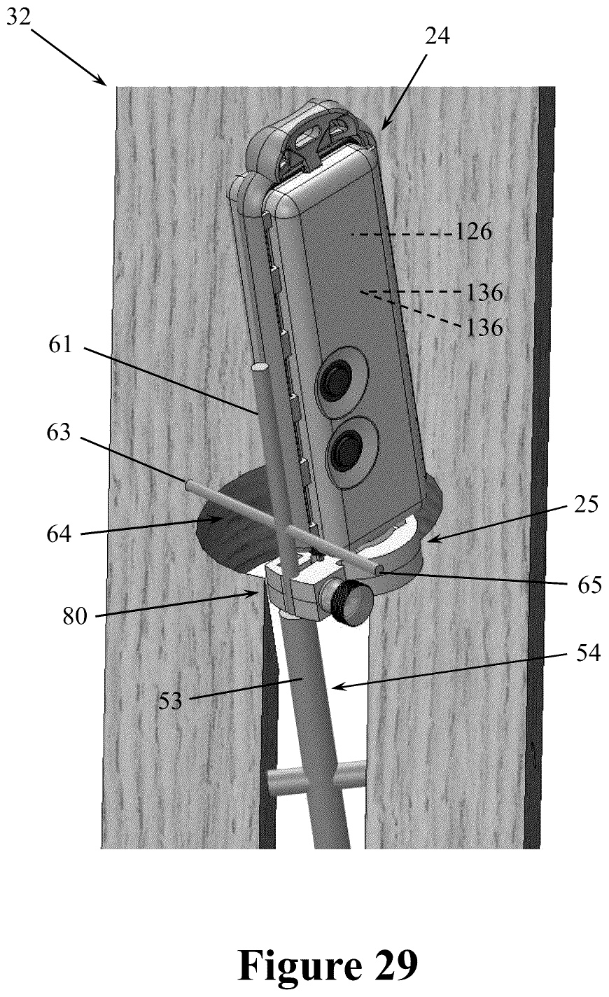

With reference to FIGS. 28 and 29, in another preferred embodiment, the sensing alarm unit 24 is removably mounted by its mounting arrangement 25 to the rotatable shaft or rod 61 of the drive shaft 62 and/or one or both bar segments 63, 65 of the spindle bar or crossbar 64 for rotation substantially in unison therewith during a fish strike. The unit 24 mounted thereto preferably is equipped with at least one motion sensor 136 and preferably at least a plurality of motion sensors 136, such as one or more of an accelerometer, preferably at least a 3-axis accelerometer, gyro, preferably at least at a 3-axis gyro, angular rate sensor, magnetometer, preferably a 3-axis magnetometer, an IMU sensor, an HRU sensor, tilt sensor, inclinometer and/or a combination of two or more of these sensors in communication with processor 126 configured, such as and/or including in software and/or firmware, to detect sensing alarm unit motion relative to the tip up 32, preferably detect rotation of the unit 24 relative to the base or frame 44 of the tip up 32, during rotation of the drive shaft 62 and/or spindle bar or crossbar 64 during a fish strike during tip up fishing operation.

Although not shown in the drawings, the mounting arrangement 25 can be composed of a pair of mounts 76 with one of the mounts 76 removably attached, such as preferably via twist-lock engagement, to one end of the housing 78 of the unit 24 and another one of the mounts 76 removably attached, such as preferably via twist-lock engagement, to the opposite end of the housing 78 of the unit 24. The clamp 80 of both mounts 76 can also be configured to clip or clamp the unit 24 onto corresponding portions or segments of the flagpole 70 at two different spaced apart locations along the flagpole 70 thereby more securely releasably mounting the unit 24 to the pole 70 of the fish strike indicator flag 66 of the tip up 32. Clamp 80 of both mounts 76 can also be used to clip or clamp the unit 24 onto corresponding portions or segments of the rotatable shaft or rod 61 of the tip up drive shaft 64.

If desired, a side of the housing 78 of the unit 24 can also have an elongate recessed mounting channel or groove (not shown) formed in the housing 78 configured for releasably receiving an elongate portion or segment of the flagpole 70 of the flag 66 extending adjacent to and alongside the unit 24 to mount the unit 24 to the pole 70 for movement in unison therewith. Where equipped with such a recessed mounting channel or groove, the unit 24 preferably also is configured thereby to removably mount the unit to the rotary shaft or rod 61 of the drive shaft 64 for rotation of the unit 24 substantially simultaneously therewith.

Magnet 40 can be a rare earth magnet that is annular, circular, cylindrical, or disc-shaped which preferably oriented relative to the tip up 32 with one of its magnetic poles, e.g., north pole, facing upwardly away from the tip up base 44 and the other one of its magnetic poles, e.g., south pole, facing downwardly towards the base 44. Magnet 40 is adhesively attached to the base 44 and/or fixed by one or more fasteners to the base 44 but can be attached to the base 44, including removably attached, in another manner if desired. For example, magnet 40 can also be recessed into, countersunk in, embedded inside, or even encapsulated within the tip up base 44.

Magnet 40 outputs or emits a steady-state source of magnetic and is mounted to the tip up base 44 adjacent the flagpole spring 72 positioned close enough to the magnet sensor 42 of the unit 24 mounted to the flagpole 70 to be sensed by the magnet sensor 42 when the flagpole 72 is releasably engaged with the spindle bar 64 in the generally horizontal fish strike indicator trigger ready position shown in FIGS. 1-4. Magnet 40 is mounted on the crossmember 50 of the tip up base 44 to which the flagpole anchor spring 72 is attached and positioned close enough to the magnet sensor 42 of the unit 24 so as to underlie the sensor 42 such that, when the generally horizontally oriented flagpole 70 disengages from the spindle bar 64 due to spindle bar rotation caused by a fish striking the bait, the unit 24 moves substantially in unison with the flagpole 70 as that flagpole 70 springs upwardly away from the magnet 40 towards the generally vertical fish-strike signaling position.

Magnet 40 preferably has a magnetic flux density of at least 10 gauss and preferably at least 30 gauss. The magnet sensor 42, preferably is an MR sensor that is at least a 9 gauss MR sensor and which preferably is at least a 30 gauss MR sensor. Sensor 42 more preferably is a TMR sensor 45, which is at least a 9 gauss TMR sensor and which preferably is at least a 30 gauss TMR sensor 45.

As previously noted, the unit 24 is configured via mount 25 to be selectively positioned or selectively positionable along the flagpole 70 to which it is releasably mounted to position its onboard magnet sensor 42 in close enough proximity to the magnet 40 of the trigger arrangement 34 fixed to the tip up base 44 to detect relative movement therebetween in a direction away from the magnet 40 when a fish strike disengages the flagpole 70 from the spindle bar 64. When the flagpole 70 is in the trigger ready position, the sensor 42 and unit 24 overlies the magnet 40 and is disposed in close enough proximity thereto such that the magnetic field, flux or flux density of the magnet 40 reaching the sensor 42 is greater than a predetermined threshold field strength, flux, or flux density preventing the sensor 42 from triggering the unit 24 to alarm and/or transmit a wireless alarm message to a portable alarm unit (not shown) located remote therefrom.

When a fish strikes and causes the tip up flagpole 70 to disengage from the rotating spindle bar 64, the strength of the magnetic field, magnetic flux and/or magnetic flux density reduces as the magnet sensor 42 and unit 24 move in unison with the flagpole 70 vertically away from the magnet 40 and tip up base 44 until it falls below a threshold magnetic field strength, flux or flux density of the sensor 42 which causes the sensor 42 to trigger the unit 24 to issue a fish strike indicator alarm and preferably also transmit a wireless fish strike indicator alarm message to a portable alarm unit (not shown) located remote therefrom.

Occurrence of such a fish strike indicator sensing alarm event causes the sensing alarm unit 24 to activate and/or energize one and preferably both of (a) a light, which can be in the form of a light bright enough to be seen for at least 1000 yards, such as a bright flashing strobe, a bright LED light or lamp, or other type of light source, and/or (b) an audio transducer, such as in the form of a loudspeaker, piezoelectric sound transducer, or other type of sound emitting transducer to provide a fish strike alarm that is both visually and audibly perceptible to a user of the tip up who is a fisherman. Occurrence of such a fish strike sensing alarm event also causes the unit to wirelessly transmit a fish strike sensing alarm event message to a remotely-located user transportable handheld alarm unit or controller (not shown) thereby causing the handheld portable alarm unit or controller to activate and/or energize at least one and preferably at least a plurality of (a) a light, such as one or more LEDs, (b) an alarm sound-outputting audio transducer, such as a speaker and/or piezoelectric transducer or actuator, and/or (c) an alarm vibration outputting haptic actuator, such as one or more of a linear resonant actuator (LRA), eccentric rotating mass actuator (ERM), and/or a piezoelectric actuator to provide at least one different type and preferably at least a plurality of different types of fish strike alarm(s) to the user, preferably a fisherman, remotely monitoring operation of the tip up 32.

As the sensing alarm unit 24 and flagpole 70 move in unison upwardly away from the trigger ready position after occurrence of a fish strike, the sensing alarm unit 24 moves away from the magnet 40 fixed to the tip up base 44 causing the magnet sensor 42 to open or close, depending on its configuration, and signal the processor 126 onboard the unit 24 of the occurrence of a sensing event that is a fish strike sensing alarm event. As the sensor 42 moves in unison with the unit 24 and flagpole 70 away from the magnet 40, the magnetic field strength, magnetic flux, or magnetic flux density of the magnet 40 decreases until it drops below a predetermined flux threshold or predetermined flux density threshold that triggers the sensor 42 to open or close and signal the onboard processor 126 of the occurrence of a fish strike sensing alarm event. To facilitate such suitably sensitive sensing of the change in flux or flux density of the magnet 40, preferably the decrease in flux or flux density thereof, which occurs during relative movement between the sensor 42 and magnet 40 caused by them separating from one another during fish-strike indicating flagpole movement, the sensor 42 preferably is a magnetoresistance or magneto-resistive magnetic sensor, e.g., an MR sensor, more preferably a TMR sensor 45, and the magnet 40 preferably is mounted to the frame or base 44 of the tip up with one of its poles, such as its north pole or south pole, facing toward the TMR magnetic sensor 45 and unit 24.

Once such a sensing event occurs that is a fish strike sensing alarm event triggered by the magnet 40 triggering the TMR magnetic sensor 45 of the unit 24 mounted to the tip up flagpole 70, the onboard processor 126 of the unit 24 is configured, such as and/or including in software and/or firmware, to provide a human perceptible alarm in the form of a light or strobe onboard the unit 24 that is energized by the processor 126 of the unit 24. Such a unit 24 adapted for tip up fishing apparatus use is further configured, such as and/or including in software and/or firmware, to wirelessly send a wireless sensing event message that is a fish strike indicator sensing alarm event message to a hand-held manually operable portable transportable user alarm unit or controller (not shared) paired therewith thereby causing the portable handheld user alarm unit or controller (not shown) to output a human perceptible alarm in the form of one or more of an audible tone, energize one or more lights, e.g., LED(S), and/or output a haptic alarm, such as in the form of a vibratory alarm that vibrates the user alarm unit or controller. Because the unit 24 and portable handheld user alarm unit or controller (not shown) are configured for wireless communication, preferably bidirectional wireless communication, therebetween over distances of at least one half mile, preferably at least one mile, and more preferably at least one and a half miles, the portable handheld user alarm unit or controller (not shown) is configured to provide at least a plurality, preferably a plurality of pairs of the audible, light and haptic alarms substantially simultaneously upon receiving a wireless fish strike indicator sensing event message from the unit 24.

To rearm the tip up 32 and the unit 24 after occurrence of a fish strike, the tip up flagpole 70 carrying the unit 24 is reengaged with the spindle bar 64 by bending the flagpole 70 about the coil spring 72 until the flagpole 70 is generally horizontal and received in a notch in the underside of the spindle bar 64. When the flagpole 70 is engaged with the spindle bar 64, the magnetic flux or flux density of the magnetic field lines of the magnet 40 are sensed by the TMR magnetic sensor 45 thereby resetting and/or rearming the unit 24 readying the unit 24 to sense another magnetically triggered fish strike sensing alarm event. In a preferred embodiment, the unit 24 and/or portable transportable handheld user alarm unit or controller (not shown) can be configured so that a control, setting or input onboard one or both the unit 24 and portable handheld alarm unit or controller (not shown) is manipulated or manually operated when the TMR magnet sensor 45 of the unit 24 when flagpole 70 of the tip up 32 is returned to the generally horizontal fish strike detecting or triggering position thereby resetting the unit 24 so it will output a fish strike indicating sensing event message upon the occurrence of the next fish strike.

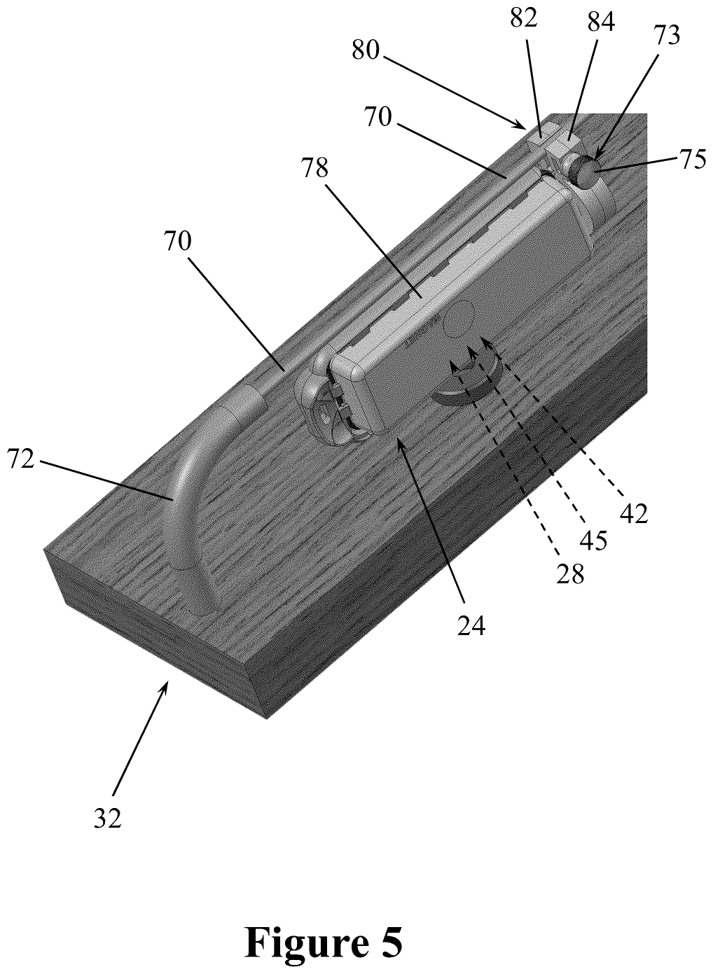

In a second preferred system, sensing alarm unit, and sensor trigger arrangement embodiment and configuration depicted in FIG. 5, the unit 24 also is configured for operation with a piece of outdoor equipment 26, e.g., outdoor recreation equipment, which preferably is a fishing apparatus 30 that more preferably is an ice fishing tip up 32. The second preferred embodiment and configuration also is well suited for use with a tip up 32 like that described above that is equipped with a base 44, e.g., frame, which supports the tip up 32 on the generally horizontally extending ice of a body of water being fished therewith. The sensor trigger arrangement 34 is attached to a movable component of the tip up 32 for movement in unison with movement of the movable component of the tip up 32 and the unit 24 is removably mounted by the mount 76 to the base or frame 44 of the tip up 32 with its onboard sensor 28 disposed adjacent to and in close enough proximity to the trigger arrangement 34 to sense movement of the arrangement 34 relative to the sensor 28 caused by movement of the movable component of the tip up 32 and trigger the unit 24 into issuing an alarm.

In a preferred implementation of the second embodiment and configuration, the sensor trigger arrangement 34 is carried by the spindle bar 64 and operably coupled thereto preferably by being fixed thereto such that the trigger arrangement 34 rotates in unison with the spindle bar 64, the drive shaft 62 and the spool 60 of the reel 58 during ice fishing tip up use and operation. The unit 24 is releasably attached to the base or frame 44 of the tip up 32 by the mount 76 bin a manner that positions the sensor 28 adjacent to and in close enough proximity to the arrangement 34 for the sensor 28 to detect rotational movement of the arrangement 34 relative to the sensor 28 caused when a fish takes and runs with bait attached to fishing line carried by the spool 60 of the tip up reel 58 thereby unspooling line from the spool 60. Unspooling of fishing line from the spool 60 rotates the spool 60 which in turn rotates the drive shaft 62 and spindle bar 64, which disengages and releases the flagpole 70 causing the flagpole 70 to spring uprightly from the generally horizontal fish strike indicator trigger ready position to the generally vertical fish strike indicator position.

As shown in FIG. 5, the trigger arrangement 34 has a plurality of sensor triggers 36a, 36b each configured to trigger the sensing alarm unit sensor 28 with one of the sensor triggers 36a carried by or mounted on one segment or branch 63 of the spindle bar 64 that extends transversely to the drive shaft 62 and support tube 54 in one direction and another one of the sensor triggers 36b carried by or mounted on the other segment or branch 65 of the spindle bar 64 that extends transversely to the drive shaft 62 and support tube 54 in the opposite direction. In preferred configuration, the processor 126 and/or sensor 28 onboard the unit 24 is or are configured, such as and/or including in software and/or firmware, to output at least one of an audible and/or visible alarm upon one of the sensor triggers 36a, 36b triggering the sensor 28 when its rotational movement causes one of the sensor triggers 36a or 36b to pass by the sensor 28 and through a sensing field 47 of the sensor 28 the first time causing the sensor 28 to trigger the unit 24 into issuing an audible and/or visible fish strike indicator alarm. In one such sensing alarm unit configuration, the onboard processor 126 and/or sensor 28 is or are configured, such as and/or including in software and/or firmware, to output at least one of an audible and/or visible fish strike indicator alarm upon the first pass of both sensor triggers 36a, 36b sequentially passing by the sensor 28 during the first rotation, e.g., first complete 360° rotation, of the spindle bar 64, drive shaft 62, and spool 60 upon occurrence of a fish strike where a fish has taken and run with bait. When one of the sensor triggers 36a first passes by and/or across the sensor 28 or all of the sensor triggers 36a, 36b sequentially pass by and across the sensor 28 indicating that a first complete revolution of the spindle bar 64, drive shaft 62 and spool 60 has occurred, the unit 24 can be configured to issue or output a fish strike indicator alarm composed of one or both of an audible alarm and/or a visible alarm substantially simultaneously and/or sequentially, including with respect to a predetermined fish strike indicator alarm sequence implemented in accordance with one or more of the fish strike indicator alarm configuration(s) described in detail above for the first embodiment and configuration.

The unit 24 preferably is further configured to transmit a wireless fish strike alarm message to wirelessly paired remotely located portable handheld alarm unit (not shown) causing the portable alarm unit to issue fish strike indicator alarm composed of one or more of an audible alarm, a visible alarm, and/or a vibratory haptic alarm outputted substantially simultaneously and/or sequentially therefrom, including in a predetermined fish strike indicator alarm sequence. If desired, the portable alarm unit (not shown) can be configured to issue or output a fish strike alarm the same as or similar to that outputted by the portable alarm unit of the first embodiment and configuration described in detail above.

In a first preferred implementation of the second embodiment and configuration, the onboard processor 126 and/or sensor 28 is or are configured, such as and/or including in software and/or firmware, to brightly flash a visual alarm, preferably by energizing a light, such as an LED, onboard the unit 24 a single time upon one of (a) sensor detection of movement of one of the sensor triggers 36a, 36b of the sensor trigger arrangement 34 passing by the sensor 28 and/or through the sensing field extending in front of the sensor 28 a single time during initial fish strike rotational movement of the trigger arrangement 34 being first rotated by the spindle bar 64 in response to a fish striking the bait causing fishing line to unspool from the spool 60 and begin rotation of the spool 60, (b) sensor detection of movement of all of the sensor triggers 36a, 36b of the arrangement 34 sequentially passing by the sensor 28 and/or passing through a sensing field of the sensor 28 extending outwardly from the sensor 28 a single time during the first complete revolution, preferably 360° rotation, of the arrangement 34, spindle bar 64, drive shaft 62 and spool 60 in response to a fish striking the bait causing fishing line to unspool and rotate the spool 600 a first complete revolution, preferably 360° rotation, or (c) sensor detection of movement of all of the sensor triggers 36a, 36b sequentially passing by the sensor 28 and/or passing through a sensing field of the sensor 28 a first time and the first one of the sensor triggers 36a that passed by the sensor 28 and/or through the sensing field of the sensor 28 a first time thereafter passing by the sensor 28 and/or through the sensing field of the sensor 28 a second time in completing the first revolution, preferably 360° rotation, of the trigger arrangement 34, spindle bar 64, drive shaft 62 and spool 60 in response to a fish striking the bait causing fishing line to unspool and rotate the spool 60 a first complete revolution, preferably 360° rotation. Where wirelessly paired with a remotely located transportable handheld portable alarm unit (not shown), the processor 126 onboard the unit 24 is configured, such as and/or including in software and/or firmware, to send one or more corresponding wireless alarm event message(s) to the remotely located portable alarm unit (not shown) whose onboard processor is configured, such as and/or including in software and/or firmware, to flash a visual alarm, preferably by energizing a light, such as an LED, onboard the portable alarm unit a single time and/or at least briefly activate a vibratory alarm, such as by energizing a vibrating transducer onboard the portable alarm unit to vibrationally “pulse” a single time upon occurrence of fish strike indicating rotational movement of one or more or all of the sensor triggers 36a, 36b of the trigger arrangement 34, the arrangement 34, spindle bar 64, drive shaft 62, and spool 60 of the tip up 32 in accordance with that defined in at least one of (a), (b) or (c) set forth above in the preceding sentence.

In such a first preferred implementation, the onboard processor 126 and/or sensor 28 is or are configured, such as and/or including in software and/or firmware, to briefly output a relatively loud audible alarm, preferably in the form of a sound, such as a “beep,” “click,” or “chirp,” from an audio transducer, e.g., speaker or piezoelectric audio transducer, onboard the unit 24 upon or after each revolution, preferably each complete revolution, i.e., each 360º rotation, of the sensor trigger arrangement 34, spindle bar 64, drive shaft 62 and spool 60 caused by continued unspooling of fishing line by a fish who has taken bait attached to the line and run with it. Where wirelessly paired with a portable alarm unit (not shown), the processor 126 onboard the unit 24 is further configured, such as and/or including in software and/or firmware, to send one or more corresponding wireless alarm event message(s) to the portable alarm unit (not shown) whose onboard processor is further configured, such as and/or including in software and/or firmware, to substantially simultaneously also briefly output an audible alarm, preferably in the form of a sound, such as a “beep,” “click,” or “chirp,” from an audio transducer, e.g., speaker or piezoelectric audio transducer, onboard the portable alarm unit upon or after the occurrence of each revolution, preferably each complete revolution, i.e., each 360° rotation, of the trigger arrangement 34, spindle bar 64, drive shaft 62 and spool 60 sensed by the sensor 28 onboard the unit 24. The portable alarm unit processor can be still further configured to also pulse the onboard vibratory alarm or vibratory transducer a single time upon or after the occurrence of each revolution, preferably each complete revolution, i.e., each 360° rotation, of the arrangement 34, spindle bar 64, drive shaft 62 and spool 60 sensed by the sensor onboard the unit.

In one embodiment of the first preferred implementation, the processor 126 and/or sensor 28 is or are configured, such as and/or including in software and/or firmware, to brightly flash the onboard visual alarm, preferably by energizing a light, such as an LED, onboard the sensing alarm unit 24 upon or after the occurrence of a predetermined number of sensor sensed revolutions or rotations of the trigger arrangement 34, spindle bar 64, drive shaft and spool as a result of continued rotation of the spool 60 from a fish that took the bait continuing to unspool line therefrom. Where wirelessly paired with a portable alarm unit, the portable alarm unit processor is further configured, such as and/or including in software and/or firmware, to substantially simultaneously also briefly output a visible alarm by flashing an onboard light, e.g., LED, upon or after the sensing of the predetermined number of revolutions or rotations of the trigger arrangement 34, spindle bar 64, drive shaft 62 and spool 60 by the sensor 28 onboard the unit 24. The portable alarm unit processor can be still further configured cause the onboard vibratory alarm or vibratory transducer to issue a pulse pattern different than when the first rotation or revolution occurs upon or after the sensing of the predetermined number of revolutions or rotations of the arrangement 34, spindle bar 64, drive shaft 62 and spool 60 by the sensor onboard the unit 24.

In one such embodiment, the processor 126 and/or sensor 28 is or are configured, such as and/or including in software and/or firmware, to brightly flash the onboard visual alarm, preferably by flashing a light, such as an LED, upon or after the occurrence of every five revolutions of the sensor trigger arrangement 34, spindle bar 64, drive shaft 62 and spool 60 as a result of a fish taking the bait and unspooling enough fishing line to rotate the spool 60 at least five revolutions or rotations. Where wirelessly paired with a portable alarm unit, the portable alarm unit processor is further configured, such as and/or including in software and/or firmware, to substantially simultaneously also briefly output a visible alarm by flashing an onboard light, e.g., LED, upon or after every five revolutions or rotations of the trigger arrangement 34, spindle bar 64, drive shaft 62 and spool 60 sensed by the sensor 42 onboard the unit 24. The portable alarm unit processor can be still further configured cause the onboard vibratory alarm or vibratory transducer to issue a pulse pattern different than when the first rotation or revolution occurs and different than when each subsequent rotation or revolution occurs upon or after every five revolutions or rotations of the arrangement 34, spindle bar 64, drive shaft 62 and spool 60 sensed by the sensor onboard the unit 24.

In another such embodiment, the processor and/or sensor is or are configured, such as and/or including in software and/or firmware, to brightly flash the onboard visual alarm, preferably by flashing a light, such as an LED, upon or after the occurrence of every ten revolutions of the trigger arrangement 34, spindle bar 64, drive shaft 62 and spool 60 as a result of a fish taking the bait and unspooling enough fishing line to rotate the spool at least ten revolutions or rotations. Where wirelessly paired with a portable alarm unit, the portable alarm unit processor is further configured, such as and/or including in software and/or firmware, to substantially simultaneously also briefly output a visible alarm by flashing an onboard light, e.g., LED, upon or after every ten revolutions or rotations of the arrangement 34, spindle bar 64, drive shaft 62 and spool 60 sensed by the sensor onboard the unit 24. The portable alarm unit processor can be still further configured cause the onboard vibratory alarm or vibratory transducer to issue a pulse pattern different than when the first rotation or revolution occurs and different than when each subsequent rotation or revolution occurs upon or after every ten revolutions or rotations of the arrangement 34, spindle bar 64, drive shaft 62 and spool 60 sensed by the sensor onboard the unit 24.

In a second preferred implementation of the second embodiment and configuration, the onboard processor 126 and/or sensor 28 or 28′ of the sensing alarm unit 24 is configured, such as and/or including in software and/or firmware, to loudly emit an audible alarm, such as by energizing an audio transducer, e.g., loudspeaker, onboard the unit 24 to output a “beep,” “click,” or “chirp a single time upon one of (a) sensor detection of movement of one of the sensor triggers 36a, 36b of the sensor trigger arrangement 34 passing by the sensor 28 and/or through the sensing field of the sensor 28 a single time during initial fish strike rotational movement of the trigger arrangement 34 being first rotated by the spindle bar 64 in response to a fish striking the bait causing fishing line to unspool and begin rotation of the spool 60 of the tip up reel 58, (b) sensor detection of movement of all of the sensor triggers each passing by the sensor 28 and/or passing through a sensing field of the sensor 28 a single time during the first complete revolution, preferably 360° rotation, of the arrangement 34, spindle bar 64, drive shaft 62 and spool 60 in response to a fish striking the bait causing fishing line to unspool and rotate the spool a first complete revolution, preferably 360° rotation, or (c) sensor detection of movement of all of the sensor triggers each passing by the sensor 28 and/or passing through a sensing field of the sensor 28 a first time and the first one of the sensor triggers that passed by the sensor 28 and/or through the sensing field of the sensor 28 passing by the sensor 28 and/or through the sensing field of the sensor 28 a second time during the first complete revolution, preferably 360° rotation, of the arrangement 34, spindle bar 64, drive shaft 62 and spool 60 in response to a fish striking the bait causing fishing line to unspool and rotate the spool a first complete revolution, preferably 360° rotation. Where wirelessly paired with a remotely located portable alarm unit, the processor 126 onboard the unit 24 is configured, such as and/or including in software and/or firmware, to send one or more corresponding wireless alarm event message(s) to the portable alarm unit whose onboard processor is configured, such as and/or including in software and/or firmware, to substantially simultaneously briefly emit an audible alarm, such from an audio transducer, e.g., speaker, in the form of a “beep,” “click,” or “chirp,” a single time and/or briefly activate a vibratory alarm, such as by energizing a vibrating transducer onboard the portable alarm unit to vibrationally “pulse” a single time upon occurrence of fish strike indicating rotational movement of one or more or all of the sensor triggers of the sensor trigger arrangement 34, the trigger arrangement 34, spindle bar 64, drive shaft 62, and spool 60 of the tip up reel 58 in accordance with that defined in at least one of (a), (b) or (c) set forth above in the preceding sentence.

In the second preferred implementation, the onboard processor 126 and/or sensor 28 is or are configured, such as and/or including in software and/or firmware, to briefly output a relatively bright visible alarm, such as by flashing a light that preferably is an LED onboard the unit 24 upon or after each revolution, preferably each complete revolution, i.e., each 360° rotation, of the sensor trigger arrangement 34, spindle bar 64, drive shaft 62 and spool 60 caused by continued unspooling of fishing line by a fish who has taken bait attached to the line and run with it. Where wirelessly paired with a portable alarm unit, the processor 126 onboard the unit 24 is further configured, such as and/or including in software and/or firmware, to send one or more corresponding wireless alarm event message(s) to the portable alarm unit whose onboard processor is further configured, such as and/or including in software and/or firmware, to substantially simultaneously also briefly output a visible alarm by flashing a light that preferably is an LED onboard the portable alarm unit upon or after the occurrence of each revolution, preferably each complete revolution, i.e., each 360° rotation, of the trigger arrangement 34, spindle bar 64, drive shaft 62 and spool 60 sensed by the sensor 28 onboard the unit 24. The portable alarm unit processor can be still further configured to also pulse the onboard vibratory alarm or vibratory transducer a single time upon or after the occurrence of each revolution, preferably each complete revolution, i.e., each 360° rotation, of the arrangement 34, spindle bar 64, drive shaft 62 and spool 60 sensed by the sensor 28 onboard the unit 24. The pulse outputted preferably has a pulse pattern or utilizes a sequence of short pulses different than the single pulse issued by the vibratory alarm, e.g., vibratory transducer, onboard the portable alarm unit upon initial sensing of a fish strike by the sensor 28 onboard the unit 24.

In one embodiment of the first preferred implementation, the processor 126 and/or sensor 28 is or are configured, such as and/or including in software and/or firmware, to relatively loudly emit an audible alarm, preferably using an onboard audio transducer, such as a speaker, that emits a “beep,” “click,” or “chirp” a upon or after the occurrence of a predetermined number of sensor 28 sensed revolutions or rotations of the sensor trigger arrangement 34, spindle bar 64, drive shaft 62 and spool 60 as a result of continued rotation of the spool from a fish that took the bait continuing to unspool line therefrom. Where wirelessly paired with a portable alarm unit, the portable alarm unit processor is further configured, such as and/or including in software and/or firmware, to substantially simultaneously also briefly output an audible alarm by emitting a “beep,” “click,” or “chirp” from an audio transducer, e.g., speaker, onboard the portable alarm unit upon or after the sensing of the predetermined number of revolutions or rotations of the trigger arrangement 34, spindle bar 64, drive shaft 62 and spool 60 by the sensor 28 onboard the unit 24. The portable alarm unit processor can be still further configured cause the onboard vibratory alarm or vibratory transducer to issue a pulse pattern different than when the first rotation or revolution and when each subsequent rotation or revolution occurs upon or after occurrence of the predetermined number of revolutions or rotations of the arrangement 34, spindle bar 64, drive shaft 62 and spool 60 as sensed by the sensor 28 onboard the unit 24.

In one such embodiment, the processor 126 and/or sensor 28 is or are configured, such as and/or including in software and/or firmware, to loudly emit an audible alarm, such as in the form of a “beep,” “click,” or “chirp” emitted from an onboard audio transducer, outputted upon or after the occurrence of every five revolutions or rotations of the sensor trigger arrangement 34, spindle bar 64, drive shaft 62 and spool 60 as a result of a fish taking the bait and unspooling enough fishing line to rotate the spool at least five revolutions or rotations. Where wirelessly paired with a portable alarm unit, the portable alarm unit processor is further configured, such as and/or including in software and/or firmware, to substantially simultaneously also briefly output an audible alarm in the form of a beep,” “click,” or “chirp” emitted by an onboard audio transducer upon or after every five revolutions or rotations of the trigger arrangement 34, spindle bar 64, drive shaft 62 and spool 60 sensed by the sensor onboard the unit 24. The portable alarm unit processor can be still further configured cause the onboard vibratory alarm or vibratory transducer to issue a pulse pattern different than when the first rotation or revolution occurs and different than when each subsequent rotation or revolutions occurs upon or after every five revolutions or rotations of the arrangement 34, spindle bar 64, drive shaft 62 and spool 60 sensed by the sensor 28 onboard the unit 24.

In another such embodiment, the processor 126 and/or sensor 28 is or are configured, such as and/or including in software and/or firmware, to loudly emit an audible alarm, such as in the form of a “beep,” “click,” or “chirp” from an onboard audio transducer, outputted upon or after the occurrence of every ten revolutions of the sensor trigger arrangement 34, spindle bar 64, drive shaft 62 and spool 60 as a result of a fish taking the bait and unspooling enough fishing line to rotate the spool at least ten revolutions or rotations. Where wirelessly paired with a portable alarm unit, the portable alarm unit processor is further configured, such as and/or including in software and/or firmware, to substantially simultaneously also briefly output an audible alarm in the form of a beep,” “click,” or “chirp” emitted by an onboard audio transducer upon or after every ten revolutions or rotations of the trigger arrangement 34, spindle bar 64, drive shaft 62 and spool 60 sensed by the sensor 28 onboard the unit 24. The portable alarm unit processor can be still further configured cause the onboard vibratory alarm or vibratory transducer to issue a pulse pattern different than when the first rotation or revolution occurs and different than when each subsequent rotation or revolutions occurs upon or after every ten revolutions or rotations of the arrangement 34, spindle bar 64, drive shaft 62 and spool 60 sensed by the sensor 28 onboard the unit 24.

In the second preferred system, sensing alarm unit 24, and sensor trigger arrangement embodiment and configuration, the trigger arrangement 34 includes at least a plurality of sensor triggers that are preferably disposed along a common plane and angularly spaced apart so as to oppositely facing or opposed to one another when the arrangement 34 is carried by and preferably mounted to the spindle bar 64 of the tip up fishing apparatus 30 in a manner such that rotation of the spool rotates the drive shaft 62, the spindle bar 64, and the sensor triggers of arrangement 34 in unison during a fish strike, e.g., a fish taking the bait, during operation of the apparatus 30. In one sensor trigger arrangement embodiment, the arrangement 34 is composed of and can consist of a plurality, preferably a pair, of spaced apart sensor triggers with one of the sensor triggers carried by and preferably fixed to one segment or section of a cross-beam of the spindle bar 64 that extends transversely relative to and outwardly from the drive shaft in one direction and the other one of the sensor triggers in turn carried by and preferably fixed to the other segment or section of the cross-beam of the spindle bar 64 that extends transversely relative to and outwardly from the drive shaft 62 in in the opposite direction. Each sensor trigger preferably is carried by or mounted to a respective end of a corresponding one of the sections or segments of the cross-beam of the spindle bar 64 so as to locate each sensor trigger as far out on the respective cross-beam segment or section end in order to position the sensor trigger in close enough proximity to the sensor 28 of the sensing alarm unit to be sensed by the sensor 28 as each sensor trigger respectively passes through a sensing field extending outwardly of or from the sensor 28 toward the sensor trigger as the sensor trigger passes by the sensor 28 during rotation of the spindle bar 64 and the sensor triggers fixed thereto during unspooling of fishing line from the spool 60 of the reel 58 of the tip up apparatus 30 when a fish strikes and takes the bait.

In one embodiment, a single revolution or rotation of the sensor trigger arrangement 34 composed of a pair of oppositely outwardly facing or disposed sensor triggers respectively fixed to oppositely outwardly extending segments or sections of the cross-bar of the spindle bar 64 is detected when the sensing alarm unit sensor senses one of (a) each one of the pair of the sensor triggers passing by the sensor 28 during spindle bar rotation driven by unspooling of fishing line from the spool 60 of the ice fishing apparatus tip up reel 58, or (b) each one of the pair of the sensor triggers passing by the sensor 28 once and the first one of the pair of sensor triggers passing by the sensor 28 a second time. In another preferred sensor trigger embodiment, the sensor trigger embodiment is composed of or consists of at least a plurality of pairs of, i.e., at least three, sensor triggers carried by or mounted to the spindle bar 64 that are equiangularly spaced apart from one another and arranged to rotate substantially in unison with the spindle bar 64 in or along a common plane disposed generally in line with the sensor 28 disposed adjacent to and preferably alongside the spindle bar 64. In one such preferred sensor trigger embodiment, the trigger arrangement 34 is composed of or consists of four, five, six, seven, eight or even more of the sensor triggers carried by or fixed to the spindle bar 64 each disposed at or along a radially outermost end of part of the spindle bar 64 or an arrangement 34 carrying the sensor triggers mounted to the spindle bar 64 which are equiangularly spaced apart from one another and preferably have adjacent sensor triggers equidistantly spaced apart from one another. In one such particularly preferred sensor trigger embodiment composed of at least a plurality of pairs, i.e., at least three, of equiangularly and/or equidistantly spaced apart sensor triggers, the sensor triggers includes a sensor trigger carrier, such as in the form of a plastic or nonmagnetic housing, to which all of the sensor triggers are mounted with the sensor trigger carrier releasably mounted to the spindle bar 64 of the tip up fishing apparatus 30 such that the sensor trigger carrier rotates in unison with the spindle bar 64, drive shaft 62, and spool 60 of the tip up reel 58 during tip up fishing apparatus use and operation. In such a particularly preferred trigger arrangement 34, the sensor trigger carrier is generally circular, round, annular, disc-shaped or cylindrical such as in the form of a generally circular, round, annular, disc-shaped and/or cylindrical plastic or nonmagnetic metallic sensor trigger carrier wheel having at least a plurality of pairs of, i.e., at least three, equiangularly and/or equidistantly spaced apart sensor triggers, preferably at least four equiangularly and/or equidistantly spaced apart sensor triggers, more preferably at least five equiangularly and/or equidistantly spaced apart sensor triggers, even more preferably at least six equiangularly and/or equidistantly spaced apart sensor triggers and which can even have eight or more equiangularly and/or equidistantly spaced apart sensor triggers, if desired.

In at least one preferred embodiment, the carrier wheel is equipped with a rattle that is configured to make a noise, e.g., rattle, during each rotation or revolution of the wheel during ice fishing apparatus operation. In another preferred embodiment, the carrier wheel has a mechanical clicker or mechanical clicking arrangement that is configured to make at least one click during each rotation or revolution of the wheel during fishing apparatus operation.

In a preferred embodiment, each sensor trigger of or used in any of the sensor trigger arrangements described in the preceding paragraph and in any of the paragraphs describing the second preferred system, sensing alarm unit, and sensor trigger arrangement embodiment and configuration is a steady-state source of a magnetic field, magnetic flux or flux density that is provided for or by each sensor trigger with a sensor trigger magnet that is a permanent magnet, such as a rare earth magnet. In one preferred embodiment, each sensor trigger is composed of or consists of a single permanent magnet of circular, disc-shaped, cylindrical, square or rectangular shape and arranged with the same respective common magnetic pole facing radially outwardly from the sensor trigger carrier, e.g., sensor trigger magnet carrier, such as preferably sensor trigger carrier wheel, such that the magnetic field, magnetic flux and magnetic flux density extends outwardly towards a sensor 28 of the unit that is a magnet sensor 42 spaced from but in close enough proximity to the sensor 42 for the sensor 42 to sense at least one of the magnetic field, magnetic flux and/or magnetic flux density and/or a change in the magnetic field, magnetic flux and/or magnetic flux density, such as a change in the magnitude or strength of the magnetic field, magnetic flux and/or magnetic flux density, of each sensor trigger magnet passing by the sensor 42 of the unit 24 during rotation of the sensor trigger magnetic carrier, e.g., magnet carrier wheel, relative to the sensor 28 and unit 24 during tip up fishing apparatus use and operation. In another preferred embodiment, the trigger magnets are arranged with one magnetic pole, i.e., the north pole, of every other magnet facing radially outwardly from the sensor trigger magnet carrier, e.g., magnet carrier wheel, with the other magnetic pole, i.e., the south pole, of each magnet disposed in between every other magnet facing radially outwardly from the sensor trigger magnet carrier, e.g., magnet carrier wheel. In still another preferred embodiment, the equiangularly and/or equidistantly spaced trigger magnets are radially outwardly disposed on the sensor trigger magnet carrier, e.g., magnet carrier wheel, and oriented such that the magnetic poles of each magnet face generally circumferentially or tangentially relative to the carrier, e.g., carrier wheel, and thereby face generally transversely or orthogonally relative to the magnet sensor 42 of the unit during rotation of the carrier, e.g., wheel, and magnets carried thereby relative to the sensor 42 and unit 24 during tip up fishing apparatus use and operation. If desired, the magnetic poles of each magnet can be oriented oppositely to the magnetic poles of the adjacent magnet disposed on each side thereof or the magnetic poles of each magnet can be oriented to face in the same direction as the magnetic poles of the adjacent magnet disposed on each side thereof.

As previously discussed, the sensor 28 of the sensing alarm unit 24 is a magnetic sensor 42 that preferably is a MR sensor that more preferably is a TMR sensor 45 because an MR magnetic sensor, preferably TMR magnetic sensor 45, advantageously has greater sensitivity and/or selectivity in sensing one of (a) a magnetic field, magnetic flux, and/or magnetic flux density, e.g., magnitude thereof, outputted by a steady state magnetic field source thereof, e.g., permanent magnet, and (b) a change in the magnetic field, magnetic flux, and/or magnetic flux density, e.g., change in magnitude thereof, outputted by the steady state permanent magnet magnetic field source thereof, and has a greater signal output range corresponding thereto enabling more accurate, reliable and repeatable alarm triggering of the unit during operation of the equipment, preferably fishing apparatus 30, more preferably ice fishing tip up 32, being monitored by the unit. The unit preferably also has at least one other type of onboard sensor such as preferably at least one or both of (a) an angle, orientation, position or movement sensor (AOPM sensor), such as an inclinometer, angle sensor, accelerometer, angular rate sensor, gyroscope, e.g., 3-axis, 6-axis gyro or 12-axis gyro, and/or multi-axis inertial measurement unit (IMU), e.g., 3-axis, 6-axis or 12-axis IMU, configured to sense at least one of a change in angle, angular acceleration, orientation, rotation, motion or movement, linear acceleration, and/or position of the unit 24 and output a corresponding alarm trigger thereto that causes the unit 24 to alarm, and/or (b) one or more of a proximity, motion or distance sensor (PMD sensor) including one or more a proximity sensor, e.g., an infrared sensor such as a PIR sensor, a motion sensor, such as an ultrasonic motion sensor or radar sensor, and/or a distance sensor, such as an ultrasonic distance sensor or doppler sensor, configured to sense motion of a nearby object or a change in a distance relative to a nearby object and trigger the unit 24 into alarming.

In a preferred embodiment of a sensor trigger arrangement 34, the arrangement 34 is a generally circular, round, annular, disc-shaped or cylindrical sensor trigger magnet carrier wheel that carries at least a plurality, preferably at least a plurality of pairs of, i.e., at least three, e.g., four, five, six, seven or more, equiangularly spaced apart and/or equidistantly spaced apart permanent trigger magnets is three-dimensionally configured or contoured, such as by being molded, so as to fit over, snap onto, couple with, operatively connect to, or otherwise operably cooperate with one or more rotatable components of a fishing apparatus, such as one or more of a spool, reel, gears, rotor or other component of the fishing apparatus that rotate during operation of the fishing apparatus, in a manner such that the carrier and its trigger magnets rotate substantially in unison with rotation of the one or more rotatable components of the fishing apparatus upon and/or during occurrence of a fish strike and/or as well as during unspooling of fishing line from a spool of the reel of the fishing apparatus by the fish that first struck the bait running with the bait attached to the line after occurrence of the fish strike. In one preferred embodiment, the generally circular, round, annular, disc-shaped or cylindrical permanent magnet carrying carrier wheel is three-dimensionally contoured, e.g., mold, to fit over or onto the spindle bar 64 of a tip up fishing apparatus 30, such as by being of snap-fit construction that removably snaps onto the spindle bar 64, in a manner that enables the carrier and magnets of the carrier to rotate in unison with the spindle bar 64, the drive shaft 62, and the spool 60 of the reel 58 of the tip up fishing apparatus 30 during fishing use and operation. In another preferred embodiment, such a permanent trigger magnet carrying carrier wheel is configured to fit over, fit on, snap onto, couple with, operatively connect to or with, or otherwise operably cooperate with one of a spool, reel, rotor, handle, gearing, e.g., one or more gears, and/or other component(s) of a fishing apparatus that is one of a casting reel such as a baitcasting reel, a spincast reel or a spinning reel, a conventional reel or a trolling reel, an offshore reel, a surf reel, a bank fishing reel, a rattle reel, a fly fishing reel, or a centerpin reel or a centrepin reel which rotates during or from a fish strike and after the fish strike when the fish that took the bait runs with the bait unspooling line from the spool rotating the spool, reel, rotor, handle, one or more gears, and/or other component(s) of the fishing apparatus. In one such preferred embodiment, one of the spool, reel, rotor, handle or gear(s) of such a fishing apparatus that is one of a casting reel such as a baitcasting reel, a spincast reel or a spinning reel, a conventional reel or a trolling reel, an offshore reel, a surf reel, a bank fishing reel, a rattle reel, a fly fishing reel, or a centerpin reel or a centrepin reel has at least a plurality of equiangularly and/or equidistantly spaced apart magnetic sensor triggers 36a, 36b, preferably each in the form of a permanent magnet trigger magnet, mounted thereto, fixed thereto, formed therein, and/or molded therein or therewith for rotation substantially in unison therewith. In one particularly preferred embodiment, at least a plurality, preferably at least a plurality of pairs of permanent magnets are affixed to, mounted on, formed in, integrally formed with, integrally molded with or into a fishing line carrying spool of a reel of a fishing apparatus, such as a casting reel, e.g., baitcasting reel, spincast reel or spinning reel, a conventional reel or a trolling reel, an offshore reel, a surf reel, a bank fishing reel, a rattle reel, a fly fishing recl, or a centerpin reel or a centrepin reel.

The unit 24 preferably is mounted to ground by being mounted to a stationary non-rotating component of the fishing apparatus, such as (a) part of a frame of the casting reel, e.g., baitcasting reel, spincast reel or spinning reel, a conventional reel or a trolling reel, an offshore reel, a surf reel, a bank fishing reel, a rattle reel, a fly fishing reel, or a centerpin reel or a centrepin reel and/or (b) a fishing rod to which the casting reel, e.g., baitcasting reel, spincast reel or spinning reel, a conventional reel or a trolling reel, an offshore reel, a surf reel, a bank fishing reel, a rattle reel, a fly fishing reel, or a centerpin reel or a centrepin reel is removably mounted. The unit 24 is mounted to ground by being mounted to such a stationary non-rotating component of the fishing apparatus with its onboard magnetic sensor, preferably MR magnetic sensor, more preferably TMR magnetic sensor disposed adjacent to one of the sensor trigger magnet-carrying magnetic carrier wheel configurations described in the preceding paragraph that is carried by, mounted to, or an integral component of a fishing apparatus that is one of a baitcasting reel, such as a spincast reel or spinning reel, a conventional reel or trolling reel, an offshore reel, a surf reel, a bank fishing reel, a rattle reel, a fly fishing reel, or a centerpin reel or a centrepin reel.

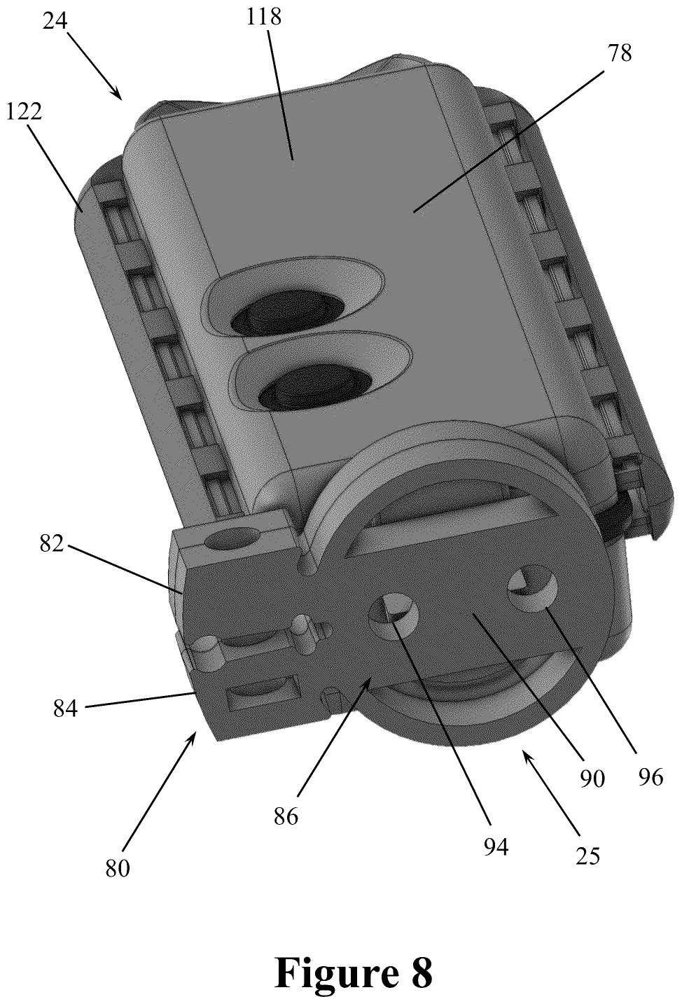

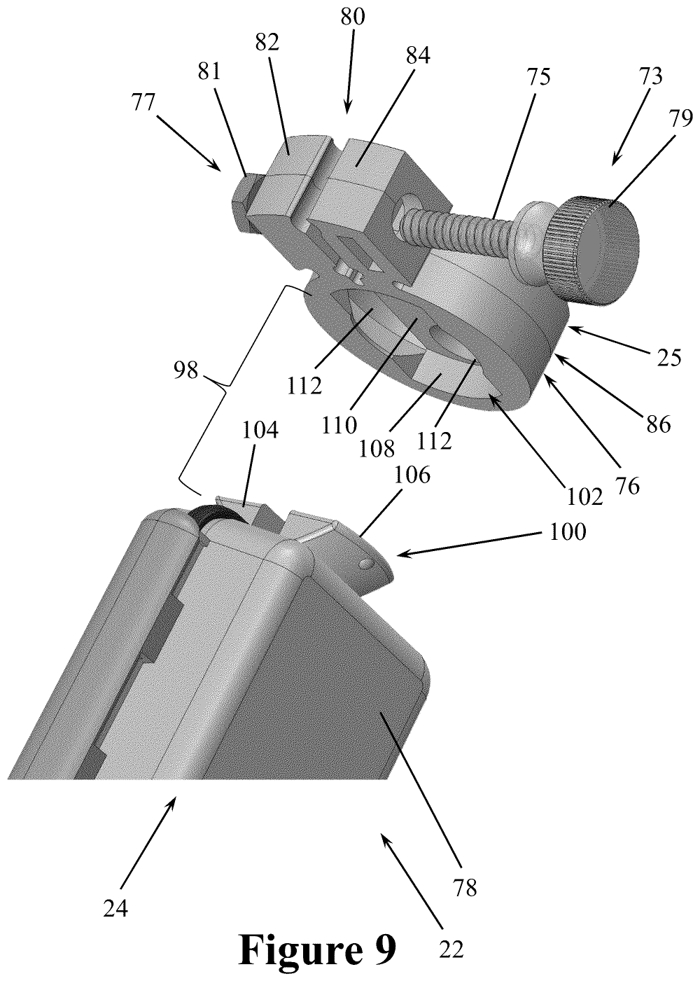

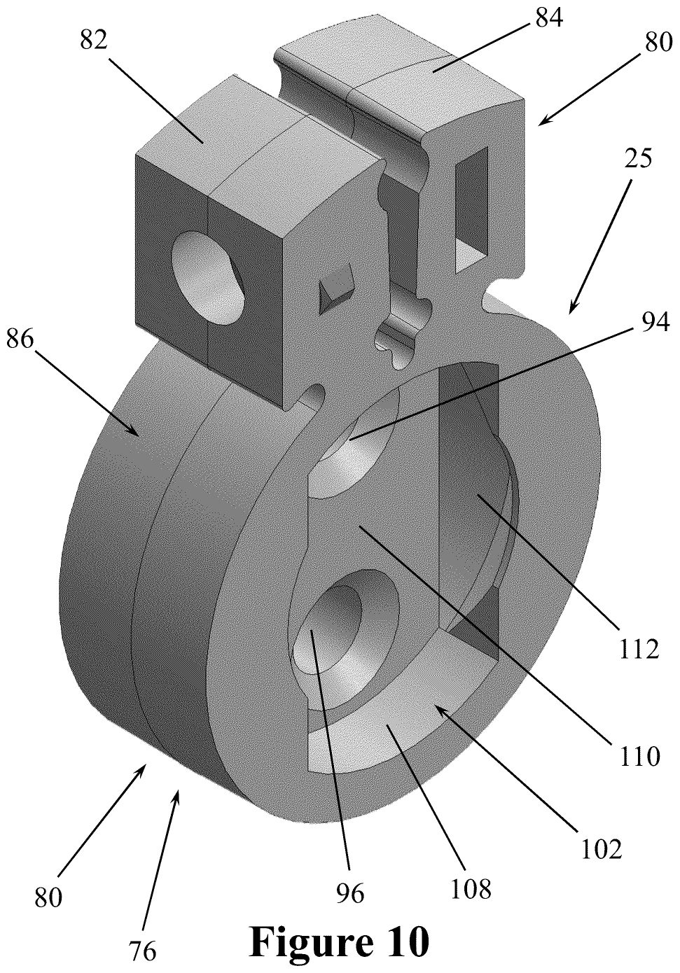

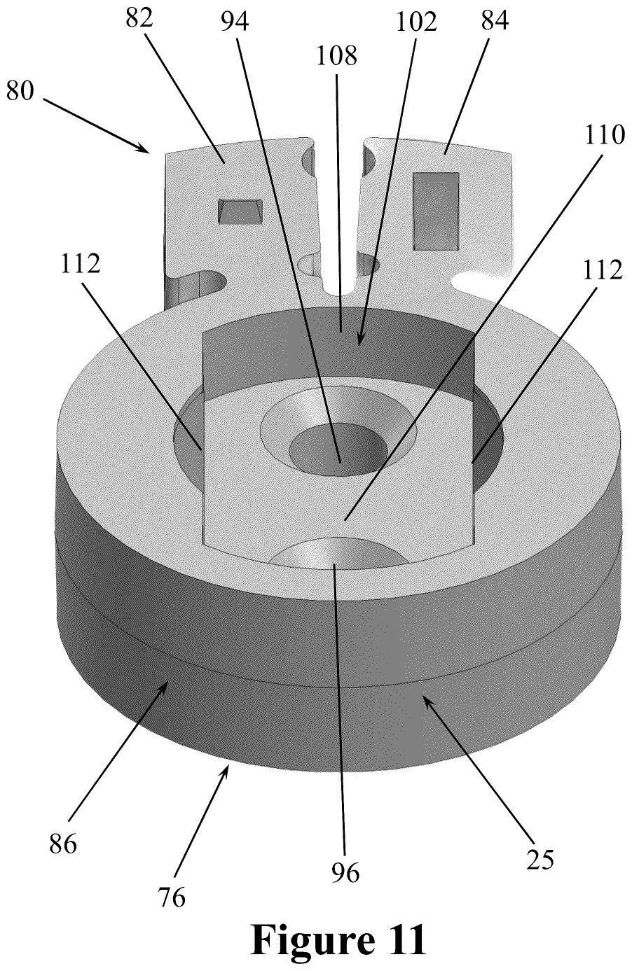

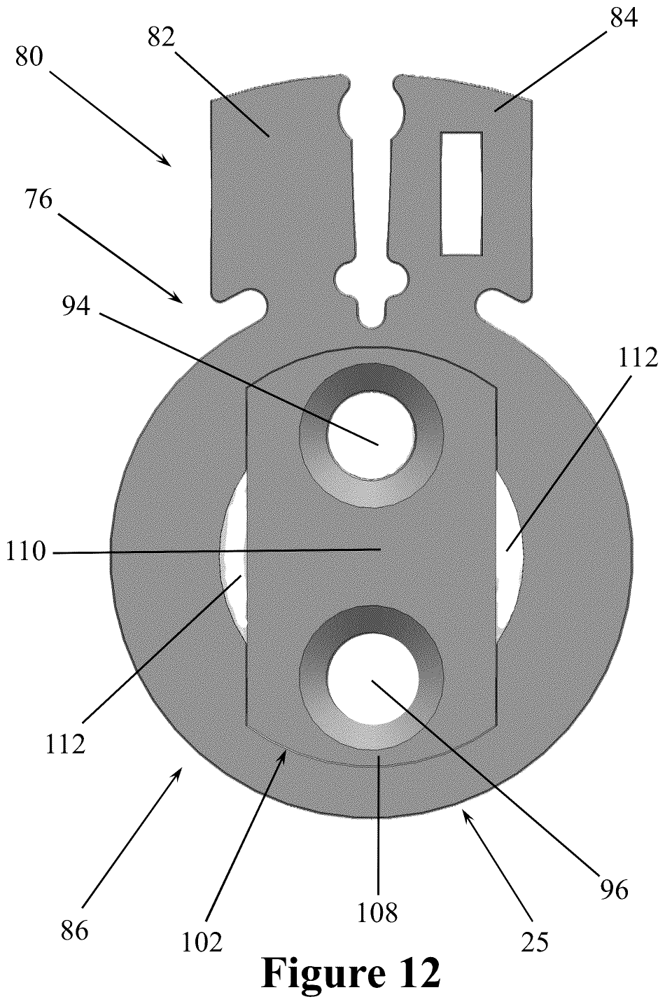

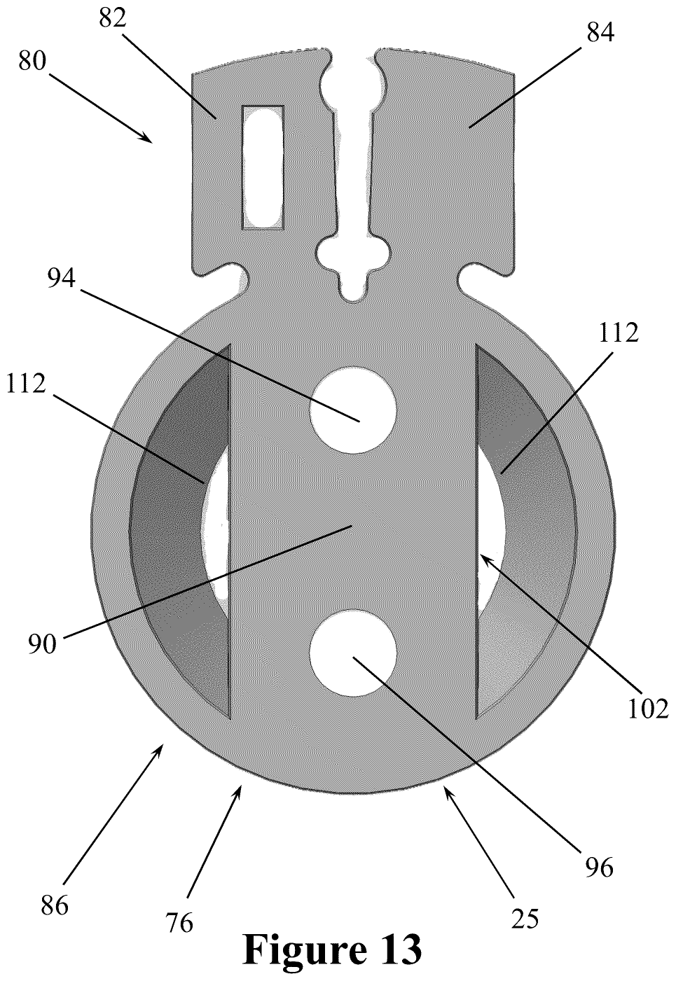

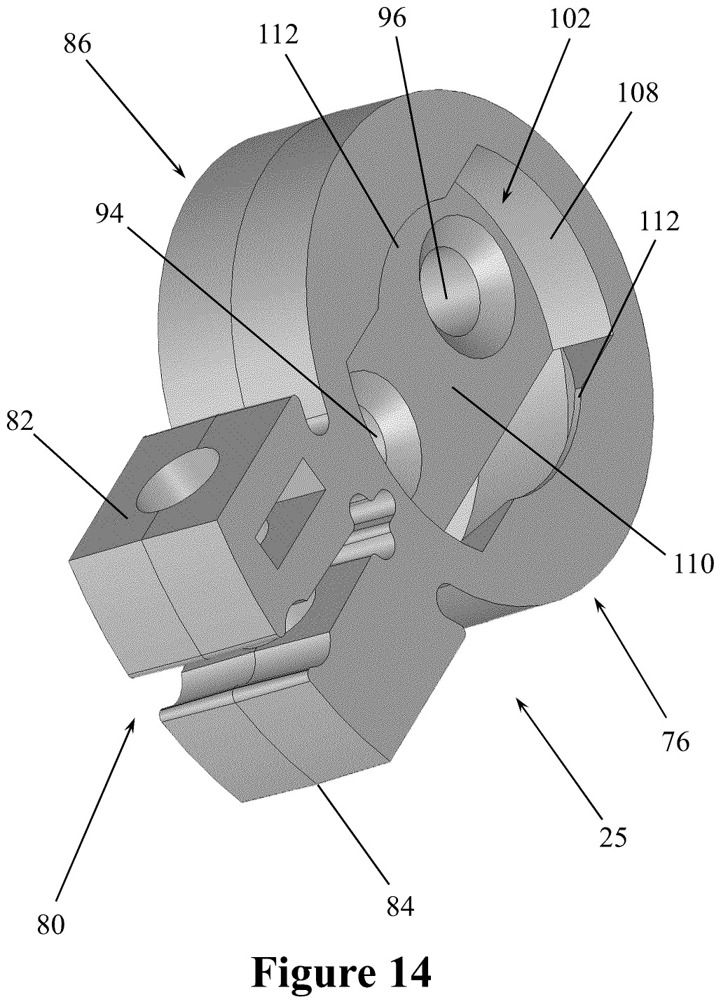

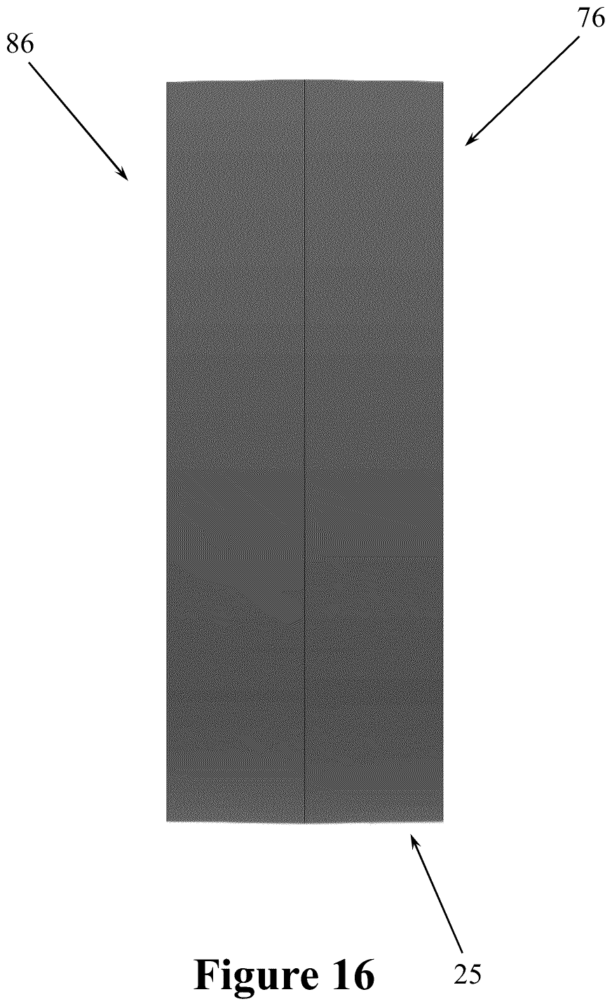

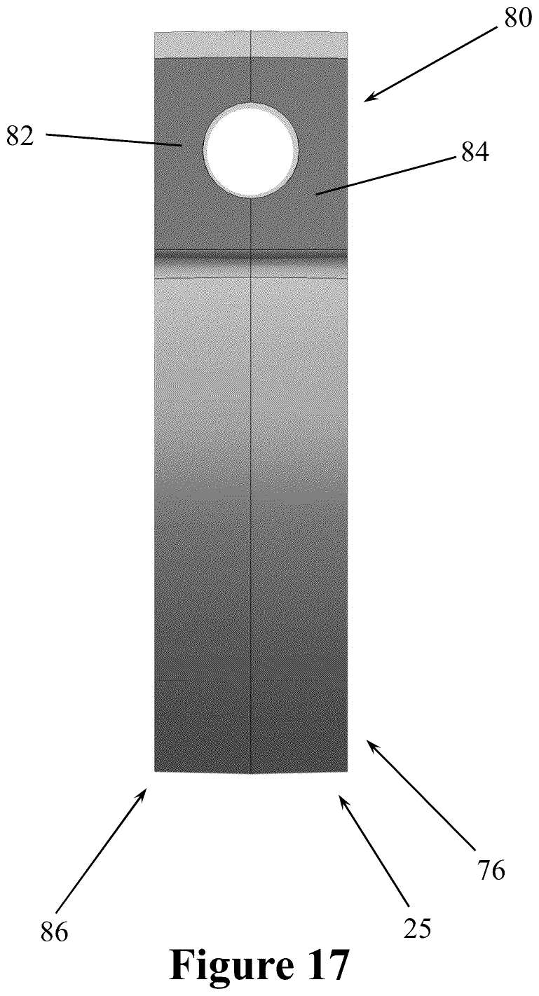

With reference to FIGS. 1 and 7-9, the unit 24 is removably attachable by a multifunction mount 76 of a sensing alarm unit mounting arrangement 25 of versatile construction to a piece of equipment 22 being monitored by the unit 24. Additional views of mount 76 of the mounting arrangement 25 are shown in FIGS. 9-17. As previously discussed, in a preferred embodiment, mount 76 is releasably attachable to either the flagpole 70 of a tip up 32 or the base or frame 44 of the tip up 32. The mount 76 is composed of a mounting base or pedestal 86 that is configured for releasable twist-on and twist-off engagement, more preferably twist-lock engagement, with a male mount docking arrangement 88 of the housing 78 that extends outwardly from one end, e.g., a bottom, of the housing 76 and which is three-dimensionally configured for twist-on engagement with the base or pedestal 86 of the mount 76 and for twist-off disengagement with the base or pedestal 86 of the mount 76. The mounting base or pedestal 86 of the mount 76 has a generally flat or planar bottom mounting surface 90 configured for secure mounting to a top surface 92, which is preferably a generally flat and/or substantially planar mounting surface 93, of a piece of equipment 22, such as preferably a tip up 32, which is to be monitored by the unit 24. Mounting preferably is preferably done by either adhesively affixing the generally flat or planar bottom surface of the mount base or pedestal 86 to the surface 92 of the piece of equipment 22 or by using a pair of fasteners received in a corresponding one of a pair of spaced apart mounting through bores 94, 96 that extend completely through the based or pedestal 86 of the mount 76.

With additional reference to FIG. 9, the mounting pedestal or base 86 of the mount 76 of mounting arrangement 25 is releasably mounted to the housing 78 of the unit 24 by a rotatable dovetail joint 98 formed via releasable twisting or rotational engagement therebetween. One of the housing 78 and the mounting pedestal or base 86 of the mount 76 has an outwardly extending male dovetail 100 that is rotatively received a dovetail receiving receptacle 102 formed in the other one of the housing 78 and the mounting pedestal or base 86 of the mount 76. In a preferred embodiment, the housing 78 has an outwardly extending oblong male dovetail 100 formed of a pair of outwardly extending flared dovetail cars 104, 106 and the mounting pedestal or base 86 of the mount 76 has a generally rectangular recessed dovetail receiving receptacle 102 formed therein having an enlarged generally circular dovetail insertion or docketing entranceway 108 configured for insertion of the male cars 104, 106 of the dovetail 100 until their ends bottom out against receptacle floor 110. Once the cars 104, 106 of the dovetail 100 are inserted into the dovetail receiving entranceway 108 until the dovetail cars bottom out against the receptacle floor 110, one of the mount 76 and unit 24 is twisted relative to the other one of the mount 76 and unit 24 until the dovetail cars 104, 106 are received in a corresponding one of a pair of car receiving undercuts 112, 114 disposing the dovetail cars 104, 106 in interference engagement with parts of the pedestal or base 86 that form opposite sides and/or opposite ends of the recessed dovetail receiving receptacle 102 by underlying one or both the dovetail receptacle sides and/or ends.

In one preferred embodiment, the dovetail 100 is inserted into the dovetail receiving entranceway 108 of the receptacle 102 until the dovetail 100 bottoms out against the receptacle floor 110 and then one of the mount 76 and unit 24 is twisted relative to the other one of the mount 76 and unit 24 at least 20 degrees and preferably no more than 150 degrees relative to the mounting base for releasable twist-lock engagement of the mount 76 to the housing 78 of the unit 24 to be achieved. In one such preferred embodiment, the cars 104, 106 of the dovetail 100 are inserted into the entranceway 108 of the receptacle 102 and twisted between about 35 degrees and 105 degrees to releasably secure the unit 24 to the mount 76 in a manner that prevents the unit 24 from pulling away or disengaging from the mount 76. In another preferred embodiment, the dovetail 100 is inserted into the receptacle 102 and the mount 76 is rotated relative to the unit 24 about 90° for releasable but secure twist locking engagement therebetween to occur.

The sensing alarm unit 24 can be and preferably is configured to wirelessly communicate via radio frequency communications with a remote transportable user alarm unit of the sensing system that is configured to provide a human perceptible audible, visual, vibratory, or other type of human perceptible alarm to a user carrying the alarm unit upon a sensing event triggering an onboard sensor of the unit. The unit 24 can have onboard wireless communications, sensing, and/or alarm circuitry as well as onboard magnetic, proximity, and/or other sensors, such as sensors 42 and/or 45, in a configuration or arrangement similar to or substantially the same as the sensor base unit disclosed in the aforementioned '735 patent. Although not shown in the drawings, the transportable user alarm unit can be further configured as a controller, like the master controller fob disclosed in the '735 patent, which is adapted to control at least a plurality of functions, operating parameters, and the like of the unit 24 via two-way wireless communication with or between the unit 24. The transportable user alarm unit, including when configured as a controller, e.g., master controller fob of the '735 patent, can be of portable hand-held construction and configured for manual, preferably one-hand operation, or can also be implemented in firmware or software, such via an app or software program, run by a processor-equipped multifunction electronic device, such as a smartphone, tablet, notebook computer, desktop computer, or another type of suitable processer-equipped device.

With reference to FIGS. 18-19, the unit 24 preferably has a housing 78 composed of a housing assembly 116 that includes a pair of generally rectangular box like plastic housing panels 118, 120 releasably secured together by a plastic generally U-shaped slide-on panel locking clip 122 that slidably engages the generally parallel opposite side edges 115, 117 of respective housing panels 118, 120 to releasably secure them together. Each one of the side edges 115 and 117 has an outturned lip 119, 121 extending substantially the length of corresponding edge 115, 117. The U-shaped clip 122 has an elongate endcap 131 with an outwardly extending handle 133 and a pair of generally parallel elongate arms 135, 137 which each have a plurality of alternatingly staggered parallel housing panel engaging tabs 127, 129 between which the corresponding lips 119, 121 of the respective edges 115, 117 of the panels 118, 120 are retained when the clip 122 is slid over them.

The unit 24 also includes internal components 125 disposed within and/or carried by the housing 78, including a sensing alarm unit circuit 124 embodied in a circuit board 33, an onboard processor 126 mounted to the circuit board 33, an onboard magnet sensor 42 that preferably is a TMR sensor mounted to the circuit board 33, an onboard electrical power source 130, which preferably is a direct current power source, such as a AA or AAA battery, for providing electrical power to the circuit board 33 and the internal components 125, including the electrical components 127 carried by or mounted to the board 33. The internal components 125 can also include one or more capacitors, resistors, diodes, and other electrical components not specifically identified in FIGS. 18-19 needed for operation of circuit board 33. The internal components 125 preferably also includes an onboard wireless radio frequency communications system 132, which can be similar to or substantially the same as the wireless radio frequency communications system disclosed in the '735 patent. The onboard wireless radio frequency communications system 132 can be in the form of an integrated circuit or chip mounted to the circuit board 33. The internal components 125 preferably further includes at least one LED 134 that preferably is of color changing construction, at least one audio transducer (not shown), which preferably is a speaker or piezoelectric transducer, and, in addition to sensor(s) 42 and/or 45, at least one motion sensor 136, such as one or more of an accelerometer, gyro, IMU, HRU, GPS sensor, magnetometer, inclinometer, angle sensor, tilt sensor and/or one or more other types of motion sensors. In the embodiment shown in FIG. 18, the circuit includes a motion sensor 136 that is a tilt sensor 138, such as a mercury switch or another type of tilt sensor, configured to sense the tilt of the unit 24 during use and operation. The internal components 125 can and preferably do also include a magnetically attractive magnet anchor 140 disposed adjacent to, carried by or positioned against an internal surface of housing panel 120 underlying a generally circular magnet seat target 142 shown adjacent the “magnet” label on an external surface of panel 120 to enable a magnetic sensor trigger magnet (not shown in FIGS. 18-19), e.g., magnet 38, to be received and magnetically retained in place on the magnet seat target 142. As is shown in FIG. 18, the magnet anchor 140 is disposed between the magnet sensor 42 and the magnet seat target 142. As is shown in FIG. 19, the magnet anchor 140 is received in a pocket 141 in the internal surface of panel 120. Unit 24 also has a plurality of sensing alarm unit controls 144, 146 shown as corresponding generally round buttons 148, 150 disposed in respective openings 152, 154 in one of the housing panels 118. The buttons 148, 150 include spaced apart upraised portions 156, 158 formed in a flexible elastomeric waterproof membrane 160 disposed between an internal surface of housing panel 118 and the circuit board 33 that respectively overlie spaced apart switches 162, 164 shown in FIG. 19 mounted on the board 33.

The sensing alarm unit housing 78 releasably mates with a twist lock mount 76 that has (a) a twist lock dovetail recess 102 formed in the pedestal or base 86 of the mount 76 for receiving a pair of outwardly extending and flared dovetail cars 104, 106 of a male dovetail 100 that is received in the dovetail recess 102 and twisted or rotated, preferably about ninety degrees, to releasably secure the housing 78 of the unit 78 to the base or pedestal 86 of the mount 76; and (b) components of an adjustable flagpole clamp jaw tightener or clamp force adjuster 77 that includes thumbscrew 75 with an enlarged knurled head 79 from which an elongated threaded stem 75 extends through aligned through-bores in each clamp jaw 82, 84 and rotatably received in a threaded nut 81 seated in a recessed nut seat nut formed in the jaw 82 opposite the jaw 84 against which the enlarged thumbscrew head 79 bears or engages during clamping via clamp jaw tightening.

The sensor trigger arrangement 34 is configured for positioning relative to one or more sensors 42, 45 and/or 136 of the unit 24 in order to operatively interact or cooperate therewith, including remotely, to trigger one or more of the sensors 42, 45 and/or 136 of the unit 24 upon the occurrence of relative movement between the unit 24 and part of the fishing apparatus 30, e.g., fishing tip up 32. The trigger arrangement 34 can take the form of one or more sensor trigger configurations described in more detail hereinbelow having one or more sensor triggers, packaging configurations, mounting arrangements, and/or operating orientations, which can be and preferably is or are tailored to the fishing, hunting, trapping or other outdoor or recreational application or equipment with which the sensor alarm unit 24 is intended to be used.

The unit 24, including its circuitry 33, sensors 42, 45 and/or 136, and any other onboard electric components 127, is powered by an electrical power supply 130 that preferably is disposed onboard the unit 24, which can be in the form of at least one and as many as a plurality or plurality of pairs, i.e., at least three, D, C, AA, or AAA batteries, which can be rechargeable. Further in accordance with the teachings of Applicant's aforementioned '735 patent, the unit 24 can also be configured to wirelessly network with one or more other units 24 to form a sensing network or system composed of at least a plurality of the units 24, which in turn can be configured to wirelessly communicate with a single or common transportable user alarm unit, such as disclosed in the '735 patent, which can be further adapted as a controller, e.g., master controller, which controls one or more functions, parameters, and/or aspects of each unit 24 in the network or system, and/or sensing alarm unit system operation. However, as disclosed in more detail below, it is contemplated that a sensing network or system, unit 24, trigger arrangement 34, and transportable user alarm unit and/or master controller constructed and configured in accordance with the present invention will have several differences compared to the corresponding components of the alarm system disclosed in Applicant's aforementioned '735 patent.

A preferred embodiment of the unit 24 is equipped with at least one onboard magnetic sensor 42 and/or 45 that is at least one of a magnetic field sensor, magnetic flux sensor or magnetic flex density sensor that is constructed and/or configured to sense a magnetic field, change in magnetic field, change in magnetic field, magnetic field strength, change in magnetic field strength, magnetic flux, change in magnetic flux, a magnetic flux density and/or change in magnetic flux density of a sensor trigger arrangement 34 that is a magnetic sensor trigger arrangement 35 employing a magnetic trigger in the form of at least one magnet 40, e.g., rare earth permanent magnet, and output an electrical signal which the processor 126 onboard the unit 24 is configured, such as and/or including in software and/or firmware, to interpret as a magnetic sensor sensing event, e.g., magnetic sensor sensing event interrupt, preferably an alarm event, e.g., sensing alarm event interrupt, and generate a sensing event message that preferably is an alarm event message that causes at least one human perceptible alarm to be outputted from the unit 24. Where the sensing event is an alarm event, (a) at least one human perceptible alarm uniquely associated with a magnetic sensor sensing event in the form of at least one audible, visual, and/or vibratory alarm is outputted by or from the unit 24 and/or (b) a corresponding magnetic sensor sensing alarm event message is wirelessly transmitted from the unit 24 to the transportable user alarm unit or controller causing at least one human perceptible alarm uniquely associated with the magnetic sensor sensing event, in the form of at least one audible, visual, and/or vibratory alarm, to be outputted by or from the unit 24 and/or transportable user alarm unit.

In a preferred magnetic sensor embodiment, at least one magnetic sensor 42 and/or 45 onboard the unit 24 and preferably each sensor 42 and/or 45 onboard the unit 24 is constructed and/or configured to be or function as a plurality of a magnetic field sensor, magnetic flux sensor and magnetic flux density sensor constructed and/or configured to sense at least a plurality of a magnetic field, change in magnetic field, magnetic field strength, change in magnetic field strength, magnetic flux, change in magnetic flux, magnetic flux density and/or change in magnetic flux density of a magnetic sensor trigger arrangement that has at least one steady state source of a magnetic field, magnetic flux and/or magnetic flux density in the form of at least one permanent magnet 40 that preferably is a rare earth magnet. Each sensor 42 preferably is a MR sensor that employs a MR sensing element, which can be an Anisotropic Magnetoresistance sensor or Anisotropic Magneto-Resistive sensor (AMR magnetic sensor) or a Giant Magnetoresistance sensor or Giant Magneto-Resistive sensor (GMR magnetic sensor), but which preferably is a TMR sensor 45 because a TMR sensor 45 provides greater signal output, possesses higher accuracy, greater magnetic field or flux sensitivity and/or selectivity, and better stability as result of less temperature drift and less aging deterioration. Use of at least one TMR sensor 45 onboard the unit 24 provides more versatility as a TMR sensor 45 can also be used as an angle sensor, a position sensor, and/or a rotary sensor, e.g., rotation sensor when sensing changes in the magnetic field or flux of a magnet 40 carried by a fishing apparatus 30.

Use of a magnetic sensor 42 onboard the unit 24 that preferably is an MR sensor and more preferably a TMR sensor 45 having such greater sensitivity, selectivity and signal output compared to a conventional reed switch or Hall magnetic sensor advantageously means sensing of the sensor trigger magnet 40 can occur where the magnet or other source of the sensed magnetic field is located a greater distance away from the TMR magnetic sensor 45. This enables a system with a unit 24 equipped with an MR sensor that preferably is a TMR sensor 45 to be used in sensing or alarm applications that do not require the trigger magnet 50 to be seated in a magnetically attractive magnet seat 142 of the unit 24 and pulled out of the seat 142 in order to cause the sensor 42, preferably TMR sensor 45, to trigger a magnetic sensor sensing event and output a corresponding alarm emanating either from the unit 24 and/or the remotely located transportable alarm or controller. This therefore also enables such a system equipped with such a unit 24 utilizing at least one MR sensor that preferably is a TMR sensor 45 to be used in sensing or alarm applications not requiring an elongate tether or line, e.g., an elongate flexible string, rope, or wire, to be attached to the trigger magnet 40 or part of a sensor trigger arrangement 34 carrying the magnet 40 or otherwise in operable cooperation with the magnet 40 in order to pull the magnet 40 from the seat 142 of the unit 24 to trigger a magnetic sensor sensing event and output a corresponding alarm emanating from the unit 24 and/or the remotely located transportable alarm or controller.

With continued reference to FIGS. 18-19, such a magnet seat 142 can be carried by, disposed on, or formed in unit 24, such as by being carried by, disposed on, or formed in the housing 78 of unit 24. The seat 142 can include or be disposed adjacent a magnetically attractive trigger magnet anchor 140, such as one made of a magnetic metallic material, carried by the unit housing 78 which helps releasably retain the trigger magnet 40 in the seat 142 via magnetic attraction therebetween until the magnet 40 is pulled out of or from the seat 142 by a force acting on the line or tether in a direction generally away from the seat 142. Where the sensor 42 is a TMR sensor 45 disposed onboard the unit 24, use of a TMR sensor 45 advantageously also enables the sensor trigger magnet 40 to be located in nearly any position outside or external of the housing 78 of the unit 24 and spaced from the TMR sensor 45 nearly any distance from the TMR sensor 45 and from the unit 24 in any direction when the magnet 40 is disposed in a predetermined set, armed, or sensor trigger ready position so long as the strength of the magnetic field, magnetic flux and/or magnetic flux density of the magnet 40 is great enough to be sensed by the TMR sensor 45 and capable of establishing, e.g., calibrating, a threshold magnetic field strength, magnetic flux and/or magnetic flux density and/or corresponding magnetic field strength, magnetic flux, and/or magnetic flux density range of the magnet 40 to enable a change in one or more thereof falling below or outside of the threshold or threshold range to be determinative of the occurrence of movement, e.g., translation, and/or rotation, of part of the equipment, e.g., apparatus 30, such as ice fishing tip up 32, relative to the TMR sensor 45 onboard the unit 24 being indicative of occurrence of an event or condition, such as a fish strike or fish unspooling line from a rotary spool or reel of the apparatus 30.

In at least one embodiment of unit 24, each unit 24 has at least one TMR sensor 45 onboard the unit 24 that is configured as at least one, and preferably at least a plurality, of an angle sensor, a position sensor, and a rotary sensor or rotation sensor, such as by being configured to function as at least one, and preferably at least a plurality, of an angle sensor, a position sensor, and a rotary sensor. In at least one embodiment, each unit 24 has at least one TMR sensor 45 onboard the unit 24 that is configured to sense at least one of, and preferably at least a plurality of, a magnetic field, a change in magnetic field, a magnetic field strength, a change in magnetic field strength, a magnetic flux, a change in magnetic flux, a magnetic flux density, and a change in magnetic flux density. In at least one embodiment, each unit 24 is equipped with at least one TMR sensor 45 onboard the unit 24 configured as at least one, and preferably at least a plurality, of an angle sensor, a position sensor, and a rotary sensor where the TMR sensor 45 is configured to sense at least one, and preferably at least a plurality, of a magnetic field, change in magnetic field, magnetic field strength, change in magnetic field strength, magnetic flux, change in magnetic flux, magnetic flux density and change in magnetic flux density of a sensor trigger magnet 40.

In one preferred unit 24, the unit 24 has at least one onboard magnetic sensor 42 that preferably is a TMR sensor 45 which communicates with the onboard processor 126 which are configured, such as and/or including in software and/or firmware, so the TMR sensor 45 senses magnetic transitions, such as in the form of a magnetic field transition, magnetic flux transition, and/or magnetic flux density transition of or caused by at least one trigger magnet 40 such as by being configured to sense (a) an open condition upon occurrence of a first magnetic field transition caused by a change in one or more of magnetic field strength, magnetic flux and/or magnetic flux density of the at least one trigger magnet 40 of a magnetic sensor trigger arrangement 35 sensed by the TMR sensor 45 with the open condition magnetic transition change being defined by a reduction in at least one or more of magnetic field strength, magnetic flux and/or magnetic flux density of the at least one trigger magnet 40 of the magnetic sensor trigger arrangement 35 sensed by the TMR sensor 45, and/or (b) a closed condition upon occurrence of a second magnetic field transition caused by a change in one or more of magnetic field strength, magnetic flux and/or magnetic flux density of the at least one trigger magnet 40 of the magnetic sensor trigger arrangement 35 sensed by the TMR sensor 45 with the closed condition magnetic transition change being defined by an increase in at least one or more of magnetic field strength, magnetic flux, and/or magnetic flux density of the at least one trigger magnet 40 of the magnetic sensor trigger arrangement 35 sensed by the TMR sensor 45. In one preferred embodiment and implementation, (a) an open condition occurs as a result of one of the trigger magnet 38 and magnetic sensor 42, preferably TMR sensor 45, moving linearly, angularly, and/or rotatively relative to the other one of the magnet 38 and sensor 42, preferably TMR sensor 45, away from one another a great enough distance, inclination, and/or rotational angle such that the magnitude, amplitude, or strength of the magnetic field, magnetic flux or magnetic flux density of the magnet 40 sensed by, e.g., extending to or into or passing through, the sensor 42, preferably TMR sensor 45, drops below a first predetermined threshold magnetic field strength, magnetic flux, or magnetic flux density, e.g., drops to zero, drops to about zero, or drops below zero, and (b) a closed condition occurs as a result of one of the trigger magnet 38 and magnetic sensor 42, preferably TMR sensor 45, moving linearly, angularly, and/or rotatively relative to the other one of the magnet 40 and sensor 42, preferably TMR sensor, toward one another a large enough distance, inclination and/or rotational angle such that the magnitude, amplitude or strength of the magnetic field, magnetic flux or magnetic flux density of the magnet 40 sensed by, e.g., extending to or into or passing through, the sensor 42, preferably TMR sensor 45, reaches or exceeds a second predetermined threshold magnetic field strength, magnetic flux or magnetic flux density that is much greater than zero.

Such a unit 24 and magnetic sensor 40, preferably TMR sensor 45, disposed onboard the unit 24 preferably is or are configured to sense or be capable of sensing (a) alternating open-closed-open-closed magnetic transitions of the trigger magnet 40 where at least a plurality of open-closed transitions occur and are sensed by sensor 42, preferably TMR sensor 45, during operation and/or (b) alternating closed-open-closed-open magnetic transitions of the magnet 40 where at least a plurality of closed-open transitions occur and are sensed by the sensor 42, preferably TMR sensor 45, during operation. In one embodiment of a system, magnet sensor equipped unit 24, and sensor trigger arrangement 34 consisting of or equipped with at least one trigger magnet 40 that preferably is a single trigger magnet 40, alternating open and closed transitions can be caused by a corresponding positive or negative change in at least one or more of magnetic field strength, magnetic flux, and/or magnetic flux density of the magnet 40 sensed by sensor 42, preferably TMR sensor 45, when in magnetic field or flux communication therewith resulting from a change in position, orientation, angle, inclination, and/or rotation of a component of a piece of equipment, preferably part of a fishing apparatus 30, to which the trigger magnet 40 is attached and which correspondingly moves relative to sensor 42, preferably TMR sensor 45, of the unit 24 used to monitor operation of the piece of equipment, preferably fishing apparatus 30.

In one preferred system and magnetic sensor equipped unit 24 of the present invention, the trigger arrangement 34 is a magnetic sensor trigger arrangement 35 equipped with and/or consists of a single sensor trigger magnet 40 carried by and preferably mounted to a component of a fishing apparatus 30′, such as a movable component of a fishing reel that moves during fishing reel operation, where the magnet 40 is disposed in close enough proximity relative to sensor 42, preferably TMR sensor 45, for the magnet 40 to be in magnetic field or magnetic flux communication with the sensor 42, preferably TMR sensor 45, such that the magnetic field force lines or magnetic flux lines of the magnet 40 extend to, preferably into, and more preferably pass through the sensor 42, preferably TMR sensor 45, when the movable component of the apparatus 30′, preferably the movable component of the fishing reel, which carries the magnet 40 is disposed in a preset ready to trigger ready position or condition. In such a preferred system and magnetic sensor equipped unit 24, the unit 24 is also mounted, preferably removably mounted, to the apparatus 30′, such as with a mounting arrangement, e.g., mounting arrangement 25, substantially immovably fixed to part of the fishing reel or a rod carrying the fishing reel, to which the unit 24 is removably attached.

Unit 24 is attached to a part or component of the apparatus 30′ other than the movable component of the apparatus 30′ such as part of the apparatus 30′ that is grounded or immovable relative to the movable component thereby enabling movement of the movable component and each sensor trigger magnet 40 carried by the movable component relative to the unit 24 and the sensor 42, preferably TMR sensor 45, during use and operation of the apparatus 30′. In a preferred embodiment, there is at least one trigger magnet 40 attached to a rotatable spool of a fishing apparatus 30′, such as a fishing reel attached to a fishing rod or pole, with the unit 24 being fixed to the rod, pole, or another part of the fishing reel that does not move. Depending upon the construction, arrangement and operation of the apparatus 30′ and its movable component, the movable component can carry a plurality of the magnets 40 spaced apart so as to provide an indication of displacement or a change therein, translation or a change therein, inclination or a change therein, and/or rotation or a change therein, e.g., rotation angle or a change therein, during use and operation of the apparatus 30′.

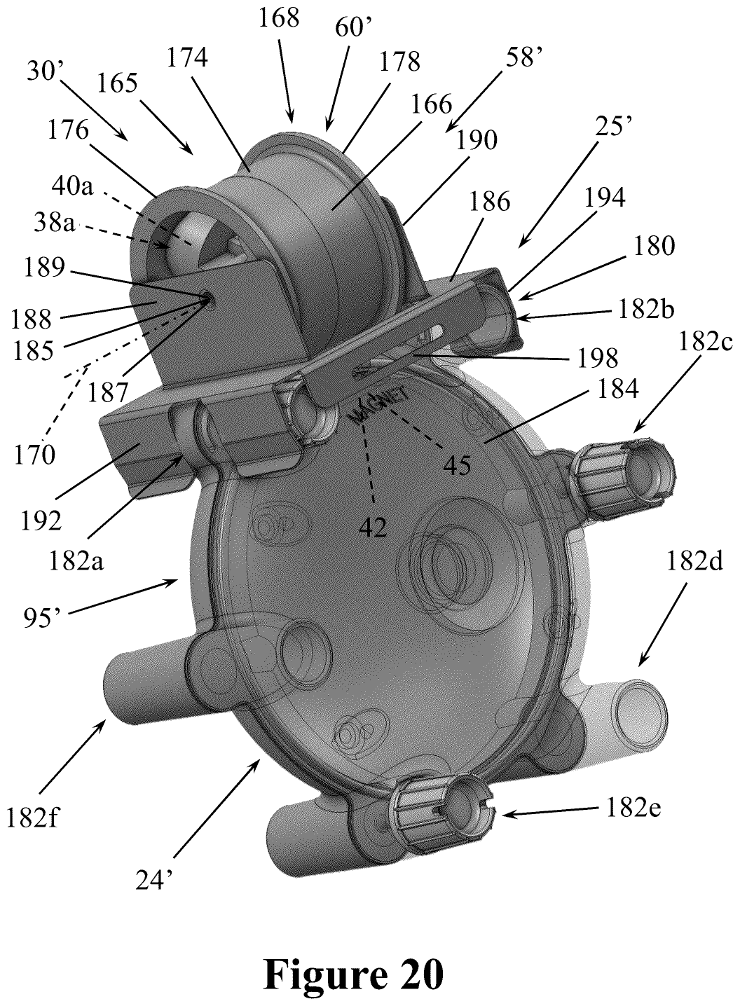

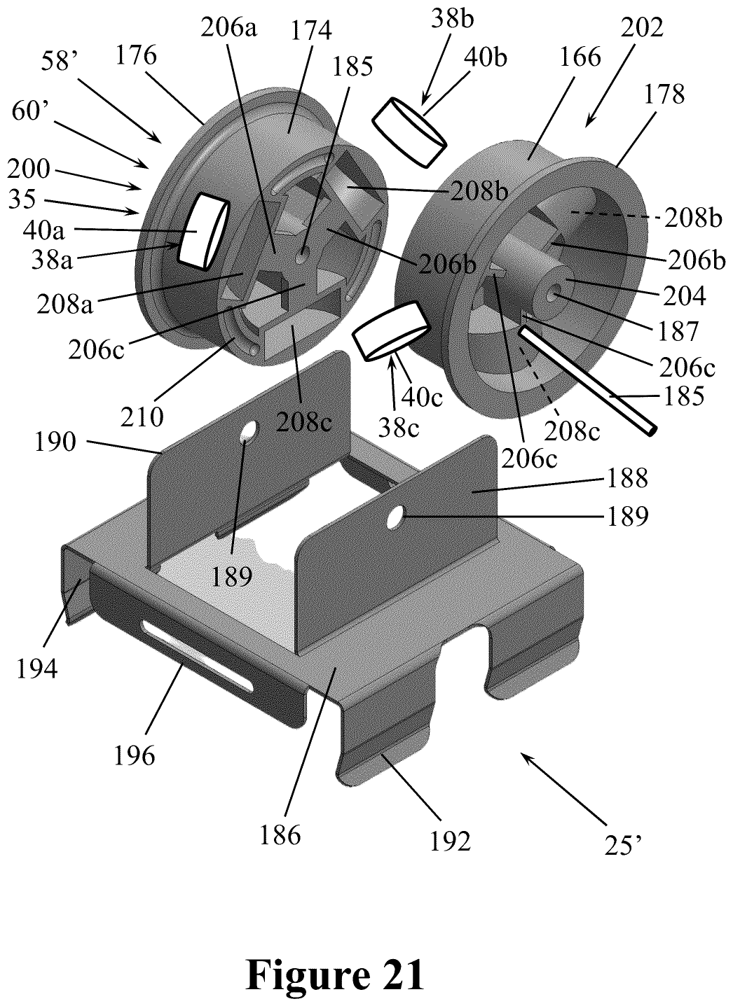

With reference to FIGS. 20 and 21, in another preferred system, magnetic sensor equipped unit 24, and magnetic sensor trigger arrangement 35 of the present invention, the trigger arrangement 34 has or consists of at least a plurality, preferably at least a plurality of pairs, i.e., at least three, spaced apart trigger magnets 38a, 38b, 38c arranged in a magnet array that all have the same magnetic poles, e.g., all north poles or all south poles, facing generally toward sensor 42, preferably TMR sensor 45. In one such preferred system, unit, and trigger arrangement 34, the array of magnets 38a, 38b, 38c are arranged with alternating opposite magnetic poles, e.g., north pole, south pole, north pole, facing generally towards sensor 42, preferably TMR sensor 42, during use and operation of the fishing apparatus 30′.

Although not shown in the drawings, in one preferred multiple magnet sensor trigger arrangement 35, at least a plurality, preferably at least a plurality of pairs, i.e., at least three, permanent magnets 40a, 40b, 40c are fixed to or embedded in an elongate flat or planar generally rectangular magnet holder, e.g., magnet-holding track, which preferably is made of a non-magnetic material, such as plastic. The magnets 40 are equidistantly spaced apart from each another and arranged in a line along the elongate generally flat multiple magnet-holding track with alternating magnetic poles, e.g., north, south, north, south, of the magnets of the track facing outwardly generally toward sensor 42, preferably TMR sensor 45, of the unit 24 during use and operation. If desired, the elongate generally flat multiple magnet-holding track can have two, three, four, five, six, seven or even more spaced apart trigger magnets 40 adhesively attached to the track, attached with fasteners to the track, embedded in the track, and/or integrally molded with or in the track.

With reference once again to FIGS. 20 and 21, a multiple magnet-holding track 165 constructed in accordance with the present invention can be a multiple magnet track 166 of endless construction, such as where the track is arranged as a cylinder or generally circular wheel 168 that is a generally cylindrical or wheel-shaped multiple magnet-holding track 165 having at least a plurality, preferably at least a plurality of pairs, i.e., at least three, of the sensor trigger magnets 38a, 38b, 38c with one of the magnetic poles of each magnet facing radially outwardly relative to a central axis of rotation 170 of the wheel 168. Each one of the trigger magnets 38a, 38b, 38c preferably is a permanent magnet 40a, 40b, 40c. Although the rest of the fishing apparatus 30′ is not shown, the wheel 168 is a rotary spool 60′ that preferably is part of a fishing apparatus 30′, such as preferably part of a fishing reel 58′, which can be configured to have fishing line (not shown) wrapped around an outer surface 174 thereof in a manner that rotates the spool 60′ when a fish bites and takes the line. The outer fishing line holding surface 174 of the spool 60′ axially spaces apart a pair of circumferentially extending radially upraised flanges 176, 178 extending along each side of the surface 174 that are configured to help retain the fishing line wrapped around the outer surface 174 of the spool 60′ between the flanges 176, 178.

As is shown in FIG. 20, the spool 60′ of the fishing reel 58′ fishing apparatus 30′, is attached to a sensor alarm unit 24′ of the present invention by a removable mounting arrangement 25′ that preferably is a clip 180 configured to releasably snap onto a plurality of spaced apart outwardly extending portions 182a, 182b of or carried by a housing 184 of the unit 24′. The clip 180 has a base 186 with a pair of spaced apart extending rotary spool mounting flanges 188, 190 extending in one direction that are each configured for receiving and rotatively supporting a respective portion an axle 185, e.g., an elongate pin or rod, extending through a bore 187 in the wheel 168, preferably spool 60′, therebetween. More particularly, each wheel mounting flange 188, 190 preferably is configured with a through-opening 189 that receives and rotatively supports a corresponding part, e.g., end, of the axle 185. The mounting clip base 186 also has a plurality of pairs of resiliently biased sensor alarm unit engaging clamp arms 192, 194 extending in the opposite direction that are respectively configured to snap around a corresponding one of a pair of outwardly extending portions 182a, 182b, 182c, 182d, 182c, and/or 182f of the unit 24′. Each one of the outwardly extending portions 182a, 182b, 182c, 182d, 182c, and/or 182f can be either or both a foot and/or fastener, e.g., thumbscrew, of the unit 24′. Disposed in between the arms 192, 194 along opposite edges of the base 186 is a pair of downturned abutments or stops 196, 198 that bracket opposite sides of the pair of outwardly extending portions 182a, 182b of the unit 24′ engaged by clamp arms 192, 194 to prevent the clip 180 from sliding off.

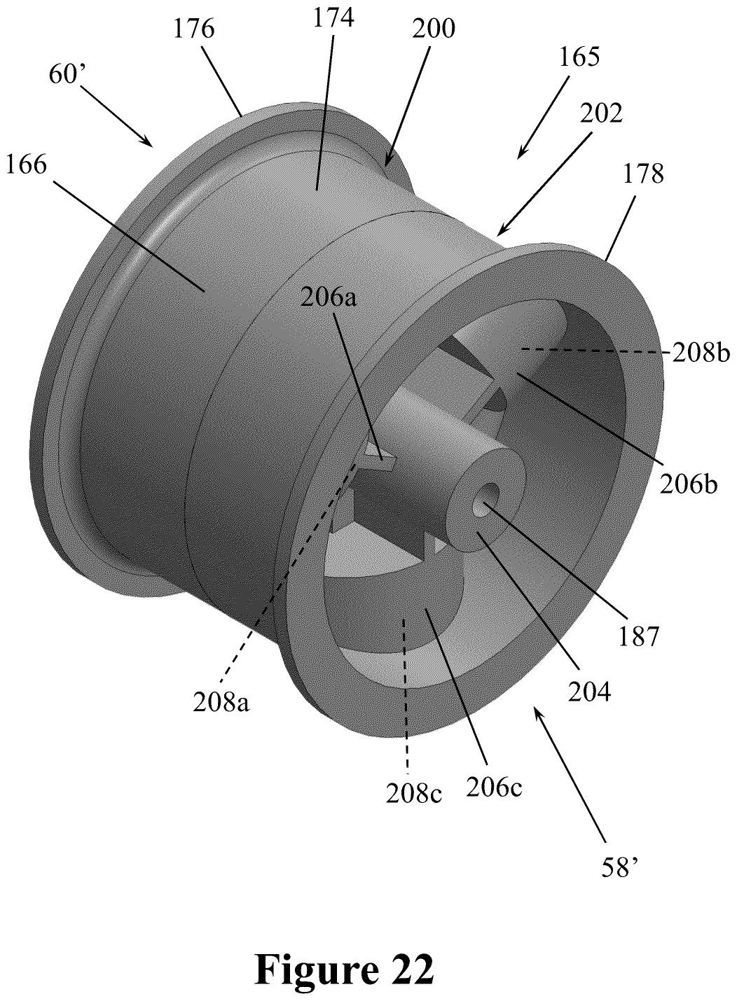

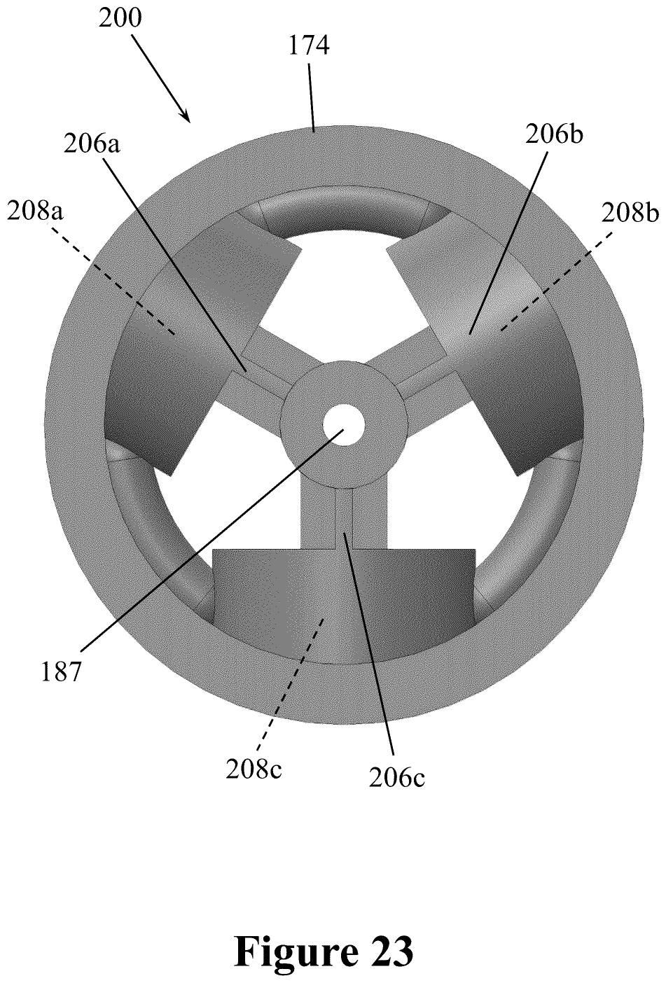

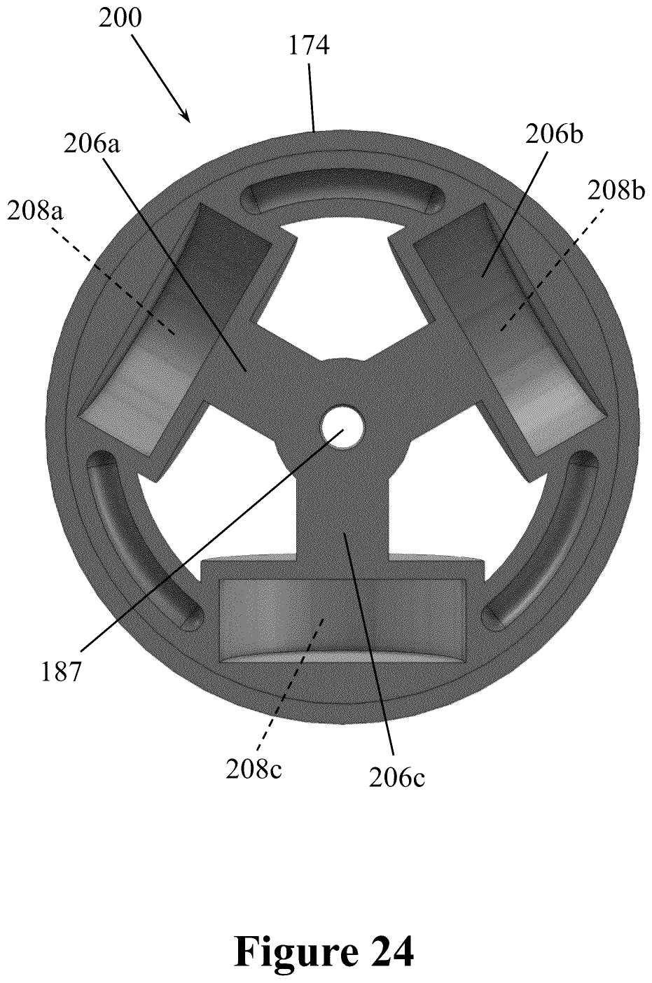

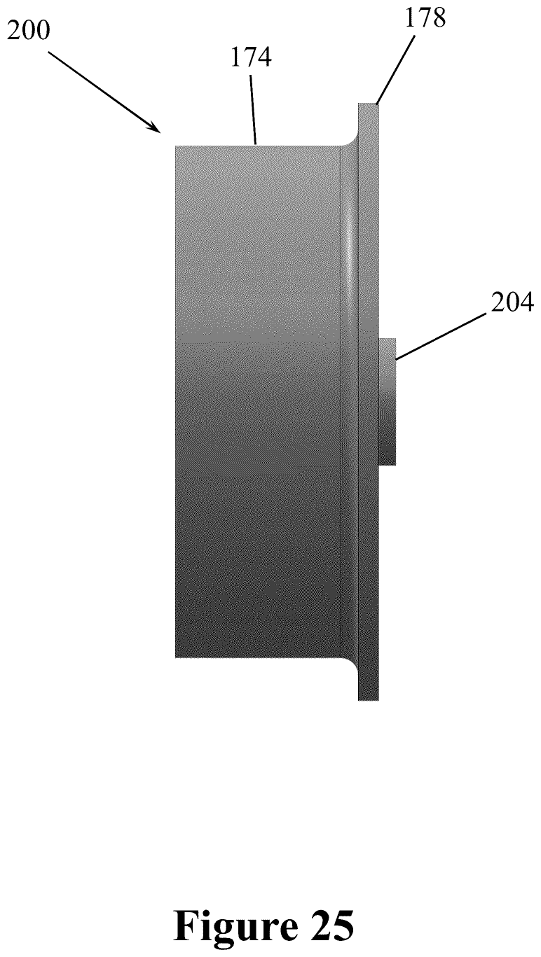

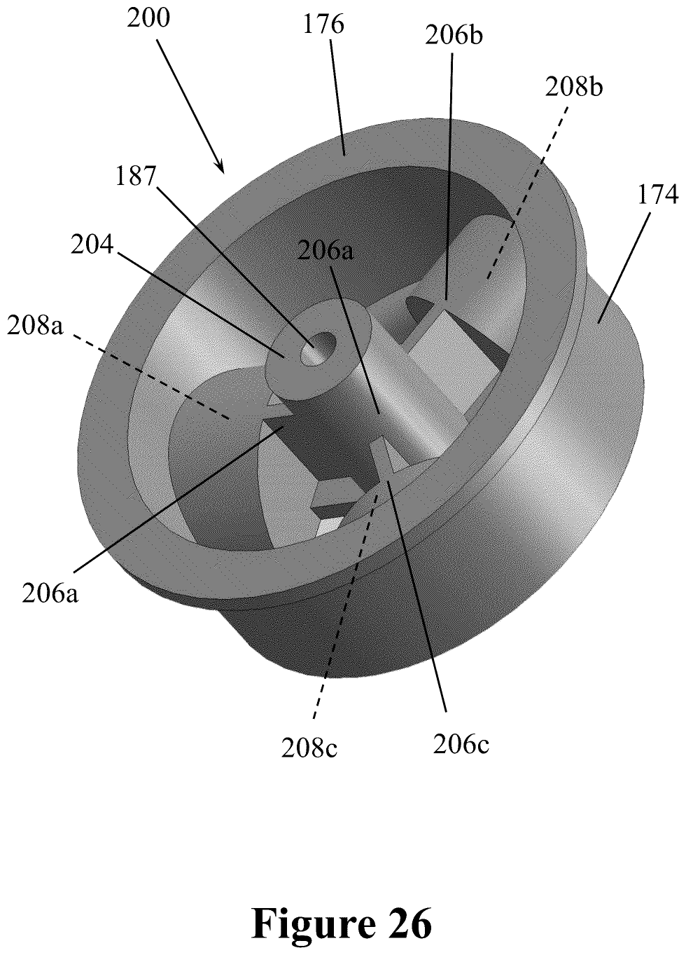

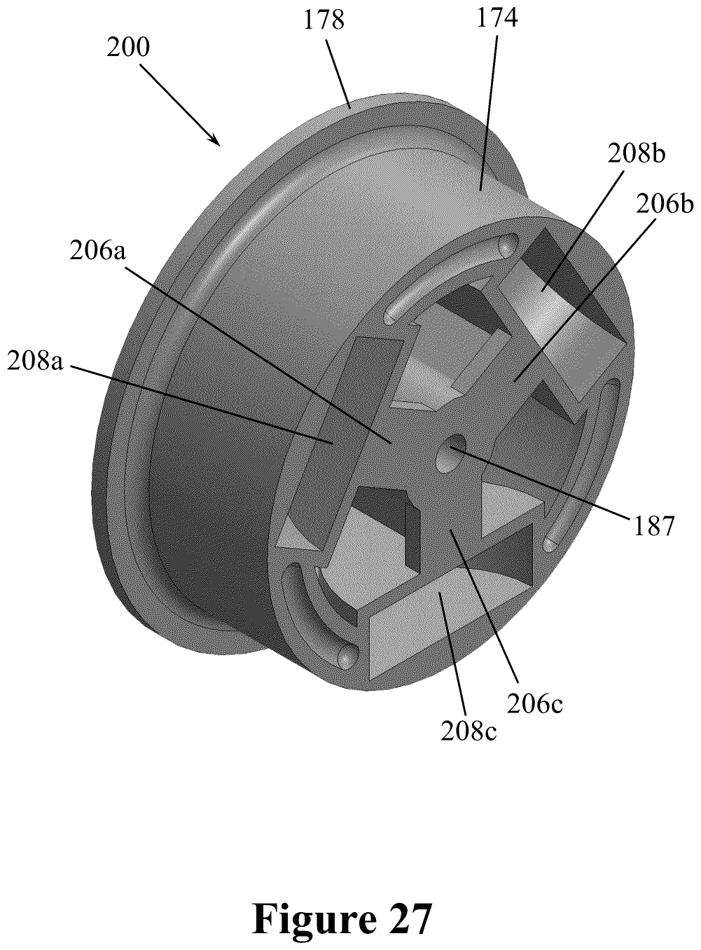

As is shown in FIG. 22, spool 60′ is formed of two halves 200, 202 that can be and preferably are mirror images of one another. The assembled spool 60′ is shown in FIG. 23 and additional views of spool half 200 are shown in FIGS. 24-27. Each spool half 200, 202 has an axially extending cylindrical central hub 204 in which an axle-receiving through-bore 185 is formed. Each half 200, 202 also has a plurality of pairs of radial spokes 206a, 206b, 206c emanating from the hub 204 radially outwardly to a corresponding magnet-holding pocket 208a, 208b, 208c formed in an annular outer rim 210 of the spool 60′, whose exterior defines the outer surface 174 of the spool 60′. Each pocket 208a, 208b, 208c is configured to receive and retain a corresponding disc-shaped magnet 40a, 40b, 40c in a manner that also orients one of its magnetic poles so it faces radially outwardly while also positioning the pole underneath and adjacent the outer surface 174 of the spool 60′.

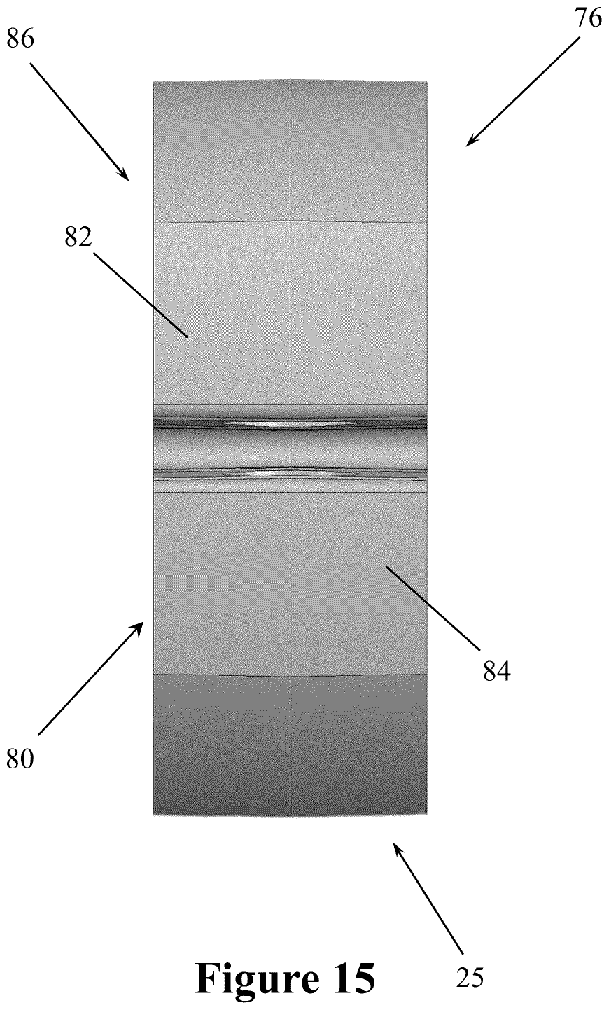

The sensor alarm unit 24′ attached by the mounting arrangement 25′ to the reel 58′ in a manner that positions its sensor 42, preferably TMR sensor 45, in close enough proximity to the outer surface 174 of the spool 60′ to read each magnet 40a, 40b, 40c during rotation of the spool 60′ during use and operation of the fishing reel fishing apparatus 30′. The unit 24′ is constructed and/or configured similar to or substantially the same as the sensing base unit disclosed and shown in FIGS. 15-18 of the '735 patent but has a magnetic sensor 42 that preferably is a TMR magnetic sensor 45. If desired, the internal and electrical components of the unit 24′ can include one or more or all of those of the sensor alarm unit 24 described and shown in FIGS. 1-9 and 18-19 herein.

Each one of the magnets 40a, 40b, 40c preferably is a generally cylindrical disc magnet with the north and south poles of each magnet 40a, 40b, 40c located at opposite axial ends thereof. Each magnet 40a, 40b, 40c is oriented radially relative to the rotational axis 170 of the spool 60′ so as to extend radially outwardly from the axis 170 with one magnetic pole facing toward the axis 170 and its other magnetic pole facing radially outwardly away from the axis 170 towards the outer surface 174 of the spool 60′. The magnets 40a, 40b, 40c can be arranged with the same magnet pole of each magnet 40a, 40b, 40c facing radially outwardly away from the axis 170. If desired, the magnets 40a, 40b, 40c can be arranged with alternating radially outwardly disposed magnetic poles. While the multiple magnet-holding track 165 can be in the form of a non-straight or non-planar, e.g., annular, circular or cylindrical, multiple magnet track 166, such as embodied as a generally cylindrical or circular wheel 168 of a rotary spool 60′ of a fishing reel 58′ configured to hold three equiangularly spaced apart and/or equidistantly circumferentially spaced apart magnets 40a, 40b, 40c, such a magnet-holding track 165 and/or multiple magnet track 166 constructed in accordance with the present invention can be configured to hold more than three magnet sensor trigger magnets if desired. For example, it is contemplated that a magnet-holding track 165 and/or multiple magnet track 166 of the invention can be constructed or configured to hold four, five, six, seven or even more magnets which can be equidistantly, equiangularly and/or uniformly circumferentially spaced apart from or relative to each other.

The track 165 and/or 166 whether flat, planar, circular, cylindrical, wheel-shaped or having another different shape preferably is fixed to or constructed as part of a movable component of a piece of equipment, such as a spool 60′ of a fishing apparatus 30 or 30′, which can be and preferably is part of a reel 58 of an ice fishing tip up 32 or part of a fishing reel 58′, which moves, e.g., rotates, during operation with the track 165 and/or 166 preferably moving substantially in unison with movement of the movable component, e.g., with rotation of the spool 60 or 60′, of the piece of equipment, e.g., fishing apparatus 30 or 30′, e.g., reel 58 of an ice fishing tip up 32 or a fishing reel 58′. The unit 24 or 24′ is carried by, e.g., mounted to, part of the piece of equipment, e.g., fishing apparats 30 or 30′, with its sensor 42, preferably TMR sensor 45, in close proximity to the track 165 and/or track 166 of movable component, e.g., spool 58 or 58′, such that each magnet 30a, 30b, 30c sequentially passing by the sensor 42 during track and movable component movement is at least temporarily in the magnetic field or magnetic flux field of view of the sensor 42. When each magnet 40a, 40b, 40c sequentially comes within the field of view of the sensor 42 during relative movement therebetween, the corresponding magnet 40a, 40b, 40c temporarily is in magnetic field and/or magnetic flux communication with the sensor 42 by its magnetic field and/or flux reaching and preferably passing through the sensor 42 in a manner that at least triggers the sensor 42 as the magnet passes by. In a preferred embodiment and method of operation, each time one of the magnets 40a, 40b, 40c passes by the sensor 42 during rotation of the spool 60 or 60′ during operation of fishing apparatus 30 or 30′, the respective magnet 40a, 40b or 40c passing by triggers the sensor 42 causing the sensor 42 to output a corresponding digital and/or analog signal.

In this way, movement of the movable component of the piece of equipment, preferably movement of movable component, e.g., spool 60 or 60′, of the fishing apparatus 30 or 30′, moves the track 165 and/or 166 and magnets 40a, 40b, 40c carried by the track 165 and/or 166 substantially in unison therewith, with movement of each one of the magnets 40a, 40b, 40c triggering the sensor 42 as the corresponding magnet 40a, 40b, or 40c passes by the sensor 42. The triggering of the magnetic sensor 42 of the unit 24 or 24′ each time a trigger magnet 40a, 40b or 40c passes by the sensor 42 during track 165 and/or 166 and spool 60 or 60′ movement provides an indication of at least one of a change in movable component position, e.g., rotation, rotation angle and/or change in rotation angle of spool 60 or 60′, movable component orientation, e.g., change in orientation of spool 60 or 60′ via determination of change in an angle, such as rotation angle, of the spool 60 or 60′, and/or operational status of the equipment, e.g., detection of rotation of spool 60 or 60′ indicative of a fish strike.

As previously noted, unit 24 or 24′ is mounted to or adjacent a piece of equipment, e.g., fishing apparatus 30 or 30′, with its sensor 42 disposed in close enough proximity to its magnet-holding track 165 and/or 166 of the movable component, e.g., rotating spool 60 or 60′, for the sensor 42 to be at least temporarily in magnetic field or flux communication sequentially with each one of the magnets 40a, 40b, 40c of the track 165 and/or 166 during movement of the movable component, e.g., spool 60 or 60′, carrying or coupled to the track 165 and/or 166. In the specific case of the embodiment shown in FIGS. 20-22, unit 24′ is mounted via mounting arrangement 25′ to a fixed or grounded part of the fishing apparatus 30′ adjacent the track 165 and/or 166 of the rotatable spool 60′ with the sensor 42 of the unit 24′ disposed in close enough proximity to the spool 60′ for the sensor 42 to be at least temporarily in magnetic field or flux communication sequentially with each one of the magnets 40a, 40b, 40c as the respective magnet 40a, 40b, 40c passes by the sensor 42 during spool rotation.

In a preferred embodiment where the piece of equipment is a fishing apparatus 30 or 30′, e.g., ice fishing tip up fishing apparatus 30 or fishing reel fishing apparatus 30′, having a movable component that preferably is a spool 30 of an ice fishing tip up 32 or a spool 30′ of a fishing reel 58′, the triggering of the magnetic sensor 42 of the unit 24 or 24′ each time a trigger magnet, e.g., magnet 40a, 40b and/or 40c, passes by the sensor 42 during movable component movement, e.g. rotation of the spool 60 or 60′, provides an indication of at least one of a change in movable component position, e.g., rotation of spool 60 or 60′, a change in movable component orientation, e.g., a change in orientation or angle of the spool 60 or 60′, a change in an angle or orientation of the fishing line on the spool 60 or 60′, and/or a change in operational status of the equipment, e.g., fishing apparatus 30 or 30′, such as by detecting (a) a fish strike by sensing the start of the unspooling of fishing line from the spool 60 or 60′ of the fishing apparatus 30 or 30′ by detection of the beginning of rotation of the spool 60 or 60′ indicative of a fish strike, (b) an increase in the rate of the fishing line being unspooled from the spool 60 or 60′ by sensing an increase in the rate of rotation or RPMs of the spool 60 or 60′ after detection of a fish strike has occurred, (c) a decrease in the rate of the fishing line being unspooled from the spool 60 or 60′ by sensing a decrease in the rate of rotation or RPMs of the spool 60 or 60′ after detection of a fish strike has occurred and preferably also after detection of a rate of rotation or RPMs of the spool 60 or 60′ has occurred, and (d) a fish dislodging the hook or breaking free of the fishing line by sensing a dramatic decrease in the rate of rotation or RPMs of the spool 60 or 60′ such as by sensing when the rate of rotation or RPMs of the spool 60 or 60′ drops to zero after detection of a fish strike and a rate of rotation or RPMs of the spool 60 or 60′ has occurred.

In one preferred embodiment and method implementation, the unit 24 or 24′, preferably one or both the onboard processor 126 and sensor 42, preferably TMR sensor 45, are configured, such as and/or including in software and/or firmware, to sense not only a beginning of when movement of the movable component of the fishing apparatus 30 or 30′ occurs, preferably by being configured, such as and/or including in software and/or firmware, to magnetically sense magnets 40a, 40b and/or 40c passing by the sensor 42, preferably TMR sensor 45 to detect: (i) a fish strike from a fish taking or striking bait on fishing line cast or unspooled from the spool 60 or 60′ during use and operation of fishing apparatus 30 or 30′ by subsequently sensing or detecting when the spool 60 or 60′ begins rotating after fishing line has been cast or unspooled from the spool 60 or 60′ caused by the fish unspooling more line from the spool 60 or 60′, (ii) unspooling and/or continued unspooling of line from the spool 60 or 60′ occurring after a fish strike has been detected in step (i), (iii) an increase in an unspooling rate that fishing line is being unspooled from the spool 60 or 60′ of the fishing apparatus 30 or 30′, e.g., fishing reel 58′, when a fish that has taken the bait after detection of a fish strike in step (i) is subsequently attempting to swim away or run away and/or fight to take the bait and/or get free of the line, (iv) a decrease in the unspooling rate that fishing line is being unspooled from the spool 60 or 60′ when a fish that has taken the bait after detection of a fish strike in step (i) and was attempting to swim away and/or fight tires or begins to tire from swimming away and/or fighting, and/or (v) the fish dislodging the hook, breaking free of the line, or breaking the line. In each one of (i)-(v) above, the detection of the fish strike in (i) preferably is accomplished by detecting magnets 40a, 40b, 40c beginning to pass by sensor 42, preferably TMR sensor 45, as the spool 60 or 60′ begins rotating (preferably after fishing line has been unspooled from the spool 60 or 60′ during casting) upon a fish taking the bait unspooling line from spool 60 or 60′ causing the spool 60 or 60′ to begin to rotate (or first rotate after casting has occurred), the detection of a spooling rate in (ii) preferably is accomplished by sensing a rate at which magnets 40a, 40b, 40c pass by sensor 42 corresponding to the rate of rotation or RPMs of the spool 60 or 60′ resulting from unspooling of additional line from the spool 60 or 60′ due to the fish swimming away from the fishing apparatus 30 or 30′ after a fish strike has been detected, the detection of an increase in spooling rate in (iii) preferably is accomplished by sensing an increase in the rate at which magnets 40a, 40b, 40c pass by sensor 42 corresponding to an increase in the rate of rotation or RPMs of the spool 60 or 60′ resulting from unspooling of additional line from the spool 60 or 60′ due to the fish swimming away faster from the fishing apparatus 30 or 30′ after a fish strike has been detected in (i) and preferably, but not necessarily, after unspooling of the line has been detected in (ii), the detection of a decrease in spooling rate in (iv) preferably is accomplished by sensing a decrease in the rate at which magnets 40a, 40b, 40c pass by sensor 42 corresponding to a decrease in the rate of rotation or RPMs of the spool 60 or 60′ resulting from unspooling of additional line from the spool 60 or 60′ due to the fish swimming away more slowly from the fishing apparatus 30 or 30′ after a fish strike has been detected in (i), after unspooling of the line has been detected in (ii), and preferably, but not necessarily, after an increase in the spooling rate has been detected in (iii), and the detection of a fish dislodging the hook, breaking free of the line, or breaking the line in (v) preferably is accomplished by sensing a rapid and substantial decrease in the rate of rotation or RPMs of the spool 60 or 60′ below a predetermined threshold decrease in the rate of rotation or RPMs of the spool 60 or 60′ resulting from line no longer being unspooled from the spool 60 or 60′ due to the fish dislodging itself from the hook, the fish breaking free of the line, or the fish breaking the line.

As discussed in more detail below, a preferred unit 24 or 24′ is removably attached to a mount 25 or 25′ that is substantially immovably fixed or anchored to or adjacent a piece of equipment, e.g., fishing apparatus 30 or 30′, which has at least one component, e.g., movable component, whose movement relative to the unit 24 or 24′ is being monitored by the unit 24 or 24′ during equipment use and operation. The mount 25 or 25′ is located relative to the piece of equipment, e.g., fishing apparatus 30 or 30′, to position the magnetic sensor 42, preferably TMR sensor 45, of the unit 24 or 24′ in magnetic field or flux communication of each magnet, e.g., 40a, 40b, 40c, of the track 165 and/or 166 as each magnet passes by the sensor 42 during relative movement between the track 165 and/or 166 and sensor 42 of the unit 24 or 24′, such as during movement of the track 165 and/or 166 relative to the sensor substantially in unison with movement of the movable component, e.g., spool 60 or 60′, of the piece of equipment, e.g., fishing apparatus 30 or 30′. The unit 24 or 24′ preferably is located in close enough proximity relative to part of the piece of equipment, e.g., fishing apparatus 30 or 30′ that positions the magnetic sensor 42, preferably at least a 9 gauss MR sensor, more preferably at least a 30 gauss MR sensor, even more preferably at least a 9 gauss TMR sensor 45 and yet even more preferably at least a 30 gauss TMR sensor, of the unit 24 or 24′ within 1-3 centimeters, preferably within 2-4 centimeters, more preferably within 3-6 centimeters, of at least one magnet, e.g., magnet 38, 38a, 38b, 38c, 40, 40a, 40b, or 40c of at least 30 gauss onboard the fishing apparatus 30 or 30′ so that as relative movement between the sensor 42 of the unit 24 or 24′ and the at least one magnet 38, 38a, 38b, 38c, 40, 40a, 40b, or 40c occurs the sensor 42 will sense the magnetic field or magnetic flux of the at least one magnet 38, 38a, 38b, 38c, 40, 40a, 40b, or 40c. With reference to FIG. 20, the mount 25′ is preferably located in close enough proximity relative to part of the piece of equipment, preferably fishing apparatus 30′, in order to position the sensor 42 of the unit 24′ within 1-3 centimeters, preferably within 2-4 centimeters, more preferably within 3-6 centimeters, of each at least 30 gauss magnet 40a, 40b, 40c of the track 165 and/or 166 of the movable component, preferably rotating spool 60′ of the piece of equipment, preferably fishing apparatus 30′, as each corresponding magnet 40a, 40b or 40c passes closest to the sensor 42 that is at least a 9 gauss MR sensor, preferably at least a 30 gauss MR sensor, and which even more preferably is at least a 9 gauss TMR sensor 45, that preferably is at least a 30 gauss TMR sensor 45, during movement of the track 165 and/or 166 in unison with movement of the movable component, preferably rotating spool 60′, of the piece of equipment, preferably fishing apparatus 30′.

It is an advantage of the present invention that the magnetic sensor trigger magnets 40a, 40b, 40c traveling by the magnetic sensor 42 during movement of the track 165 and/or 166 substantially in unison with movement of the movable component, preferably spool 60′ of the piece of equipment, preferably fishing apparatus 30′, can be sensed by the sensor 42 as each magnet 40a, 40b, 40c sequentially passes by the sensor 42 over a distance of at least one centimeter, preferably at least two centimeters, and more preferably at least three centimeters from the sensor 42 where each magnet 40a, 40b, 40c is a rare earth magnet with a magnetic flux density, preferably residual flux density (Br), of at least 9 gauss and the sensor is at least a 9 gauss MR sensor that preferably is at least a 9 gauss sensor TMR sensor 45. It is a further advantage of the present invention that the trigger magnets 40a, 40b, 40c passing by sensor 42 during movement of the track 165 and/or 166 substantially in unison with movement of the movable component, preferably rotating spool 60′, of the piece of equipment, preferably fishing apparatus 30′, can be sensed by the sensor 42 as each magnet 40a, 40b, 40c passes by the sensor 42 over a distance of at least one centimeter, preferably at least two centimeters, and more preferably at least three centimeters from the sensor 42 where each magnet 40a, 40b, 40c is a rare earth magnet that has a residual flux density or Br of at least 30 gauss and the sensor 42 is at least a 30 gauss MR sensor that preferably is at least a 30 gauss TMR sensor 45. It is yet a further advantage that the sensor 42 can be spaced advantageously at an even greater distance of between 5-10 centimeters from each trigger magnet 40a, 40b, 40c traveling by the sensor 42 during track movement caused by movement of the movable component, preferably rotation of spool 60′, of the piece of equipment, preferably fishing apparatus 30′, where a more powerful magnet is used that preferably is a neodymium magnet, samarium cobalt magnet, or aluminum nickel cobalt magnet having a residual flux density or Br of at least 100 gauss, preferably at least 500 gauss, and more preferably at least 1000 gauss and where the sensor 42 is an MR sensor that preferably is a TMR sensor 45.

In one preferred system and unit 24 are configured for use in a fishing application that is a tip up ice fishing application and have at least one sensing alarm unit of the system configured as a fish strike indicator or fish strike indicator sensing alarm unit adapted for use with a fishing apparatus 30 that is an ice fishing tip up 32 by being configured (a) for mounting thereto, (b) to sense occurrence of a fish strike during fishing use of the tip up, and (c) to provide at least one human perceptible alarm, preferably by outputting one or more of (i) an audible alarm, e.g., sound, tone or siren, and/or (ii) a visual alarm, e.g., LED light, flashing strobe, rotating/flashing beacon, or flashing light, perceptible to a person, e.g., user or fisherman, located within hearing or sight range of the unit 24 and tip up 32. Where the system includes a transportable alarm unit or controller (not shown) that is carried on the person, e.g., user or fisherman, when they are located remotely out of sight and hearing range of the tip up 32 and fish strike indicator unit 24 mounted thereto, the unit 24 is further configured to wirelessly communicate, such as via an RF digital signal, a wireless sensor event alarm message that is a fish strike indicator alarm message to the transportable alarm unit or controller wirelessly paired therewith that causes the transportable alarm unit or controller to provide at least one human perceptible alarm, preferably by outputting one or more of (a) an audible alarm, e.g., sound, tone or siren, (b) a visual alarm, e.g., LED light, flashing strobe, rotating/flashing beacon, or flashing light, and/or (c) a haptic or vibratory alarm, perceptible to the person, e.g., user or fisherman, carrying the transportable alarm unit or controller on their person, such as by being held in their hand, tethered to their wrist, disposed in their clothing, etc. While it is contemplated that a fish strike indicator unit 24 paired for wirelessly communicating with a transportable alarm unit or controller is configured for sensing the occurrence of a fish strike, to cause the transportable alarm unit or controller to output one or more audible, visual, and haptic/vibratory alarms at substantially simultaneously the same time as the unit 24 itself is outputting one or more audible and visual alarms therefrom, the unit 24 can be configured to only cause the transportable alarm unit or controller to output one or more of the audible, visual and haptic/vibratory alarms, such as upon selection of an alarm mode control setting of the unit 24 and/or transportable alarm unit or controller and/or detection of the transportable alarm unit or controller being located a distance from the unit 24 that is greater than a predetermined threshold distance, such as a distance greater than one mile.

In one preferred ice fishing tip up embodiment, the unit 24 is configured for releasable but positively secure mounting to an elongate bendable fish strike indicator flagpole 70 of a standard rail type ice fishing tip up 32 anchored by coil spring 72 at one end to an elongate transversely extending generally planar frame 44 that serves as a generally horizontal base 44 to support the tip up 32 on the ice of a lake or pond during fishing use. Such a standard rail tip-up 32 has a pair of spaced apart generally parallel horizontal support frame rails 46, 48 with an elongate cylindrical tube 54 pivotably mounted therebetween that has a diameter approximately that of a large straw. The tube 54 is pivotable between a generally parallel horizontal storage position where the tube 54 is folded parallel to the frame rails 46, 48 thereby nesting between the frame rails 46, 48, and an ice fishing tip up operating position where the tube 54 is swung out from the base 44 to a 90-degree angle relative to the base 44 forming a T during use.

The tube 54 generally coaxially houses an elongate internal stainless-steel drive shaft 62 that has a free-spinning rotatable spool 60 of a reel 58 carrying fishing line fixed to one end of the shaft 62 for causing the shaft 62 to rotate in unison with the spool 60 when a fish strikes the bait and unspools line from the spool 60 of the submerged reel 58. At the other end of the tube 54 is an elongate generally transversely extending notched spindle bar 64 fixed to the opposite end of the drive shaft 62 that rotates in unison with the shaft 62 and the spool 60 of the reel 58 during unspooling of line from the spool 60 of the reel 58 from a fish strike.

The tip up 32 is armed by bending the flagpole 70 from its generally vertical fish-strike signaling position to a generally horizontal set or fish strike trigger ready position until part of the pole 70 releasably engages the spindle bar 64 by being received in a notch in the spindle bar 64 releasably retaining the pole 70 in the trigger ready position. When a fish strikes by taking the bait in their mouth, it unspools line from the spool 60 of the reel 58 attached to the bait rotating the drive shaft 62 thereby also rotating the spindle bar 64. As the spindle bar 64 turns, it causes the flagpole 70 to disengage from the notch in the spindle bar 64 releasing the pole 70 and a brightly colored fish strike indicator flag 66 attached to the free end of the pole 70. Once released, the flagpole 70 springs back to its original vertical or upright fish-strike signaling position thereby making the flag 66 readily visible for anyone to see.

A magnetic sensor trigger arrangement 35 containing a steady-state source of magnetic flux, preferably a permanent magnet 40, is carried by, preferably mounted to, the tip up base 44 and disposed close enough to the magnetic sensor 42 of the unit 24 carried by the flagpole 70 to be sensed by the sensor 42 when the pole 70 is releasably engaged with the spindle bar 64 in the generally horizontal set or trigger ready position. The magnet 40 is positioned on one of the frame rails 46, 48 of the base 44 close enough to the sensor 42 of the unit 24 such that when the flagpole 70 disengages from the spindle bar 64 due to spindle bar rotation caused by a fish striking the bait, the unit 24 moves substantially in unison with the pole 70 as it springs upwardly rotating the pole 70 away from the trigger magnet and towards the generally vertical fish-strike signaling position.

Although FIG. 1 shows a trigger arrangement 34 with a trigger magnet 38 that is simply a permanent magnet 40 adhesively fixed or attached by one or more fasteners to the upper outer surface 74 of the tip up base 44 with one of its poles facing upwardly away from the base 44 and the other one of its poles facing downwardly towards the base 44, the arrangement 34 can take the form of a housing that is releasably or permanently mounted on the upwardly facing outer surface of the tip up frame or base 44 that contains or carries a magnetic trigger, e.g., trigger magnet 38, which preferably also is a permanent magnet 40. Where the magnetic trigger of the trigger arrangement 34 is a permanent magnet 40, the permanent magnet of a trigger arrangement 34 having a housing carrying the permanent magnet 40 is immovably fixed to an upwardly facing surface 74 of the frame or base 44 of the tip up 32 at a position on the frame or base 44 that locates the magnet 40 adjacent to the unit 24 when the pole 70 of the flag 66 is releasably retained by the spindle bar 64 in the set or fish strike trigger detecting position. Where the magnetic sensor trigger arrangement 35 consists of a permanent magnet 40, the magnet 40 can be circular or cylindrical, rectangular or square in shape or cross-section oriented with one of its magnetic poles facing generally upwardly and the other one of its magnetic poles facing downwardly. The magnet 40 can also be recessed into, countersunk in, embedded in, or even encapsulated within the base or frame 44 of the tip up 32 including by being recessed into one of its frame rails 46, 48.

The unit 24 is configured to be selectively positioned or selectively positionable along the flagpole 70 to which it is releasably mounted to position sensor 42, preferably TMR sensor 45, in close enough proximity to the magnet of the trigger arrangement 34 fixed to the tip up base 44 to detect relative movement therebetween in a direction away from the magnet when a fish strike disengages the flagpole 70 from the spindle bar 64. When the flagpole 70 is in the set or trigger ready position, sensor 42 and unit 24 overlie the magnet and are disposed in close enough proximity thereto such that the magnetic field, flux or flux density reaching the sensor 42 falls below a predetermined threshold field strength, flux, or flux density which causes the sensor 42 to trigger a sensing alarm event interrupt and/or the unit 24 to issue a fish strike sensing alarm event message.

When a fish strikes and causes the flagpole 70 to disengage from the rotating spindle bar 64, the strength of the magnetic field, magnetic flux and/or magnetic flux density reduces as the sensor 42 and unit 24 move with the flagpole 70 vertically away from the magnet until to falls below a threshold field strength, flux or flux density of the sensor that causes a sensing alarm event signal or sensing alarm event interrupt to be issued to or by the processor 126 onboard the unit 24. Occurrence of such a sensing alarm event causes the unit 24 to activate and/or energize one and preferably both of (a) a light, which can be in the form of a light bright enough to be seen for at least 1000 yards, such as a bright flashing strobe, a bright LED light or lamp, or other type of light source, and/or (b) an audio transducer, such as in the form of a loudspeaker, piezoelectric sound transducer, or other type of sound emitting transducer to provide a visually and audibly perceptible fish strike alarm. Occurrence of such a sensing alarm event also causes the unit 24 to wirelessly transmit a sensing alarm event message to the remotely-located user transportable alarm unit or controller causing the transportable alarm unit or controller to activate and/or energize at least one and preferably at least a plurality of (a) a light, such as one or more LEDs, (b) an alarm sound-outputting audio transducer, such as a speaker and/or piezoelectric transducer or actuator, and/or (c) an alarm vibration outputting haptic actuator, such as one or more of a linear resonant actuator (LRA), eccentric rotating mass actuator (ERM), and/or a piezoelectric actuator to provide at least one different type and preferably at least a plurality of different types of fish strike alarm(s) to the user.

As the flagpole 70 and unit 24 move in unison upwardly, the unit 24 moves away from the trigger magnet 38 fixed to the tip up base or frame 44 causing sensor 42, preferably TMR sensor 45, to open or close, depending on its configuration, and signal the processor 126 onboard the unit 24 of the occurrence of a sensing event that is a sensing alarm event. As the sensor 42 moves in unison with the unit 24 and tip up flagpole 70 away from the trigger magnet 38, the magnet's magnetic field strength, magnetic flux, or magnetic flux density decreases until it drops below the predetermined flux threshold or predetermined flux density threshold that triggers the sensor 42, preferably TMR sensor 45, to signal the onboard processor 126 the occurrence of a magnetically triggered sensing alarm event. To facilitate such suitably sensitive sensing of the change in flux or flux density of the trigger magnet 38, preferably the decrease in flux or flux density thereof, which occurs during relative movement between the sensor 45 and magnet 38 caused by them separating from one another during fish-strike indicating flagpole movement, the magnet 38 preferably is mounted to the frame or base 44 of the tip up 32 with one of its poles, such as its north pole or south pole, facing generally toward the sensor 45 and unit 24.

Once such a sensing event occurs that is a sensing alarm event triggered by such a magnetic trigger trigging the sensor 45 of the unit 24 mounted to the tip up flagpole 70, the onboard processor 126 of the unit 24 is configured, such as and/or including in software and/or firmware, to provide a human perceptible alarm in the form of a light or strobe carried by the unit 24 that is energized by the unit 24. Such a unit 24 adapted for tip up use is further configured in firmware and/or software to wirelessly send a sensing event message that is a sensing alarm event message to a hand-held manually operable transportable user alarm unit or controller wirelessly paired therewith thereby causing the transportable alarm unit or controller to output a human perceptible alarm in the form of one or more of emit an audible tone, energize one or more lights, e.g., LED(S), and/or output a haptic alarm, such as in the form of a vibratory alarm that vibrates the transportable user alarm unit or controller. Because the unit 24 and transportable user alarm unit or controller are configured for wireless communication, preferably bidirectional wireless communication, therebetween over distances of at least one half mile, preferably at least one mile, and more preferably at least one and a half miles, the transportable user alarm unit or controller is configured to provide at least a plurality, preferably a plurality of pairs of audible, light and haptic alarms substantially simultaneously upon receiving a wireless sensing event message from the unit 24 that is a wireless sensing alarm event message.

When the flagpole 70 is reengaged with the releasable tip up trigger mechanism by bending the pole 70 about its coil spring 72 anchored to the tip up frame or base 44 until the pole 70 is generally horizontal and releasably retained in this position by the spindle bar 64, the magnetic flux or flux density of the magnetic field lines of the trigger magnet 38 are sensed by the sensor 45 thereby resetting and/or rearming the unit 24 readying the unit 24 to sense another magnetically triggered fish strike sensing event. The unit 24 and/or transportable user alarm unit or controller can be configured so that a control, setting or input of one or both is operated when the sensor 45 of the unit 24 on the vertically oriented fish-strike indicating flag 66 and flagpole 70 is returned to the generally horizontal fish strike detecting or triggering position thereby resetting the unit 24 so it will output a fish strike sensing event message upon the occurrence of the next flagpole disengaging fish strike.

In a preferred embodiment where the onboard magnetic sensor is a TMR sensor 45, the processor 126 and/or TMR sensor 45 can be configured in firmware and/or software to detect or determine an angle using the TMR sensor 45 and preferably also the unit 24 relative to a generally vertical orientation of the magnetic field or flux lines of the trigger magnet 38 by virtue of the magnet 38 being fixed to the tip up base or frame 44 with one of its north pole and south pole facing generally upwardly generally perpendicular to the generally horizontal base or frame 44 away from the base or frame 44 and the other one of its north pole and south pole facing generally downwardly generally perpendicular to the generally horizontal base or frame 44 towards the base or frame 44. When flagpole 70 is released upon occurrence of a fish strike, as the pole 70 moves from a generally horizontal orientation towards a generally vertical orientation, it moves the unit 24 and its sensor 45 in the same direction. As the sensor 45 moves away from the magnet 38 from a generally horizontal orientation towards a generally vertical orientation, the sensed flux density or sensed magnetic field strength emanated by the magnet 38 decreases in a manner sensed by the sensor 45 that not only corresponds with the sensor 45 and unit 24 moving away from the magnet 38 but also the change in angle of the sensor 45 and unit 24 relative to the magnet 38. In a preferred embodiment, as the flagpole 70 moves the unit 24 and sensor 45 away from the magnet 38, the magnitude of the magnetic field or flux sensed by the sensor 45 decreases proportionally to the distance the magnet 38 is spaced from the sensor 45 thereby enabling a magnet-to-sensor distance measurement to be obtained during fishing apparatus operation.

In one such preferred sensing alarm unit embodiment, the processor 126 and/or sensor 42, preferably TMR sensor 45, onboard the unit 24 operatively communicates with one or more motion sensors 136, e.g. one or more of an angle, position, or orientation sensor 139, onboard the unit 24 that is configured to sense a change in one or more of an angle, a position, or an orientation of the unit 24 and/or sensor 42 onboard the unit 24. Where equipped with one or more such motion sensors 136 configured to sense one or more of a change in angle, a position, or an orientation of the unit 24 during use and operation of the unit 24 and fishing apparatus 30 or 30′, the processor 126 of the unit 24 can be configured, including in software and/or firmware, to (a) reset the unit 24 readying it for fish strike detection when the flagpole 70 and unit 24 are generally horizontally disposed when the pole 70 is releasably retained by engagement with the spindle bar 64 orienting the pole 70 and unit 24 in the generally horizontal “armed” position as sensed by sensor 136 detecting a change in angle of the unit 24 that orients the unit 24 in a generally horizontal orientation, and/or (b) detect occurrence of a fish strike by the sensor 136 detecting a change in angle, change in angular acceleration, change in orientation and/or change in position upon disengagement of the flagpole 70 from the spindle bar 64 upon occurrence of a fish strike.

In a preferred embodiment, the presence of one or more motion sensors 136 onboard the unit 24 provides a double-check or confirmatory determination of the occurrence of a fish strike by providing the onboard processor 126 with an indication, e.g., interrupt or signal, of a change in angle, position or orientation of the at least one sensor 136 and unit 24 substantially simultaneously with the magnetic sensor 42, preferably TMR sensor 45, providing an indication, e.g., interrupt or signal, to the processor 126 of a sensed drop in magnetic field, magnetic flux, or magnetic flux density strength due to sensor 42, preferably TMR sensor 45, and unit 24 moving away from the trigger magnet 38 of the sensor trigger arrangement 34 fixed to the tip up frame or base 44. Where equipped with one or more motion sensors 136 onboard the unit 24, such sensor(s) 136 include at least one and preferably at least a plurality of an onboard inclinometer, an angle sensor, e.g., piezoelectric “driftless” angle sensor, an accelerometer, such as a piezoelectric accelerometer, a piezoresistance accelerometer, or a capacitive accelerometer that can be of 3-axis accelerometer construction, an angular rate sensor, such as a piezoelectric angular rate sensor or a microelectromechanical systems or MEMS angular rate sensor, a gyro or gyroscope, such as a fiber optic or FOG gyro, a ring laser gyro, a nanophotonic optical gyroscope, a tunneling magneto-resistive micro-gyroscope, or a vibrating beam micro/nano gyroscope, and/or an inertial measurement unit (IMU), such as a multi-axis IMU, which preferably is an at least a 3-axis IMU and more preferably is at least a 6-axis IMU, to sense, determine, or obtain an angular orientation, preferably angle of inclination of the unit 24 and flagpole 70 as the flagpole 70 is moved relative to the generally horizontal tip up frame or base 44 from a generally vertical triggered position to a generally horizontal ready to trigger position where the pole 70 is engaged with the cross bar 64 to automatically confirm resetting of the unit 24 to a ready to trigger position where the unit 24 is ready to detect occurrence of another fish strike event using the tip up 32.

In another preferred embodiment, no magnet is needed nor used as the unit 24 instead relies on at least one motion sensor 136 carried by and preferably disposed onboard the unit 24 that preferably is at least one of an inclinometer, an angle sensor, an angular rate sensor, a gyro or gyroscope, and/or a multi-axis IMU, preferably at least a 3-axis IMU, more preferably 6-axis or 12-axis IMU, located carried by the unit 24, preferably disposed inside or onboard the unit 24, that communicates with processor 126 configured in firmware or software to sense a fish strike by sensing (a) release of the flagpole 70 from the spindle bar or cross bar 64 rotating free of engagement with the pole 70 during a fish strike, and/or (b) the rapid rotation of the flagpole 70 and unit 24 carried by the flagpole 70 about spring 72 as the released pole 70 springs from the generally horizontal set or trigger ready position to the vertical or upright fish strike indicator position. In such a preferred embodiment, the sensor 136 is an internal or onboard inclinometer, angle sensor, angular rate sensor, gyro or gyroscope, and/or multi-axis IMU disposed with a sensing axis thereof oriented relative to the flagpole 70, more preferably relative to a central longitudinal axis of the pole 70, in a manner that enables sensing of the change in angle of the flagpole 70 and unit 24 carried thereby, rate of change in angle of the flagpole 70 and unit 24 carried thereby, and/or angular acceleration of the rotation of the flagpole 70 and unit 24 carried thereby, as the spring-loaded or spring-mounted flagpole 70 rapidly springs from the horizontal set or trigger ready position to the upright or vertical fish strike indicator position.

In a preferred embodiment, the sensing axis of sensor 136 is generally parallel to the central longitudinal axis of the flagpole 70. In such a preferred embodiment, when the unit 24 is releasably mounted to the flagpole 70, like in the manner depicted in FIGS. 1-5, mounting of the unit 24 with its longitudinal extent generally parallel to the central longitudinal axis of the flagpole 70 orients the sensing axis of the sensor 136 generally parallel to the central longitudinal axis of the flagpole 70.

In another preferred embodiment, the sensing axis of the sensor 136 is generally perpendicular or transverse to the central longitudinal axis of pole 70. In such another preferred embodiment, when the unit 24 is releasably mounted to the flagpole 70, like in the manner depicted in FIGS. 1-5, mounting of the unit 24 with its longitudinal extent generally parallel to the central longitudinal axis of the flagpole 70 orients the sensing axis of the sensor 136 generally transverse or perpendicular to the central longitudinal axis of the flagpole 70.

In such a preferred embodiment, one or both of the (a) at least one motion sensor 136, e.g., at least one inclinometer, angle sensor, angular rate sensor, gyro or gyroscope, and/or multi-axis IMU, and (b) onboard processor 126 are configured, such as and/or including in software and/or firmware, to sense one of a (a) change in angle of the fish-strike released moving flagpole 70 and the unit 24 carried by the flagpole 70 as the flagpole 70 and unit 24 carried by the flagpole 70 moves from the generally horizontal set or fish strike trigger ready position to or toward the generally vertical fish strike indicating position, (b) rate of change in angle of the fish-strike released moving flagpole 70 and unit 24 carried by the flagpole 70 as the flagpole 70 and unit 24 carried by the flagpole 70 moves from the set or fish strike trigger ready position to or toward the fish strike indicating position, (c) the angular acceleration of the fish-strike released moving flagpole 70 and unit 24 carried thereby as the flagpole 70 and unit 24 carried by thereby moves from the set or fish strike trigger ready position to or toward the fish strike indicating position, and/or (d) the rate of change in the angular acceleration of the fish-strike released moving flagpole 70 and unit 24 carried thereby as the flagpole 70 and unit 24 carried thereby moves from the set or fish strike trigger ready position to or toward the fish strike indicating position. In at least one such preferred embodiment, the at least one motion sensor 136 carried by and preferably disposed onboard the unit 24, preferably one or more of an internal or onboard inclinometer, angle sensor, angular rate sensor, gyro or gyroscope, and/or multi-axis IMU with the sensor 136 disposed with a sensing axis thereof oriented relative to the flagpole 70, more preferably relative to a central longitudinal axis of the pole 70, in a manner that enables sensing of the change in angle, rate of change in angle, and/or angular acceleration of the rotation of the flagpole 70, and unit 24 carried by the pole 70, after or upon disengagement from the spindle bar 64 due to rotation of the spindle bar 64 caused by a fish strike, as the spring-loaded or spring-mounted flagpole 70, and unit 24 carried by the pole 70, rapidly springs from the horizontal set or trigger ready position shown in FIGS. 1-5 to the upright or vertical fish strike indicator position where the pole 70 extends upright generally vertically from and relative to the tip up base or frame 44. In such a preferred embodiment, one or both of the (a) onboard processor 126 and (b) sensor 163, e.g., inclinometer, angle sensor, angular rate sensor, gyro or gyroscope, and/or multi-axis IMU, are configured, preferably including in firmware and/or software, to sense one of (a) a change in angle of the fish-strike released moving flagpole 70 by sensing the change in angle of the unit 24 mounted to the flagpole 70 of or along an axis of the unit 24 generally parallel to the central longitudinal axis of the flagpole 70, (b) a rate of change in angle of the fish-strike released moving flagpole 70 by sensing a rate of change in angle of the unit 70 mounted to the flagpole 70 of or along an axis of the unit 24 generally parallel to the central longitudinal axis of the flagpole 70, (c) an angular acceleration of the fish-strike released moving flagpole 70 by sensing a rate of change in angle of the unit 24 mounted to the flagpole 70 of or along an axis of the unit 24 generally parallel to the central longitudinal axis of the flagpole 70, and/or (d) a rate of change in the angular acceleration of the fish-strike released moving flagpole 70 by sensing a rate of change in angle of the unit 24 mounted to the flagpole 70 of or along an axis of the unit 24 generally parallel to the central longitudinal axis of the flagpole 70.

In a preferred embodiment, a sensing axis of the sensor 136 of the unit 24 is the sensing axis of the unit 24 and is generally parallel to the central longitudinal axis of the flagpole 70. In such a preferred embodiment, when the unit 24 is releasably mounted to the flagpole 70, like in the manner depicted in FIGS. 1-5, mounting of the unit 24 with its longitudinal extent generally parallel to the central longitudinal axis of the flagpole 70 orients the sensing axis of the sensor 136 generally parallel to the central longitudinal axis of the flagpole 70.

In another preferred embodiment, the sensing axis of the sensor 136 is the sensing axis of the unit 24 and is generally perpendicular or transverse to the central longitudinal axis of pole 70. In such another preferred embodiment, when the unit 24 is releasably mounted to the flagpole 70, like in the manner depicted in FIGS. 1-5, mounting of the unit 24 with its longitudinal extent generally parallel to the central longitudinal axis of the flagpole 70 orients the sensing axis of the sensor 136 generally transverse or perpendicular to the central longitudinal axis of the flagpole 70.

A preferred embodiment of the unit 24 or 24′ is configured and/or configurable, such as and/or including in software and/or firmware, to provide or operate as a fish strike indicator 95 or 95′ with sensor 42, preferably TMR sensor 45, onboard the unit 24 or 24′ configured to sense one or more of (a) a magnetic field, magnetic flux, or magnetic flux density of a magnetic field source that preferably is a source of a steady-state magnetic field, which more preferably is provided by at least one sensor trigger magnet 38 that preferably is at least one permanent magnet 40, (b) a strength or magnitude of the magnetic field, magnetic flux or magnetic flux density of the magnetic field source that preferably is a steady-state magnetic field source provided by at least one trigger magnet 38, which more preferably is at least one permanent magnet 40, and/or (c) a change in the strength or magnitude of the magnetic field, magnetic flux or magnetic flux density of the magnetic field source that preferably is a steady-state magnetic field source provided by at least one trigger magnet 38, which more preferably is provided by at least one permanent magnet 40, and provide an indication of a fish strike, such as in the form of an audible, visible, or haptic, e.g., vibratory, user perceptible or detectable feedback, preferably by sensing a rotation of a part or movable component of a fishing apparatus 30 or 30′ by sensing rotation of a fishing-line carrying spool 60 or 60′ of the apparatus 30 or 30′. Such a unit 24 or 24′ configured as a fish strike indicator 95 or 95′ of the present invention is configured to determine an occurrence of a fish strike of a fishing apparatus 30 or 30′ by detecting rotation of one or more components of the fishing apparatus 30 or 30′ preferably by detecting rotation of a spool 60 or 60′ of the fishing apparatus 30 or 30′. The apparatus 30 or 30′ can be a fishing apparatus 30 that preferably is a ice fishing tip up 32 equipped with a fishing line carrying rotary spool 60 of a reel 58 of the tip up 32. The apparatus 30 or 30′ can also be a fishing apparatus 30′ that is a non-ice fishing reel 58′ that preferably is a casting reel, such as a baitcasting recl, a spincast reel or a spinning reel, a conventional reel or a trolling reel, an offshore reel, a surf reel, a bank fishing reel, a rattle reel, a fly-fishing reel, and/or a centerpin reel or a centrepin reel. It is also contemplated as being within the scope of the present invention to provide a unit 24 or 24′ that is a fish strike indicator 95 or 95′ and/or otherwise configured, including as discussed hereinabove, to provide an indication of a fish strike and which is further configured to determine an occurrence of a fish strike by detecting rotation of one or more of (a) a rotor, bail, handle, line spool and/or one or more internal gears that operatively couple the handle to the rotor and/or to the spool of a spincasting fishing reel, (b) a handle, drive gear, drive shaft, pinion gear, main shaft, line guide and/or spool of a baitcasting fishing reel, (c) a spool, spool cover, and/or gearing of a fly reel, and/or (d) the spindle bar, drive shaft and/or spool 60 of a tip up ice fishing reel 58.

With reference once again to FIGS. 28 and 29, the unit 24 is releasably mounted by the clamp 80 of the mounting arrangement 28 to a movable component of a fishing apparatus 30, such as a tip up 32, which is a rotary component of the apparatus 30, such as the drive shaft 62 and/or crossbar 64 of the tip up 32, which rotates during fishing apparatus operation, such as when a fish strikes. In the preferred embodiment and implementation depicted in FIGS. 28 and 29, the unit 24 is mounted by the clamp 80 of its mounting arrangement 25 to the part of segment 61 of the rotary drive shaft 62 of the rotary reel and drive assembly 55 of a tip up 32 that extends outwardly from tube 54, e.g., driveshaft rotation guide/bearing sleeve 53, of the assembly 55. The unit 24 is mounted to the rotary drive shaft segment 61 by the clamp 80 in a manner that causes the unit 24 to rotate substantially in unison with rotation of the drive shaft 62 caused by a fish striking and taking the bait attached to fishing line attached to the spool 60 at the opposite end of the drive shaft 62.

As previously discussed, unit 24 has at least one and preferably a plurality of onboard motion sensors 136 carried by, mounted to, or disposed inside the unit 24. In the preferred embodiment of unit 24 shown in FIGS. 18 and 19, there is at least one motion sensor 136 mounted to circuit board 33 disposed within the housing 78 of the unit 24. If desired, a second motion sensor 136 can be carried by, mounted to, or disposed inside unit 24. The at least one sensor 136 preferably is a motion sensor configured to sense or detect one of movement of the sensor 136 and/or unit 24, change in movement of sensor 136 and/or unit 24, rotation of sensor 136 and/or unit 24, change in rotation of sensor 136 and/or unit 24, a rotation angle of sensor 136 and/or unit 24, and/or a change in rotation angle of sensor 136 and/or unit 24 to thereby enable rotation of the shaft 62 to be detected or sensed thereby when a fish strikes. At least one sensor 136 of unit 24 is arranged with a sensing axis configured or oriented relative to the longitudinally extending axis about which the drive shaft 62 rotates during a fish strike that enables sensor 136 to sense or detect rotation of the drive shaft 62 when a fish strikes.

The unit 24 or 24′ is configured for use with a fishing apparatus, such as preferably an ice fishing tip up or a rod and reel, where the unit is configured for monitoring one or more parameters pertaining to operation of the fishing apparatus and providing feedback to a user upon occurrence of one or more events, such as a fish strike, a fish running with bait, a fish slowing upon tiring after running with bait, a fish disengaging from the bait or breaking fishing line attached to the bait, and/or another type of predetermined known fishing apparatus operational event which can occur during fishing apparatus operation. The sensing unit can be and preferably includes one or more onboard components and/or an arrangement for outputting a human perceptible, such as an audible, visible, tactile, vibratory, etc., feedback, such as in the form of an alarm, and one or more components and/or an arrangement for wirelessly communicating with one or more other units and/or a transportable portable hand-held controller and/or user alarm unit of an alarm system of the present invention.

A unit configured for monitoring one or more parameters of operation of a fishing apparatus, has one or more sensors each configured to sense a value, magnitude, threshold, and/or range of or pertaining to one or more of the operational parameters during apparatus operation, and has a processor in communication with each sensor and which is configured for providing user feedback in the form of one or more alarms upon the one or more sensors sensing a predetermined value, a predetermined magnitude, a predetermined threshold and/or a predetermined range of or pertaining to one or more of the monitored operational parameters, such as movement or operation of one or more components of the apparatus, indicative of one of the events occurring, and providing a corresponding alarm to the user.

In a preferred embodiment, the at least one sensor is a magnetic sensor disposed onboard the unit which can be a Hall sensor, but which preferably is an MR sensor that preferably is a TMR sensor. The unit can be equipped with a plurality of magnetic sensors, preferably spaced apart from each other, if desired. In another preferred embodiment, the at least one sensor is a motion sensor, such as at least one of a tilt sensor, inclinometer, accelerometer, a gyro, an angular rate sensor, a magnetometer, an IMU, or a HRU. The unit can be equipped with a plurality of motion sensors, preferably spaced apart from each other, if desired. In at least one embodiment, the unit is equipped with at least one magnetic sensor and at least one motion sensor. In at least one other embodiment, the unit is equipped with a plurality of spaced apart magnetic sensors and a plurality of spaced apart motion sensors.

In a preferred embodiment, the fishing apparatus is equipped with a pole, a rotary shaft, and a reel assembly with a spool having fishing line spooled thereon, and the sensing alarm unit is configured to monitor fishing apparatus operation using at least one sensor configured to detect movement of at least one component of the apparatus, such as a rod of pole of the apparatus, a rotary shaft, e.g., rotary drive shaft, of the apparatus, and/or a reel assembly, such as preferably a fishing line carrying spool of the reel assembly, of the apparatus which is indicative of a fishing-related event occurring, such as (a) movement of the pole or rod upon occurrence of a fish strike, (b) rotation of the rotary shaft upon occurrence of (i) a fish strike, (ii) a fish running with bait after a fish strike, (iii) a fish tiring and slowing down, and/or (iv) a fish disengaging from the bait, e.g. detaching from a hook or the like carrying the bait, or breaking the fishing line to which the bait is attached, e.g., by a hook or the like, and/or (c) rotation of the spool upon occurrence of (i) a fish striking bait attached to fishing line from the spool of the reel assembly, (ii) a fish running with the bait after striking the bait, (iii) a fish becoming tired after running with the bait, and/or (iv) a fish disengaging from the bait, e.g., detaching from the hook, or breaking the line extending from the spool. Such a fishing apparatus equipped with a reel assembly can be an ice fishing tip up or a rod and reel, which can be a spinning rod and/or reel, a casting rod, a baitcasting rod and/or reel, a spin-casting rod or reel, a fly rod and/or reel, a trolling rod and/or reel, a surf rod and/or reel, an offshore rod and/or reel or another type of fishing rod and/or reel.

In one such preferred embodiment, the fishing apparatus is an ice fishing apparatus, preferably a tip up, which has a reel assembly equipped with (a) a rotary spool carrying fishing line to which hook-containing or hook-carrying bait is attached, e.g., via a hook, which is initially unspooled from the spool into the water during casting of the bait into the water to seck to entice a fish to take the bait with the spool monitored by the unit by sensing with at least one sensor when the spool: (i) rotates, e.g., begins rotating, after casting when additional line is unspooled from the spool when a fish strikes upon taking the bait attached to the line, (ii) rotates faster after a fish strike has been detected when the fish fights and/or runs with the bait unspooling more line from the from the spool, (iii) rotates slower when the fish tires or slows down after a fish strike has been detected and/or after it has been detected that the fish has run with the bait, and/or (iv) stops rotating after a fish strike has been detected when the fish disengages from the bait and/or breaks the fishing line; and (b) a rotary drive shaft in operable cooperation with the spool, preferably coupled to the spool, which rotates with the spool as fishing line is unspooled from the spool which is monitored by the unit by sensing with at least one sensor when the shaft: (i) rotates or begins rotating when a fish has taken bait attached to the line causing more line to be unspooled after the spool after initial casting thereby indicating that a fish strike has occurred, (ii) rotates faster after a fish strike has been detected when the fish fights and/or runs with the bait as more line is unspooled from the from the spool, (iii) rotates slower as the rate of line spooling from the spool decreases as the fish tires or slows down after a fish strike has been detected and/or after it has been detected that the fish has run with the bait, and/or (iv) stops rotating after a fish strike has been detected when the fish disengages from the bait and/or breaks the fishing line.

In a preferred tip up embodiment, the rotary drive shaft is connected to the spool in a manner such that rotation of the spool rotates the shaft preferably in unison therewith. In one such preferred embodiment, the unit is equipped with at least one sensor that is a magnetic sensor, preferably a TMR sensor, configured to sense a magnetic field or magnetic flux of at least one source of a magnetic field or magnetic flux, each of which preferably is a permanent magnet, operatively connected to or operatively coupled with either or both the spool and/or the rotary drive shaft for movement of the magnetic field or magnetic flux source substantially in unison therewith. In a preferred embodiment, at least one magnet is carried by the shaft and/or the spool for rotation in unison therewith during fishing operation of the tip up.

The unit is configured to be mounted to the tip up in a manner that positions the at least one magnetic sensor in close enough proximity, i.e., sensing proximity, to the at least one source of magnetic field or magnetic flux, preferably magnet, carried by the shaft or spool in order to sense a magnetic field or magnetic flux of the magnet, preferably a change in a magnetic field of the magnet, and/or preferably a change in a magnetic flux of the magnet indicative of movement, preferably rotation, e.g., change in angle, preferably rotational angle, of the shaft or spool. The at least one magnetic sensor and/or the processor of the unit is or are configured, such as and/or including in software and/or firmware, to detect the occurrence of a fish strike by monitoring for the occurrence of movement, e.g., start of movement, such as preferably in the form of rotation, e.g., start of rotation, of the shaft or spool by the at least one magnetic sensor sensing the magnetic field, preferably a change in the magnetic field, or the magnetic flux, preferably a change in the magnetic flux, of the magnet that occurs when the magnet begins to move or rotate in response to the shaft or spool beginning to move, preferably beginning to rotate, after casting has taken place.

The processor and/or the at least one magnetic sensor of the unit is or are also configured, such as and/or including in software and/or firmware, to detect if a fish that has taken the bait is running with the bait, e.g., fighting, by monitoring for movement, preferably rotation, of the shaft or spool occurring after a fish strike has been detected by the at least one magnetic sensor sensing the magnetic field, preferably a change in the magnetic field, or the magnetic flux, preferably a change in the magnetic flux, of the magnet indicative of movement, preferably additional movement, more preferably rotation, even more preferably additional rotation, of the shaft or spool occurring that is indicative of the fish running with the bait. In a preferred embodiment and implementation of a method of operation, the processor and/or the at least one magnetic sensor of the unit is or are preferably configured, such as and/or including in software and/or firmware, to detect if a fish is running with the bait by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor due to movement of the shaft or spool of the apparatus from which an angle, e.g., change in angle, a rotational angle, a change in rotational angle, an increase in rotation, an increase in the rate of rotation, an increase in an angular velocity, an increase in angular acceleration, a jerk factor, an increase in the rate or speed of rotation, an increase in rotations per unit time, e.g., increase in revolutions per minute (RPMs), of the shaft or spool is determined or obtained that is indicative of a fish running with the bait. The processor and/or the at least one magnetic sensor preferably is or are configured to begin monitoring for the occurrence of a fish running with the bait only after a fish strike has been detected.

The processor and/or the at least one magnetic sensor of the unit preferably is or are further configured, such as and/or including in software and/or firmware, to detect if a fish is slowing down how fast it is running with the bait, e.g., tiring, by monitoring for movement, preferably rotation, of the shaft or spool occurring by the at least one magnetic sensor sensing the magnetic field, preferably a change in the magnetic field, or the magnetic flux, preferably a change in the magnetic flux, of the magnet indicative of movement, preferably reduced movement or a reduction in movement, more preferably rotation, even more preferably reduced rotation or a reduction of rotation, of the shaft or spool occurring during fishing apparatus operation. In a preferred embodiment and method implementation, the processor and/or the at least one magnetic sensor of the unit is or are also configured to detect if a fish slowing how fast it is running with the bait by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor caused by movement of the shaft or spool from which an angle, e.g., change in angle, a rotational angle, a change in rotational angle, a decrease in rotation, a decrease in the rate of rotation, a decrease in an angular velocity, a decrease in angular acceleration, a jerk factor, a decrease in the rate or speed of rotation, a decrease in rotations per unit time, e.g., decrease in revolutions per minute (RPMs), of the shaft or spool is determined or obtained that is indicative of a fish slowing in how fast it is running with the bait. The processor and/or the at least one magnetic sensor preferably is or are configured to begin monitoring for the occurrence of a fish slowing in how fast it is running with the bait after a fish strike has been detected and/or after a fish running with the bait has been detected. In a preferred embodiment, the processor and/or the at least one magnetic sensor preferably is or are configured to begin monitoring for the occurrence of a fish slowing in how fast it is running with the bait only after a fish strike has first been detected and after a fish running with the bait has also been detected.

The processor and/or the at least one magnetic sensor of the unit preferably is or are further configured, such as and/or including in software and/or firmware, to detect if a fish has disengaged or detached from the fishing line attached to the spool, e.g., thrown the hook, detached from the bait or broken the line, by monitoring for movement, preferably rotation, of the shaft or spool occurring by the at least one magnetic sensor sensing the magnetic field, preferably a change in the magnetic field, or the magnetic flux, preferably a change in the magnetic flux, of the magnet indicative of movement, preferably of significantly reduced movement such as preferably a stoppage or cessation of movement, more preferably of rotation, even more preferably of significantly reduced rotation such as preferably a stoppage or cessation of rotation, of the shaft or spool occurring during fishing apparatus operation. In a preferred embodiment and method implementation, the processor and/or the at least one magnetic sensor of the unit is or are also configured to detect if a fish has disengaged or detached from the line by the at least one magnetic sensor sensing a change in the magnetic field, such as a change in the rate of change of the magnetic field, a change in the magnetic flux, such as a change in the rate of change of the magnetic flux, of the magnet moving relative to the at least one magnet sensor corresponding to movement of the shaft or spool during fishing apparatus operation from which an angle, e.g., change in angle, such as where there is no change in angle, a rotational angle, a change in rotational angle, such as where there is no change in rotational angle, a significant decrease in rotation, such as a cessation or stopping of rotation, a decrease, preferably significant decrease, in the rate of rotation, such as the rate of rotation rapidly dropping to a level close to zero, about zero, or becoming zero, a significant decrease in an angular velocity, such as the angular velocity dropping to a level close to zero or zero, a decrease in angular acceleration, such as the angular acceleration dropping to close to zero, about zero, or becoming zero, a jerk factor, such as the jerk factor dropping to zero, a decrease in the rate or speed of rotation, such as dropping to about zero or becoming zero, a decrease in rotations per unit time, e.g., decrease in revolutions per minute (RPMs), such as dropping to about zero or zero rotations per unit time, e.g., decreasing in RPMs to about zero or zero, of the shaft or spool is determined or obtained that is indicative of a fish having disengaged or detached from the line. In a preferred embodiment and method implementation, a fish disengaging or detaching from the line is detected upon occurrence of where there is no change in angle of the shaft or spool for at least one half second, at least one second, at least a plurality of seconds, or even at least a plurality of pairs of, i.e., at least three, seconds, where there is no change in rotational angle for at least one-half second, at least one second, at least a plurality of seconds, or at least a plurality of pairs of, i.e., at least three, seconds, where there is a cessation or stopping of rotation for at least one-half second, at least one second, a plurality of seconds, or even a plurality of pairs of, i.e., at least three, seconds, where the rate of rotation drops to about zero or zero for at least one-half second, at least one second, at least a plurality of seconds, or even at least a plurality of pairs of, i.e., at least three, seconds, where the angular velocity drops to a level of about zero or zero for at least one-half second, at least one second, at least a plurality of seconds, or even at least a plurality of pairs of, i.e., at least three, seconds, where the angular acceleration drops to about zero or zero for at least one-half second, at least one second, at least a plurality of seconds, or even at least a plurality of pairs of, i.e., at least three, seconds, where the jerk factor drops to zero for at least one-half, at least one second, at least a plurality of seconds, or at least a plurality of pairs of, i.e., at least three, seconds, a decrease in the rate or speed of rotation, such as dropping to about zero or zero for at least one-half, at least one second, at least a plurality of seconds, or at least a plurality of pairs of, i.e., at least three, seconds, a decrease in rotations per unit time, e.g., decrease in revolutions per minute (RPMs), such as dropping to about zero or zero rotations per unit time, e.g., decreasing in RPMs to about zero or zero, for at least one-half second, at least one second, at least a plurality of pairs of seconds, or even at least a plurality of pairs of seconds. The processor and/or the at least one magnetic sensor preferably is or are configured to begin monitoring for the occurrence of a fish disengaging or detaching from the line after casting and after a fish strike has been detected. If desired, the processor and/or the at least one magnetic sensor can be configured to begin monitoring for the occurrence of a fish disengaging or detaching from the line after casting, after a fish strike has first been detected, after a fish running with the bait has also been detected and/or after a fish has slowed in running with the bait.

In a preferred embodiment, the spool and/or the shaft of the fishing apparatus, preferably tip up, carries at least a plurality and preferably carries at least a plurality of pairs of, i.e., at least three, magnets which are preferably are equidistantly and/or equiangularly spaced apart from each other and/or from or relative to an axis of rotation of the spool and/or the shaft. In one preferred embodiment, there are at least a plurality of magnets and can be a plurality of pairs of magnets mounted to or carried by the shaft for rotation in unison with the shaft during rotation of the spool operatively coupled or operatively connected to the shaft. In one such embodiment, there is a magnet carried by each segment of a crossbar mounted to the shaft that is configured to releasably retain a pole of a fish strike indicator flag in a ready to trigger position that moves, preferably pivots, toward and to a fish strike indicating position when the shaft rotates enough to disengage the crossbar during occurrence of a fish strike.

In one embodiment, a single magnet can be attached to or otherwise carried by the crossbar for movement, preferably rotation, substantially in unison with the crossbar during fishing apparatus, preferably tip up, operation, the magnet having one magnetic pole disposed on or extending along one segment of the crossbar and an opposite pole disposed on or extending along the other segment of the crossbar. In another embodiment, there are a plurality of magnets attached to or carried by the crossbar for rotation substantially in unison therewith with one magnet attached to, extending along, and/or otherwise carried by at least a portion of one segment of the crossbar and another magnet attached to, extending along, and/or carried by the other segment.

In a further embodiment, a plurality, preferably a plurality of pairs of magnets are attached to the shaft and arranged so they are equidistantly and/or equiangularly spaced apart from each other about the shaft and equidistantly radially spaced from the shaft with the magnets oriented so as to extend radially outwardly from or relative to the shaft having one of their magnetic poles facing toward the shaft and the other one of their poles facing away from the shaft. In such an embodiment, the magnets can be mounted in or to a circular disk that is fixed to the shaft an axial distance from the crossbar such that the disk and magnets rotate in unison with the shaft with each magnet extending in a radial direction outwardly from the shaft such that one of the poles of each magnet faces radially outwardly away from the shaft.

It also is contemplated that a magnet holder, such as a magnet-holding cartridge, carrying at least one magnet and preferably a plurality of spaced apart magnets can be used that is releasably attached to or otherwise carried by the crossbar and/or shaft so that holder and its magnets rotate substantially in unison therewith. In a preferred embodiment, the magnet holder is composed of a non-magnetic material, such as preferably plastic, and configured for snap-fit attachment to one or both bar segments and/or an adjacent part of the shaft in a manner that positions one magnet adjacent or along a portion of one of the crossbar segments and positions the other magnet adjacent or along a portion of the other one of the segments.

In a further preferred embodiment, a spool of a reel assembly of a fishing apparatus, which can be a rod and reel or a tip up, is configured to carry at least a plurality, preferably at least a plurality of pairs of, i.e., at least three, magnets which are equiangularly and equidistantly spaced apart from each other and equidistantly spaced from a centrally located axis of rotation of the spool, and with each magnet oriented with one of its magnetic poles facing radially outwardly away from the rotational axis of the spool. The radially outermost disposed pole of each magnet is disposed adjacent and radially underlies a cylindrical fishing line carrying outer surface of the spool defining a magnet track composed of the plurality, preferably plurality of pairs of spaced apart magnets that is non-straight, preferably annular, more preferably generally cylindrical, and even more preferably defines a wheel that rotates during casting, during occurrence of a fish strike where a fish has taken bait attached to fishing line spooled therearound, when a fish runs with the bait after striking the bait unspooling line from the spool, and/or when a fish tires after striking the bait and/or running with the bait also unspooling line from the spool.

In one such spool embodiment, each magnet is received in a pocket formed in the spool that orients the magnet so the magnet extends radially outwardly from or relative to the rotational axis of the spool towards or to the outer fish-line carrying surface of the spool with one of the poles of the magnet directly underling the outer surface of the spool. The spool can have a spoke or rib that extends radially outwardly from a centrally located hub through which the rotational axis is disposed towards and preferably to each one of the magnet-holding pockets. The spool can be formed of a pair of halves, which are preferably symmetrical and/or a mirror image of one another, which are assembled together with a magnet received in each pocket to produce the spool. In a preferred embodiment, the spool has three equiangularly and/or equidistantly spaced apart magnets received in a corresponding one of the magnet-holding pockets of the spool.

The unit is configured for mounting, such as with a mounting arrangement, and removably mounted to the fishing apparatus, such as a fishing apparatus equipped with a recl assembly, like a rod and reel or tip up, in a location on the apparatus that positions a magnetic sensor of the unit in close enough proximity to a magnet of the apparatus so as to dispose the magnetic sensor in magnetic field and/or magnetic flux sensing proximity to the magnet during movement, preferably rotation, of the shaft or spool carrying the magnet, such as in a manner the same as or like that described above, during apparatus operation. Where there is more than one magnet carried by and/or in operable cooperation with the shaft or spool, the unit preferably is mounted, such as by its mounting arrangement, where its magnet sensor is positioned close enough to the magnets carried by and/or in operable cooperation with the shaft or spool for each one of the magnets to pass by, preferably sequentially, in sensing proximity to the sensor during movement, preferably rotation, of the shaft or spool during apparatus operation.

As the spool or shaft rotates, at least one and preferably each magnet passes by a magnet sensor of the unit, preferably in sensing proximity thereto, during fishing apparatus, preferably tip up, operation enabling sensing of at least one of the magnet's magnetic field, increase in magnetic field strength, decrease in magnet field strength, magnetic flux, increase in magnetic flux and/or decrease in magnetic flux and detection, such as preferably by the processor of the unit, whether any of (a) (i)-(iv) and/or (b) (i)-(iv) is occurring. Depending on which one of (a) (i)-(iv) and/or (b) (i)-(iv) is detected as occurring, the unit will provide, preferably output, either in human perceptible form, e.g., visually, audibly, vibrationally, etc., and/or wirelessly, e.g., via radio frequency communication, notification, e.g., an alarm, that an event corresponding to one of (a) (i), a (ii), a (iii) and/or a (iv), and/or (b) (i), b (ii), b (iii) and/or b (iv) that indicates the corresponding one of (a) (i), a (ii), a (iii) and/or a (iv), and/or (b) (i), b (ii), b (iii) and/or b (iv) is occurring.

In another preferred embodiment, the present invention is directed to a fishing apparatus unit configured for sensing one or more parameters of operation of a fishing apparatus, such as a tip up or a rod and reel, the unit having at least one sensor that is or includes at least one motion sensor configured for sensing at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor, where the unit is configured to be mounted or attached to the fishing apparatus, and wherein the unit is configured to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus. The at least one motion sensor preferably is an accelerometer, such as at least a 3-axis accelerometer, a gyro, such as at least a 3-axis gyro, a magnetometer, such as at least a 3-axis magnetometer, an IMU, an HRU, a GPS sensor, an inclinometer, an angle sensor, or a tilt sensor. If desired the unit can be equipped with a plurality of motion sensors and can have none, one, or more than one magnetic sensor.

During operation, the at least one motion sensor senses at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus. The processor can be configured to determine at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus from data and/or signals received from the at least one motion sensor during fishing operation of the fishing apparatus.

The unit, preferably the processor and/or the at least one motion sensor, is configured to (a) monitor operation of the apparatus in the above manner, (b) detect one or more fishing events that include one or more of (1) a fish strike, (2) a fish running with bait after a fish strike, (3) a fish tiring and slowing down, and/or (4) a fish disengaging from the bait, e.g. detaching from a hook or the like carrying the bait, or breaking the fishing line to which the bait is attached, e.g., by a hook or the like, based on whether one or more of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus meets or exceeds a predetermined value, magnitude, or threshold, meets or falls below a predetermined value, magnitude, or threshold, and/or falls within or lies outside of a predetermined range, and (c) provide feedback to a user of the apparatus, such as preferably in the form of an audible, visually perceptible, tactile, vibrational, etc. alarm, corresponding to the event detected during fishing with the apparatus depending on the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed by the at least one motion sensor during fishing apparatus operation. The unit, preferably processor and/or the at least one motion sensor, is configured to monitor operation of the fishing apparatus to determine whether the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed during fishing with the apparatus meets or exceeds the predetermined value, magnitude, or threshold, meets or falls below the predetermined value, magnitude, or threshold, and/or falls within or lies outside of the predetermined range that indicates (b) (1), (b) (2), (b) (3) or (b) (4) is occurring and provides feedback to the user of the apparatus, such as preferably in the form of an audible, visually perceptible, tactile, vibrational, etc. alarm, corresponding to the specific one of event (b) (1), (b) (2), (b) (3) or (b) (4) detected during fishing with the apparatus.

In one preferred embodiment, the unit is configured to be releasably mounted or attached by a mounting arrangement to the fishing apparatus, the processor and/or the at least one motion sensor is or are configured to sense and/or determine at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of a component, such as a shaft, preferably a rotary drive shaft, and/or spool, such as of a reel assembly of the apparatus, or a pole, e.g., tip up fish strike indicator flagpole, or rod, e.g., rod of a rod and reel, of the apparatus that is movable relative to one or more other components of the apparatus during fishing with the apparatus. The unit is mounted in operable communication with and preferably is operatively connected to the movable component of the apparatus in a manner enabling the at least one motion sensor to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the movable component during apparatus operation. The unit preferably is configured to be mounted by the mounting arrangement to the movable component, such as by being releasably clamped to the shaft, e.g., drive shaft, pole, e.g., tip up flagpole, or rod, e.g., fishing pole or rod of a rod and reel, of the apparatus for movement substantially in unison with the movable component during fishing operation of the apparatus. The unit, preferably its mounting arrangement, can be configured for releasable mounting with the at least one motion sensor disposed in operable cooperation with the spool and/or operatively connected to the spool in a manner that enables at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the spool to be sensed during apparatus operation using the at least motion sensor and/or determined using the processor.

In another preferred embodiment, the fishing apparatus has a rod or pole and unit can be and preferably is configured for releasable mounting to the rod or pole with the at least one motion sensor and/or processor of the unit configured to sense one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, an angular velocity, an angular acceleration, and an angular jerk or an angular jerk factor indicative of a change in the position of the pole or rod during fishing with the apparatus to determine whether the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed by the at least one motion sensor and/or determined by the processor are indicative of one of a fish strike, a fish running with the bait, a fishing tiring, or a fish disengaging from the bait or breaking the fishing line.

In one such preferred embodiment, the fishing apparatus is an ice fishing apparatus, preferably a tip up, equipped with a rod or pole, such as preferably a fish strike indicator flagpole, in releasable engagement with part, e.g., a crossbar, of a rotary drive shaft coupled to a spool of a reel assembly of the apparatus where the pole or rod is configured to be movable between a generally horizontal ready to trigger position, where it is engaged with the part of the shaft and ready to trigger upon occurrence of a fish strike, and a generally upright or vertical fish strike indicating position disposed from the ready to trigger position when rotation of the shaft disengages the rod or pole therefrom when a fish strike occurs. The unit can be and preferably is configured for releasable mounting to the rod or pole for movement substantially in unison with the at least one motion sensor and/or processor of the unit configured to sense one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, an angular velocity, an angular acceleration, and an angular jerk or an angular jerk factor of the rod or pole indicative of a change in the position of the pole or rod moving from the horizontal ready to trigger position towards the vertical fish strike indicating position. The unit, preferably its processor and/or the at least one motion sensor, is configured to monitor the position of the rod or pole, sense when the rod or pole moves or begins moving from the ready to trigger position toward or to the fish strike indicating position and provides feedback to the user, such as preferably in the form of an audible, visually perceptible, tactile, vibratory, etc. alarm telling the user that a fish strike has occurred.

In a further preferred embodiment, unit is configured for being operably coupled, preferably operatively connected, and preferably is operably coupled, preferably operatively connected, to a rotary drive shaft of a fishing line carrying spool of a reel assembly of a fishing apparatus in a manner that enables the at least one motion sensor of the unit to sense at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft is the shaft is rotated by the spool being rotated due to fishing line unspooling from the spool by a fish during fishing apparatus operation. The processor and/or at least one motion sensor are configured to determine whether the characteristics of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor sensed during fishing apparatus operation are indicative of one of a fish strike, a fish running with the bait, a fishing tiring, or a fish disengaging from the bait or breaking the fishing line. The processor and/or at least one motion sensor are further configured to determine whether the sensed position, change in position, angle, change in angle, orientation, change in orientation, movement, change in movement, velocity, acceleration, jerk or jerk factor, rotation, change in rotation, rotational angle, change in rotational angle, number of rotations, number of rotations per unit time, number of rotations per minute, angular velocity, angular acceleration, and angular jerk or angular jerk factor meets or exceeds a predetermined value, magnitude, or threshold, meets or falls below the predetermined value, magnitude, or threshold, and/or falls within or lies outside of a predetermined range that indicates a casting event is occurring, a fish strike event is occurring, a fish running with the bait event is occurring, a fish tiring event is occurring, or a fish disengaged from the bait or broken line event is occurring during fishing with the apparatus and provides feedback to the user of the apparatus, such as preferably in the form of an audible, visually perceptible, tactile, vibrational, etc. alarm, corresponding to the specific one of these events that has occurred or is occurring.

In one such preferred embodiment, the fishing apparatus is an ice fishing apparatus that preferably is an ice fishing tip up and the unit is configured to be releasably mounted by a mounting arrangement that preferably is a clamp that clamps the unit to a rotary drive shaft of the tip up that is operatively coupled, preferably operatively connected, to a fishing-line carrying spool of a reel assembly of the tip up to enable rotation of the shaft caused by rotation of the spool due to a fish striking the bait unspooling line from the spool, a fish running with the bait unspooling line from the spool at a relatively fast rate, or a fish tiring unspooling line from the spool at a slower rate than a fish running with the bait to be sensed by the at least one motion sensor of the unit. During fishing operation, the unit clamped to the shaft rotates substantially in unison with the shaft with the at least one motion sensor sensing at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft and the processor determining from the sensed data and/or signals from the at least one motion sensor whether a fish strike has occurred after casting of the bait, a fish is running with bait after a fish strike has occurred, a fish is tiring such as after a fish strike has occurred, or a fish has detached from the bait and/or broken the line.

The processor can be configured to monitor the apparatus to determine whether a casting event has occurred where fishing line carrying a bait, such as attached to the line by a hook or the like, has taken place where line has been unspooled from the spool to position the bait in the water in a manner where a fish can strike the bait. The processor can be configured to do so by accepting a manual input, such as through a control, e.g., a button or the like, or other input, e.g., such as via or using an app on a processor-equipped device like a smartphone, tablet, or computer, that indicates a casting event has occurred. The processor can also be configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a casting event occurring or having occurred.

The processor is configured to monitor apparatus operation to determine whether a fish strike event has occurred where fishing line carrying a bait is further rapidly unspooled from the spool after casting when a fish bites the bait thereby striking the bait. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish strike event occurring or having occurred.

The processor also is configured to monitor apparatus operation to determine whether a fish running with the bait event has occurred where fishing line carrying a bait is rapidly unspooled from the spool after occurrence of a fish strike event thereby indicating the fish is fighting. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish running with the bait event occurring or having occurred. In a preferred embodiment and method implementation, the processor can be further configured to communicate with a drag assembly of the fishing apparatus to increase drag on the fishing line in response to detection of a fish running with the bait event.

The processor is further configured to monitor apparatus operation to determine whether a fish tiring event has occurred where fishing line carrying a bait is less rapidly unspooled from the spool compared to an earlier rate of unspooling of the line and after a fish strike event has occurred. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish tiring event occurring or having occurred. In a preferred embodiment and method implementation, the processor can be further configured to communicate with a drag assembly of the fishing apparatus to decrease drag on the fishing line in response to detection of a fish tiring event.

The processor is still further configured to monitor apparatus operation to determine whether a fish detaching from bait or line breaking event has occurred where fishing line abruptly ceases being unspooled from the spool and after a fish strike event has occurred. The processor is configured to monitor the at least one motion sensor to determine whether one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor of the shaft rotating fishing apparatus use is indicative of a fish disengaging from bait or breaking the line event occurring or having occurred.

The processor and/or at least one motion sensor are configured to determine whether the sensed position, change in position, angle, change in angle, orientation, change in orientation, movement, change in movement, velocity, acceleration, jerk or jerk factor, rotation, change in rotation, rotational angle, change in rotational angle, number of rotations, number of rotations per unit time, number of rotations per minute, angular velocity, angular acceleration, and angular jerk or angular jerk factor meets or exceeds a predetermined value, magnitude, or threshold, meets or falls below the predetermined value, magnitude, or threshold, and/or falls within or lies outside of a predetermined range that indicates a casting event is occurring, a fish strike event is occurring, a fish running with the bait event is occurring, a fish tiring event is occurring, or a fish disengaged from the bait or broken line event is occurring during fishing with the apparatus and provides feedback to the user of the apparatus, such as preferably in the form of an audible, visually perceptible, tactile, vibrational, etc. alarm, corresponding to the specific one of these events that has occurred or is occurring.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A fishing apparatus sensing alarm unit for sensing one or more parameters of operation of a fishing apparatus, the fishing apparatus sensing alarm unit comprising:
a motion sensor configured for sensing at least one of a position, a change in position, an angle, a change in angle, an orientation, a change in orientation, a movement, a change in movement, a velocity, an acceleration, a jerk or a jerk factor, a rotation, a change in rotation, a rotational angle, a change in rotational angle, a number of rotations, a number of rotations per unit time, a number of rotations per minute, an angular velocity, an angular acceleration, and an angular jerk or an angular jerk factor; and
a processor in communication with the motion sensor; and
wherein the fishing apparatus sensing alarm unit is configured to be mounted to part of the fishing apparatus; and
wherein one or both the processor and the motion sensor are configured to one of sense and/or determine at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the fishing apparatus during fishing operation of the fishing apparatus.

2. The fishing apparatus sensing alarm unit of claim 1, wherein the part of the fishing apparatus to which the fishing apparatus sensing alarm unit is configured to be mounted or attached is a component of the fishing apparatus that is movable relative to another component of the apparatus, wherein the fishing apparatus sensing alarm unit is mounted to the movable component of the fishing apparatus, and wherein the motion sensor senses at least one of at least one of the position, the change in position, the angle, the change in angle, the orientation, the change in orientation, the movement, the change in movement, the velocity, the acceleration, the jerk or jerk factor, the angle, the change in angle, the rotation, the change in rotation, the angular velocity, the angular acceleration, the angular jerk or angular jerk factor, the rotational angle, and the change in the rotational angle of the movable component of the fishing apparatus.

3. The fishing apparatus sensing alarm unit of claim 2, wherein the fishing apparatus sensing alarm unit has a plurality of the motion sensors disposed onboard the fishing apparatus sensing alarm unit.

4. The fishing apparatus sensing alarm unit of claim 2, wherein the motion sensor comprises an accelerometer, a gyro, an angular rate sensor, a magnetometer, an Inertial Measurement Unit (IMU) sensor, or a Heading Reference Unit (HRU) sensor.

5. The fishing apparatus sensing alarm unit of claim 4, wherein the motion sensor comprises a 3-axis accelerometer, a 3-axis gyro, or a 3-axis magnetometer.

6. The fishing apparatus sensing alarm unit of claim 2, wherein the movable part or movable component of the fishing apparatus comprises a rod or a pole and wherein the fishing apparatus sensing alarm unit comprises a mounting arrangement configured for mounting the fishing apparatus sensing alarm unit to the rod or pole of the fishing apparatus.

7. The fishing apparatus sensing alarm unit of claim 6, wherein the movable part or movable component of the fishing apparatus comprises an elongate pole of the fishing apparatus and wherein the mounting arrangement of the fishing apparatus sensing alarm unit is configured to releasably mount the fishing apparatus sensing alarm unit to the elongate pole of the fishing apparatus for movement of the fishing apparatus sensing alarm unit substantially in unison with the elongate pole of the fishing apparatus.

8. The fishing apparatus sensing alarm unit of claim 7, wherein the motion sensor is configured to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the elongate pole of the fishing apparatus indicative of a fish strike occurring.

9. The fishing apparatus sensing alarm unit of claim 8, wherein the processor is configured to provide an indication of a fish strike occurring when the motion sensor senses at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the elongate pole of the fishing apparatus indicative of a fish strike occurring indicative of a fish strike occurring during movement of the elongate pole of the fishing apparatus.

10. The fishing apparatus sensing alarm unit of claim 9, wherein the elongate pole of the fishing apparatus comprises an elongate flagpole of a fish strike indicator flag of an ice fishing tip up.

11. The fishing apparatus sensing alarm unit of claim 9, wherein the motion sensor comprises an accelerometer, a gyro, an angular rate sensor, a magnetometer, an IMU, or an HRU.

12. The fishing apparatus sensing alarm unit of claim 9, wherein the mounting arrangement of the fishing apparatus sensing alarm unit comprises a clamp configured to releasably mount the fishing apparatus sensing alarm unit to the elongate pole of the fishing apparatus in a manner where movement of the elongate pole of the fishing apparatus causes movement of the fishing apparatus sensing alarm unit.

13. The fishing apparatus sensing alarm unit of claim 6, wherein the movable part or movable component of the fishing apparatus comprises an elongate flagpole of a fish strike indicator flag of an ice fishing tip up that is movable between a generally horizontal ready to trigger position and a generally vertical fish strike indicating position and wherein the mounting arrangement of the fishing apparatus sensing alarm unit is configured to mount the fishing apparatus sensing alarm unit to the flagpole for movement of the fishing apparatus sensing alarm unit substantially in unison with the flagpole from the generally horizontal ready position toward the generally vertical fish strike indicating position.

14. The fishing apparatus sensing alarm unit of claim 13, wherein the mounting arrangement of the fishing apparatus sensing alarm unit comprises a clamp configured to releasably mount the fishing apparatus sensing alarm unit to the elongate flagpole.

15. The fishing apparatus sensing alarm unit of claim 13, wherein the motion sensor is configured to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the flagpole of the ice fishing tip up indicative of a fish strike occurring during movement of the flagpole of the ice fishing tip up.

17. The fishing apparatus sensing alarm unit of claim 15, wherein the motion sensor comprises an accelerometer, a gyro, an angular rate sensor, a magnetometer, an IMU, or an HRU.

18. The fishing apparatus sensing alarm unit of claim 6, wherein the movable part or movable component of the fishing apparatus comprises a rotary drive shaft of the fishing apparatus that rotates during operation of the fishing apparatus, and wherein the mounting arrangement of the fishing apparatus sensing alarm unit is configured to mount the fishing apparatus sensing alarm unit in operable communication with the rotary drive shaft of fishing apparats.

19. The fishing apparatus sensing alarm unit of claim 18, wherein the motion sensor is configured to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the rotary drive shaft.

20. The fishing apparatus sensing alarm unit of claim 19, wherein the processor is configured to provide an indication of the occurrence of a fishing related event occurring when the motion sensor senses at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the rotary drive shaft of the fishing apparatus during fishing operation of the fishing apparatus.

21. The fishing apparatus sensing alarm unit of claim 20, wherein the mounting arrangement of the fishing apparatus sensing alarm unit comprises at least one clamp configured to releasably mount the fishing apparatus sensing alarm unit to the rotary drive shaft.

22. The fishing apparatus sensing alarm unit of claim 20, wherein the fishing apparatus comprises an ice fishing tip up and the rotary drive shaft is attached to a spool of a reel assembly of the ice fishing tip up that rotates when a fish strikes bait attached to fishing line wrapped around the spool unspooling fishing line therefrom and wherein the processor is configured to provide an indication of the occurrence of a fish strike event occurring when the motion sensor senses at least one of the angle, the change in angle, the rotation, the change in rotation, the number of rotations, the number of rotations per unit time, the number of rotations per minute, the rotational angle, and the change in a rotational angle of the rotary drive shaft of the ice fishing tip up indicative of a fish strike occurring during rotation of the rotary drive shaft of the ice fishing tip.

23. The fishing apparatus sensing alarm unit of claim 22, wherein the motion sensor comprises an accelerometer, a gyro, an angular rate sensor, a magnetometer, an IMU, or an HRU.

24. The fishing apparatus sensing alarm unit of claim 6, wherein the movable part or movable component of the fishing apparatus comprises a rotary drive shaft attached to a spool of a reel assembly of an ice fishing tip up that rotates when a fish strikes bait attached to fishing line wrapped around the spool unspooling fishing line therefrom, and wherein the mounting arrangement of the fishing apparatus sensing alarm unit is configured to mount the fishing apparatus sensing alarm unit to the rotary drive shaft of the ice fishing tip up for rotation of the fishing apparatus sensing alarm unit substantially in unison with the rotary drive shaft of the ice fishing tip up.

25. The fishing apparatus sensing alarm unit of claim 24, wherein the mounting arrangement of the fishing apparatus sensing alarm unit comprises at least one clamp configured to releasably mount the fishing apparatus sensing alarm unit to the rotary drive shaft in a manner that causes the fishing apparatus sensing alarm unit to rotate in unison with the rotary drive shaft.

26. The fishing apparatus sensing alarm unit of claim 24, wherein the motion sensor is configured to sense at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the rotary drive shaft of the ice fishing tip up indicative of a fish strike occurring.

27. The fishing apparatus sensing alarm unit of claim 26, wherein the processor is configured to provide an indication of a fish strike occurring when the motion sensor senses at least one of the position, the change in position, the angle, the change in angle, the orientation, the change in orientation, the movement, the change in movement, the velocity, the acceleration, the jerk or jerk factor, the rotation, the change in rotation, the rotational angle, the change in rotational angle, the number of rotations, the number of rotations per unit time, the number of rotations per minute, the angular velocity, the angular acceleration, and the angular jerk or angular jerk factor of the rotary drive shaft of the ice fishing tip up indicative of a fish strike occurring during rotation of the rotary drive shaft of the ice fishing tip up.

28. The fishing apparatus sensing alarm unit of claim 26, wherein the motion sensor comprises an accelerometer, a gyro, an angular rate sensor, a magnetometer, an IMU, or an HRU.

29. The fishing apparatus sensing alarm unit of claim 1, further comprising a magnetic sensor for sensing one of a magnetic field, a change in a magnetic field, a magnetic flux, or a change in a magnetic flux of a source of a magnetic field or magnetic flux.

30. The fishing apparatus sensing alarm unit of claim 29, wherein the magnetic sensor comprises a magnetoresistance (MR) sensor.

31. The fishing apparatus sensing alarm unit of claim 30, wherein the magnetic sensor comprises a tunneling magnetoresistance (TMR) sensor.

32. The fishing apparatus sensing alarm unit of claim 29, wherein the fishing apparatus comprises a track with a plurality of pairs of spaced apart sources of a magnetic field or magnetic flux, and wherein the magnetic sensor of the fishing apparatus sensing alarm unit is configured to sense each one of the spaced apart sources of the magnetic field or magnetic flux during movement of the track relative thereto.

33. The fishing apparatus sensing alarm unit of claim 32, wherein the magnetic sensor of the fishing apparatus sensing alarm unit is configured to sequentially sense each one of the spaced apart sources of the magnetic field or magnetic flux of the track during movement of the track relative thereto.

34. The fishing apparatus sensing alarm unit of claim 33, wherein the track is comprised of a generally circular or generally cylindrical wheel of one part of the fishing apparatus, and wherein the fishing apparatus sensing alarm unit is configured to be mounted on another part of the fishing apparatus with the magnetic sensor of the fishing apparatus sensing alarm unit disposed sequentially in magnetic field or magnetic flux sensing proximity to each one of the sources of the magnetic field or magnetic flux of the track during movement of the generally circular or generally cylindrical wheel relative thereto during fishing apparatus operation.

35. The fishing apparatus sensing alarm unit of claim 34, wherein the generally circular or generally cylindrical wheel comprises a rotary spool of a fishing reel carrying fishing line that rotates relative to another part of the fishing reel that is fixed or grounded, and wherein the fishing apparatus sensing alarm unit is configured to be mounted to the another part of the fishing reel that is fixed or grounded.

36. The fishing apparatus sensing alarm unit of claim 1, wherein the fishing apparatus has a rotary spool with an outer surface carrying a fishing line that is unspooled from the spool during fishing apparatus operation, the rotary spool comprised of at least a plurality of spaced apart magnets carried thereby, and wherein the fishing apparatus sensing alarm unit further comprises a magnetic sensor configured for sensing one of a magnetic field, a change in a magnetic field, a magnetic flux, or a change in magnetic flux of each one of the plurality of magnets of the spool sequentially passing by in sensing proximity to the magnetic sensor during rotation of the spool.

37. The fishing apparatus sensing alarm unit of claim 36, wherein the spool has at least a plurality of magnet-holding pockets formed therein in which is received a corresponding one of the magnets.

38. The fishing apparatus sensing alarm unit of claim 37, wherein the spool has an axis of rotation and each one of the magnets are arranged in a radial direction relative to the rotational axis extending radially outwardly away from the rotational axis.

39. The fishing apparatus sensing alarm unit of claim 38, wherein each one of the magnets is arranged with a magnetic pole facing radially away from the rotational axis of the spool and which underlies the outer surface of the spool around which the fishing line is spooled.

40. The fishing apparatus sensing alarm unit of claim 36, wherein the processor is configured to (a) determine at least one of an angle, e.g., change in angle, a rotational angle, a change in rotational angle, an increase in rotation, an increase in the rate of rotation, an increase in an angular velocity, an increase in angular acceleration, a jerk factor, an increase in the rate or speed of rotation, an increase in rotations per unit time, e.g., increase in revolutions per minute (RPMs), of the spool from data or signals from the at least one magnetic sensor sensing the magnetic field, change in the magnetic field, the magnetic flux, or the change in magnetic flux of each one of the plurality of magnets of the spool sequentially passing by in sensing proximity to the magnetic sensor during rotation of the spool, and (b) detect whether a fish strike event is occurring or has occurred.

41. The fishing apparatus sensing alarm unit of claim 40, wherein the processor is further configured to detect whether a fish running with bait event is occurring or has occurred, a fish tiring event is occurring or has occurred, or a fish disengaging from bait or fishing line breaking event is occurring or has occurred.

42. The fishing apparatus sensing alarm unit of claim 40, wherein the magnetic sensor comprises a TMR sensor.
